(19) United States
(12) Patent Application Publication
(10) Pub. No.: US 2025/0223165 A1
(43) Pub. Date: Jul. 10, 2025

(54) POROUS CARBON MATERIALS COMPRISING A CARBON ADDITIVE

(71) Applicant: Aspen Aerogels, Inc., Northborough, MA (US)

(72) Inventor: Zhifei Li, Marlborough, MA (US)

(73) Assignee: Aspen Aerogels, Inc., Northborough, MA (US)

(21) Appl. No.: 19/090,646

(22) Filed: Mar. 26, 2025

Related U.S. Application Data
(63) Continuation of application No. PCT/US2023/070425, filed on Jul. 18, 2023.
(60) Provisional application No. 63/410,652, filed on Sep. 28, 2022.

(51) Int. Cl. C01B 32/05; H01M 4/587

(52) U.S. Cl. CPC C01B 32/05; H01M 4/587; C01P 2004/03; C01P 2006/40

(57) ABSTRACT

The present disclosure is directed to methods of forming carbon aerogel materials which include (i.e., are doped with) a carbon additive such as graphene, graphene nanoribbons, graphene nanoplatelets, graphene oxide, carbon black, single wall carbon nanotubes, multiple wall carbon nanotubes, carbon nanofibers, or combinations thereof. The methods generally include providing an organogel precursor; adding a carbon additive or precursor thereof to the organogel precursor; inducing gelation of the organogel precursor to provide an organogel doped with the carbon additive or precursor thereof; drying the organogel to form an organic aerogel doped with the carbon additive or precursor thereof; and pyrolyzing the doped organic aerogel. The doped gel materials prepared according to the disclosed methods are suitable for use in environments involving electrochemical reactions, for example as an electrode material within a lithium-ion battery.

### CROSS REFERENCES TO RELATED APPLICATIONS

This application is a continuation of International Application No. PCT/US2023/070425, filed Jul. 18, 2023, and which claims priority to and the benefit of U.S. Provisional Patent Application No. 63/410,652, filed Sep. 28, 2022, which is herein incorporated by reference in its entirety.

### TECHNICAL FIELD

The present disclosure relates generally to porous carbon materials which include (i.e., are doped with) carbon additives and to methods for the preparation thereof.

### BACKGROUND

Aerogels are solid materials that include a highly porous network of micro-, meso-, and macro-sized pores. Depending on precursor materials used and processing undertaken, the pores of an aerogel can frequently account for over 90% of the volume when the density of the aerogel is about 0.05 g/cc. Aerogels are generally prepared by removing the solvent from a gel (a solid network that contains a solvent) in a manner such that minimal or no contraction of the gel can be brought by capillary forces at its pore walls. Methods of solvent removal include, but are not limited to, supercritical drying (or drying using supercritical fluids, such that the low surface tension of the supercritical fluid replaces the high surface tension gelation solvent within the gel), exchange of solvent with supercritical fluid, exchange of solvent with fluid that is subsequently transformed to the supercritical state, sub- or near-critical drying, and sublimating a frozen solvent in a freeze-drying process. See for example, PCT Patent Application Publication No. WO2016127084A1. It should be noted that when drying in ambient conditions, gel contraction may take place with solvent evaporation, and a xerogel can form. Therefore, aerogel preparation through a sol-gel process or other polymerization processes typically proceeds in the following series of steps: dissolution of the solute in a solvent, addition of a catalyst or reagent that induces or promotes reaction of the solute, formation of a reaction mixture, formation of the gel (may involve additional heating or cooling), and solvent removal by a supercritical drying technique or any other method that removes solvent from the gel without causing contraction or pore collapse.

Aerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyimide (PI), polyurethane (PU), polyurea (PUA), polyamine (PA), polybutadiene, polydicyclopentadiene, and precursors or polymeric derivatives thereof, the organic aerogel may be carbonized (e.g., by pyrolysis) to form carbon aerogels, which can have properties (e.g., pore volume, pore size distribution, morphology, etc.) that differ from or overlap with each other, depending on the precursor materials and methodologies used. As used herein, the term “organic aerogel” refers to a group of porous materials formed from organic materials. Depending on the preparation method and porosity of the porous materials, the organic aerogel may be an organic xerogel, cryogel, ambigel, microporous material, and the like. For example, if the porous material is prepared under ambient pressure (not under supercritical drying conditions), the porous material may be referred to generally as an organic aerogel rather than utilizing the more precise term “organic xerogel”.

Recently, there has been effort devoted to the development and characterization of carbon aerogels as electrode materials with improved performance for applications in energy storage devices, such as lithium-ion batteries (LIBs). Accordingly, it would be desirable in the art to provide further carbon aerogel materials with fine-tune electrochemical properties and methods of preparing same.

### SUMMARY

The present technology is generally directed to porous carbon materials and porous carbon-silicon composite materials which include (i.e., are doped with) carbon additives such as soft carbon, graphene, graphene nanoribbons, graphene nanoplatelets, graphene oxide, carbon black, single wall carbon nanotubes, multiple wall carbon nanotubes, carbon nanofibers, or combinations thereof. The present technology is further directed to methods of preparation of such carbon additive-containing porous carbon materials. The methods generally comprise providing an organogel precursor; adding a carbon additive or precursor thereof to the organogel precursor; optionally adding silicon particle, or other functional particles and sacrificial particles, inducing gelation of the organogel precursor to provide an organogel doped with the carbon additive or precursor thereof; drying the organogel to form an organic aerogel doped with the carbon additive or precursor thereof; and pyrolyzing the doped organic aerogel. In the case of porous carbon materials and porous carbon-silicon composite materials comprising soft carbon as the additive, the method comprises adding a precursor of the soft carbon, such as pitch or perylene tetracarboxylic dianhydride (PTCDA). During subsequent pyrolysis, such precursors are thermally converted to soft carbon.

The disclosed processes are advantageous in enabling customization of the carbon additive present in the resulting porous carbon materials as opposed to relying on the properties associated with merely introducing commercially available carbon additives. Surprisingly, it was found according to the present disclosure that carbon aerogel beads or carbon/silicon composite aerogel beads comprising certain carbon additives, prepared as described herein, exhibited improved first cycle efficiency, reversible capacity, and high-rate performance lithiation potential relative to reference carbon aerogel beads (i.e., not including a carbon additive). Without wishing to be bound by theory, it is believed that such enhanced performance is a result of the formation of carbon within the aerogel matrix which has a desirably ordered structure, and/or due to changes to the polyimide-derived carbon induced by the presence of the carbon additive. Further, according to the present disclosure, it was surprisingly found that carbon aerogel materials comprising soft carbon retained the high efficiency of carbon aerogel materials comprising hard carbon. This is advantageous as such carbon aerogels may be prepared at lower pyrolysis temperatures, thereby potentially lowering production costs by virtue of the lower energy demand. Finally, the sol-based method for preparing gel materials comprising a carbon additive or precursor thereof is highly flexible with respect to the nature of the organogel precursor, may in many instances be conducted under aqueous (“green”) conditions, and allows incorporation of a wide variety of carbon forms in the final carbon aerogel, and further allows incorporation of electroactive materials such as silicon. The method also allows incorporation of void spaces in the final carbon aerogel, which void spaces may further comprise silicon particles.

Particularly, this method may be applied to organogels including, but not limited to, resorcinol-formaldehyde (RF) polymers, phloroglucinol-furfuraldehyde (PF) polymers, polyacrylonitrile (PAN), polyurethanes (PU), polyureas (PUA), polyamines (PA), polybutadiene, polydicyclopentadiene, polyamic acids, and polyimides to produce carbon- and/or silicon-doped carbon aerogels.

Accordingly, in one aspect is provided a method of forming a carbon aerogel comprising a carbon additive, the method comprising: providing a solution comprising an organogel precursor and a solvent; adding a carbon additive or precursor thereof to the organogel precursor solution; initiating gelation of the organogel precursor to provide an organogel comprising the carbon additive or precursor thereof; drying the organogel to form an organic aerogel comprising the carbon additive or precursor thereof; and isomorphically converting the organic aerogel to the carbon aerogel comprising the carbon additive, the converting comprising pyrolyzing the organic aerogel under an inert atmosphere at a temperature of at least about 650° C.

In some aspects, the carbon additive is graphene, graphene nanoribbons, graphene nanoplatelets, graphene oxide, carbon black, single wall carbon nanotubes, multiple wall carbon nanotubes, carbon nanofibers, or a combination thereof, the method comprising adding the carbon additive to the organogel precursor solution.

In some aspects, the carbon additive is soft carbon, the method comprising adding a soft carbon precursor to the organogel precursor solution, wherein the soft carbon precursor comprises or is perylene tetracarboxylic dianhydride (PTCDA).

In some aspects, the carbon additive is soft carbon, the method comprising adding a soft carbon precursor to the organogel precursor solution, wherein the soft carbon precursor comprises or is or pitch.

In some aspects, the carbon aerogel further comprises silicon, the method further comprising adding silicon to the organogel precursor solution.

In some aspects, the method further comprises adding poly(methyl methacrylate) particles to the organogel precursor solution.

In some aspects, the method further comprises adding sacrificial material modified silicon particles to the organogel precursor solution.

In some aspects, drying the organogel comprises: optionally, washing or solvent exchanging the organogel; and subjecting the organogel to elevated temperature conditions, lyophilizing the organogel, or contacting the organogel with supercritical fluid carbon dioxide.

In some aspects, the washing or solvent exchanging is performed with water, a C1 to C3 alcohol, acetone, acetonitrile, ether, tetrahydrofuran, toluene, liquid carbon dioxide, or a combination thereof.

In some aspects, the organogel comprises a resorcinol-formaldehyde (RF) polymer, a phloroglucinol-furfuraldehyde (PF) polymer, polyacrylonitrile (PAN), a polyurethane (PU), a polyurea (PUA), a polyamine (PA), polybutadiene, polydicyclopentadiene, or a combination thereof.

In some aspects, the organogel comprises a polyimide, polyamic acid, or a combination thereof.

In some aspects, the organogel is a polyimide, and the organogel precursor is a polyamic acid salt.

In some aspects, initiating gelation comprises imidizing the polyamic acid salt.

In some aspects, imidizing comprises adding a dehydrating agent to the solution of the polyamic acid salt.

In some aspects, the dehydrating agent is acetic anhydride.

In some aspects, the solvent is water. In some aspects, the solvent is a polar, aprotic organic solvent. In some aspects, the solvent is N,N-dimethylacetamide, N,N-dimethylformamide, N-methylpyrrolidone, or a combination thereof.

In a further aspect is provided a method of forming a carbon aerogel comprising a carbon additive, the method comprising: providing an aqueous solution of a polyamic acid salt, the polyamic acid salt comprising a polyamic acid including carboxylic acid groups, wherein the carboxylic acid groups are associated with cationic species and are substantially present as carboxylate anions; adding a carbon additive or precursor thereof to the aqueous solution; imidizing the polyamic acid salt to form a polyimide gel comprising the carbon additive or precursor thereof; drying the polyimide gel to form a polyimide aerogel comprising the carbon additive or precursor thereof; and isomorphically converting the polyimide aerogel to the carbon aerogel comprising the carbon additive, the converting comprising pyrolyzing the polyimide aerogel under an inert atmosphere at a temperature of at least about 650° C.

In some aspects, providing the aqueous solution of the polyamic acid salt comprises: providing a polyamic acid; adding the polyamic acid to water to form an aqueous suspension of the polyamic acid; and adding a base (e.g., a non-nucleophilic amine, a hydroxide or a carbonate or bicarbonate) to the aqueous suspension of the polyamic acid to form the aqueous solution of the polyamic acid salt.

In some aspects, the base is an alkali metal hydroxide, and the cationic species is an alkali metal cation. In some aspects, the alkali metal hydroxide is lithium hydroxide, sodium hydroxide, or potassium hydroxide.

In some aspects, the base is a water-soluble carbonate or bicarbonate salt.

In some aspects, the base is a non-nucleophilic amine, and wherein the cationic species is an ammonium cation. In some aspects, the non-nucleophilic amine has a solubility of at least about 4 grams per 1 L of water at 20° C. In some aspects, the non-nucleophilic amine is a tertiary amine. In some aspects, the non-nucleophilic amine is selected from the group consisting of triethylamine, trimethylamine, tri-n-butylamine, N-methylpyrrolidine, N-methylpiperidine, diisopropylethylamine, and combinations thereof. In some aspects, the non-nucleophilic amine is triethylamine or diisopropylethylamine

In some aspects, the non-nucleophilic amine is added in a quantity sufficient to maintain substantially all of the polyamic acid in solution. In some aspects, a molar ratio of the non-nucleophilic amine to the polyamic acid is from about 2 to about 4, or from about 2.2 to about 2.5.

In some aspects, the polyamic acid comprises a tetracarboxylic acid selected from the group consisting of benzene-1,2,4,5-tetracarboxylic acid, [1,1′-biphenyl]-3,3′,4,4′-tetracarboxylic acid, 4,4′-oxydiphthalic acid, 4,4′-sulfonyldiphthalic acid, 4,4′-carbonyldiphthalic acid, 4,4′-(propane-2,2-diyl)diphthalic acid, 4,4′-(perfluoropropane-2,2-diyl)diphthalic acid, naphthalene-1,4,5,8-tetracarboxylic acid, 4-(2-(4-(3,4-dicarboxyphenoxy)phenyl)propan-2-yl)phthalic acid, perylene tetracarboxylic acid, and combinations thereof.

In some aspects, the polyamic acid comprises a C2-C6 alkylene diamine, wherein one or more of the carbon atoms of the C2-C6 alkylene is optionally substituted with one or more alkyl groups. In some aspects, the C2-C6 alkylene diamine is selected from the group consisting of ethylenediamine, 1,3-diaminopropane, 1,4-diaminobutane, 1,5-diaminopentane, 1,6-diaminohexane, or a combination thereof. In some aspects, the polyamic acid comprises 1,3-phenylenediamine, 1,4-phenylenediamine, 4,4′-methylenedianiline, 4,4′-diaminodiphenyl ether, or a combination thereof. In some aspects, the polyamic acid comprises a diamine selected from the group consisting of 1,4-phenylenediamine, 4,4′-methylenedianiline, 4,4′-diaminodiphenyl ether, and combinations thereof.

In some aspects, a range of concentration of the polyamic acid salt in the solution is from about 0.01 to about 0.3 g/cm³, based on the weight of the polyamic acid.

In some aspects, the polyimide gel is in monolithic form, and imidizing the polyamic acid salt comprises adding a dehydrating agent to the aqueous solution of the polyamic acid salt to form a gelation mixture, the method further comprising pouring the gelation mixture into a mold and allowing the gelation mixture to gel.

In some aspects, the polyimide gel is in monolithic form, and imidizing the polyamic acid salt is performed thermally, the method further comprising: adding delta-gluconolactone to the aqueous solution of the polyamic acid salt to form a gelation mixture; pouring the gelation mixture into a mold and allowing the gelation mixture to gel; washing the resulting polyamic acid gel with water; and thermally imidizing the polyamic acid gel to form the polyimide gel, wherein thermally imidizing comprises exposing the polyamic acid gel to microwave frequency irradiation.

In some aspects, the polyimide gel is in bead form, and imidizing the polyamic acid salt comprises adding a dehydrating agent to the aqueous solution of the polyamic acid salt to form a gelation mixture; the method further comprising adding the gelation mixture to a solution of a water-soluble acid in water to form the polyimide gel beads, wherein adding comprises dripping the gelation mixture into the solution of the water soluble acid in water, spraying the gelation mixture under pressure through one or more nozzles into the solution of the water-soluble acid in water using pressure; or electrospraying the gelation mixture into the solution of the water soluble acid in water.

In some aspects, the dehydrating agent is acetic anhydride.

In some aspects, the water-soluble acid is a mineral acid or is acetic acid.

In some aspects, the polyimide gel is in bead form, and imidizing the polyamic acid salt comprises adding a dehydrating agent to the aqueous solution of the polyamic acid salt to form a gelation mixture, the method further comprising adding the gelation mixture to a water-immiscible solvent, optionally comprising an acid, wherein adding comprises dripping the gelation mixture into the water-immiscible solvent, spraying the gelation mixture under pressure through one or more nozzles into the water-immiscible solvent using pressure; or electrospraying the gelation mixture into the water-immiscible solvent.

In some aspects, the dehydrating agent is acetic anhydride.

In some aspects, the optional acid is acetic acid.

In some aspects, the method comprises electrospraying the gelation mixture through one or more needles at a voltage in a range from about 5 to about 60 kV.

In some aspects, the polyimide gel is in bead form, and imidizing the polyamic acid salt comprises adding a dehydrating agent to the aqueous solution of the polyamic acid salt to form a gelation mixture, the method further comprising combining the aqueous solution of the polyamic acid salt with a water-immiscible solvent comprising a surfactant; and mixing the resulting mixture under high-shear conditions.

In some aspects, the polyimide gel is in bead form, and imidizing the polyamic acid salt comprises chemical imidization, the method comprising: combining the aqueous solution of the polyamic acid salt with a water-immiscible solvent comprising a surfactant; mixing the resulting mixture under high-shear conditions to form a quasi-stable emulsion; and adding a dehydrating agent to the quasi-stable emulsion.

In some aspects, the water-immiscible organic solvent is a C5-C12 hydrocarbon. In some aspects, the C5-C12 hydrocarbon is mineral spirits.

In some aspects, providing an aqueous solution of a polyamic acid salt comprises: dissolving a water-soluble diamine in water to form an aqueous diamine solution; adding a non-nucleophilic amine to the aqueous diamine solution; adding a tetracarboxylic acid dianhydride to the aqueous diamine solution; and stirring the resulting solution for a period of time in a range from about 1 hour to about 24 hours at a temperature in a range from about 15 to about 60° C.

In some aspects, providing an aqueous solution of a polyamic acid salt comprises: dissolving a water-soluble diamine in water to form an aqueous diamine solution; adding a tetracarboxylic acid dianhydride to the aqueous diamine solution; stirring the resulting suspension for a period of time in a range from about 1 hour to about 24 hours at a temperature in a range from about 15 to about 60° C.; adding a non-nucleophilic amine to the aqueous diamine solution; and stirring the resulting suspension for a period of time in a range from about 1 hour to about 24 hours at a temperature in a range from about 15 to about 60° C.

In some aspects, providing an aqueous solution of a polyamic acid salt comprises: adding to water, simultaneously or in rapid succession, a water-soluble diamine, a tetracarboxylic acid dianhydride, and a non-nucleophilic amine; and stirring the resulting mixture for a period of time in a range from about 1 hour to about 24 hours at a temperature in a range from about 15 to about 60° C.

In some aspects, the water-soluble diamine, tetracarboxylic acid dianhydride, and non-nucleophilic amine are added to water simultaneously. In some aspects, the water-soluble diamine, tetracarboxylic acid dianhydride, and non-nucleophilic amine are added to water in rapid succession.

In some aspects, the resulting mixture is stirred at a temperature in a range from about 15 to about 25° C. In some aspects, the resulting mixture is stirred at a temperature in a range from about 50 to about 60° C.

In some aspects, the non-nucleophilic amine has a solubility of at least about 4 grams per 1 L of water at 20° C.

In some aspects, the non-nucleophilic amine is a tertiary amine. In some aspects, the non-nucleophilic amine is selected from the group consisting of triethylamine, trimethylamine, tri-n-butylamine, N-methylpyrrolidine, N-methylpiperidine, diisopropylethylamine, and combinations thereof. In some aspects, the non-nucleophilic amine is triethylamine or diisopropylethylamine.

In some aspects, a molar ratio of the non-nucleophilic amine to the diamine is from about 2 to about 2.5.

In some aspects, the tetracarboxylic acid dianhydride is selected from the group consisting of pyromellitic anhydride (PMDA, biphthalic dianhydride (BPDA), oxydiphthalic dianhydride (ODPA), perylene tetracarboxylic dianhydride, and combinations thereof.

In some aspects, the diamine is a C2-C6 alkylene diamine, wherein one or more carbon atoms of the C2-C6 alkylene are optionally substituted with one or more alkyl groups. In some aspects, the C2-C6 alkylene diamine is selected from the group consisting of ethylenediamine, 1,3-diaminopropane, 1,4-diaminobutane, 1,5-diaminopentane, 1,6-diaminohexane, and combination thereof. In some aspects, the diamine is 1,3-phenylenediamine, 1,4-phenylenediamine, or a combination thereof. In some aspects, the diamine is 1,4-phenylenediamine.

In some aspects, a molar ratio of the tetracarboxylic acid dianhydride to the diamine is from about 0.9 to about 1.1.

In another aspect is provided a method of forming a carbon aerogel comprising a carbon additive or precursor thereof, the method comprising: providing an aqueous solution of a polyamic acid salt; adding a carbon additive or precursor thereof to the aqueous solution; acidifying the polyamic acid salt solution to form a polyamic acid gel comprising the carbon additive or precursor thereof; drying the polyamic acid gel to form a polyamic acid aerogel comprising the carbon additive or precursor thereof; and isomorphically converting the polyamic acid aerogel comprising the carbon additive or precursor thereof to the carbon aerogel comprising the carbon additive, the converting comprising pyrolyzing the polyamic acid aerogel material under an inert atmosphere at a temperature of at least about 650° C.

In some aspects, the polyamic acid gel is in monolithic form, and acidifying the polyamic acid salt comprises adding delta-gluconolactone to the aqueous solution of the polyamic acid salt to form a gelation mixture and pouring the gelation mixture into a mold and allowing the gelation mixture to gel.

In some aspects, the polyamic acid gel is in bead form, and acidifying the polyamic acid salt comprises adding the aqueous solution of polyamic acid salt to a solution of a water-soluble acid in water to form the polyamic acid gel beads, wherein adding comprises dripping the aqueous solution of polyamic acid salt into the solution of the water-soluble acid in water, spraying the aqueous solution of polyamic acid salt under pressure through one or more nozzles into the solution of the water-soluble acid in water using pressure; or electrospraying the aqueous solution of polyamic acid salt into the solution of the water-soluble acid in water.

In some aspects, the water-soluble acid is a mineral acid or is acetic acid.

In some aspects, the method comprises electrospraying the aqueous solution of polyamic acid salt through one or more needles at a voltage in a range from about 5 to about 60 kV.

In some aspects, the polyamic acid gel is in microbead form, the method further comprising: combining the aqueous solution of polyamic acid salt with a water-immiscible solvent comprising a surfactant; mixing the resulting mixture under high-shear conditions to form an emulsion; and adding an organic acid to the emulsion.

In some aspects, the water-immiscible organic solvent is a C5-C12 hydrocarbon. In some aspects, the water-immiscible organic solvent is mineral spirits.

In some aspects, the organic acid is acetic acid.

In some aspects, providing the aqueous solution of the polyamic acid salt comprises: providing a polyamic acid in substantially pure form; adding the polyamic acid to water to form an aqueous suspension of the polyamic acid; adding a base to the aqueous suspension of the polyamic acid to form the aqueous solution of the polyamic acid salt.

In some aspects, the base is a non-nucleophilic amine.

In some aspects, the non-nucleophilic amine has a solubility of at least about 4 grams per 1 L of water at 20° C.

In some aspects, the non-nucleophilic amine is a tertiary amine. In some aspects, the non-nucleophilic amine is selected from the group consisting of triethylamine, trimethylamine, tri-n-butylamine, N-methylpyrrolidine, N-methylpiperidine, diisopropylethylamine, and combinations thereof. In some aspects, the non-nucleophilic amine is triethylamine or diisopropylethylamine.

In some aspects, the non-nucleophilic amine is added in a quantity sufficient to maintain substantially all of the polyamic acid in solution.

In some aspects, a molar ratio of the non-nucleophilic amine to the polyamic acid is from about 2 to about 4, or from about 2.2 to about 2.5.

In some aspects, the polyamic acid comprises a tetracarboxylic acid selected from the group consisting of benzene-1,2,4,5-tetracarboxylic acid, [1,1′-biphenyl]-3,3′,4,4′-tetracarboxylic acid, 4,4′-oxydiphthalic acid, 4,4′-sulfonyldiphthalic acid, 4,4′-carbonyldiphthalic acid, 4,4′-(propane-2,2-diyl)diphthalic acid, 4,4′-(perfluoropropane-2,2-diyl)diphthalic acid, naphthalene-1,4,5,8-tetracarboxylic acid, 4-(2-(4-(3,4-dicarboxyphenoxy)phenyl)propan-2-yl)phthalic acid, perylene tetracarboxylic acid, and combinations thereof.

In some aspects, the polyamic acid comprises a C2-C6 alkylene diamine, wherein optionally, one or more of the carbon atoms of the C2-C6 alkylene are substituted with one or more alkyl groups. In some aspects, the C2-C6 alkylene diamine is selected from the group consisting of ethylenediamine, 1,3-diaminopropane, 1,4-diaminobutane, 1,5-diaminopentane, 1,6-diaminohexane, and combinations thereof.

In some aspects, the polyamic acid comprises 1,3-phenylenediamine, 1,4-phenylenediamine, 4,4′-methylenedianiline, 4,4′-diaminodiphenyl ether, or a combination thereof. In some aspects, the polyamic acid comprises a diamine selected from the group consisting of 1,4-phenylenediamine, 4,4′-methylenedianiline, 4,4′-diaminodiphenyl ether, and combinations thereof.

In some aspects, a range of concentration of the polyamic acid salt in the solution is from about 0.01 to about 0.3 g/cm³, based on the weight of the polyamic acid.

In some aspects, providing an aqueous solution of a polyamic acid salt comprises: dissolving a water-soluble diamine in water to form an aqueous diamine solution; adding a non-nucleophilic amine to the aqueous diamine solution; adding a tetracarboxylic acid dianhydride to the aqueous diamine solution; and stirring the resulting mixture for a period of time in a range from about 1 hour to about 24 hours at a temperature in a range from about 15 to about 60° C.

In some aspects, the resulting mixture is stirred at a temperature in a range from about 15 to about 25° C. In some aspects, the resulting mixture is stirred at a temperature in a range from about 50 to about 60° C.

In some aspects, providing an aqueous solution of a polyamic acid salt comprises: dissolving a water-soluble diamine in water to form an aqueous diamine solution; adding a tetracarboxylic acid dianhydride to the aqueous diamine solution; stirring the resulting mixture for a period of time in a range from about 1 hour to about 24 hours at a temperature in a range from about 15 to about 60° C.; adding a non-nucleophilic amine to the mixture; and stirring the resulting mixture for a period of time in a range from about 1 hour to about 24 hours at a temperature in a range from about 15 to about 60° C.

In some aspects, the resulting mixture is stirred at a temperature in a range from about 15 to about 25° C. In some aspects, the resulting mixture is stirred at a temperature in a range from about 50 to about 60° C.

In some aspects, providing an aqueous solution of a polyamic acid salt comprises: adding to water, simultaneously or in rapid succession, a water-soluble diamine, a tetracarboxylic acid dianhydride, and a non-nucleophilic amine; and stirring the resulting mixture for a period of time in a range from about 1 hour to about 24 hours at a temperature in a range from about 15 to about 60° C.

In some aspects, the resulting mixture is stirred at a temperature in a range from about 15 to about 25° C. In some aspects, the resulting mixture is stirred at a temperature in a range from about 50 to about 60° C.

In some aspects, the water-soluble diamine, the tetracarboxylic acid dianhydride, and the non-nucleophilic amine are added to the water simultaneously. In some aspects, the water-soluble diamine, the tetracarboxylic acid dianhydride, and the non-nucleophilic amine are added to the water in rapid succession.

In some aspects, the non-nucleophilic amine has a solubility of at least about 4 grams per 1 L of water at 20° C.

In some aspects, the non-nucleophilic amine is a tertiary amine. In some aspects, the non-nucleophilic amine is selected from the group consisting of triethylamine, trimethylamine, tri-n-butylamine, N-methylpyrrolidine, N-methylpiperidine, and diisopropylethylamine. In some aspects, the non-nucleophilic amine is triethylamine or diisopropylethylamine

In some aspects, a molar ratio of the non-nucleophilic amine to the diamine is from about 2 to about 2.5.

In some aspects, the tetracarboxylic acid dianhydride is selected from the group consisting of pyromellitic anhydride (PMDA, biphthalic dianhydride (BPDA), oxydiphthalic dianhydride (ODPA), perylene tetracarboxylic dianhydride, and combinations thereof.

In some aspects, the diamine is a C2-C6 alkylene diamine, and wherein one or more carbon atoms of the C2-C6 alkylene are optionally substituted with one or more alkyl groups. In some aspects, the C2-C6 alkylene diamine is selected from the group consisting of ethylenediamine, 1,3-diaminopropane, 1,4-diaminobutane, 1,5-diaminopentane, 1,6-diaminohexane, and combination thereof.

In some aspects, the diamine is 1,4-phenylenediamine.

In some aspects, a molar ratio of the tetracarboxylic acid dianhydride to the diamine is from about 0.9 to about 1.1.

In a still further aspect is provided a metal- or metal oxide-doped carbon aerogel in the form of beads comprising a carbon additive, the method comprising: providing an aqueous solution of an ammonium or alkali metal salt of a polyamic acid; adding a carbon additive or precursor thereof to the aqueous solution; performing a metal ion exchange comprising adding the solution of the polyamic acid salt to a solution comprising a soluble metal salt to form polyamate metal salt gel beads comprising the carbon additive or precursor thereof; drying the polyamic acid metal salt gel beads to form polyamic acid metal salt aerogel beads comprising the carbon additive or precursor thereof; and isomorphically converting the polyamic acid metal salt aerogel beads comprising the carbon additive or precursor thereof to the metal- or metal oxide-doped carbon aerogel beads comprising the carbon additive, the converting comprising pyrolyzing the polyamic acid metal salt aerogel beads under an inert atmosphere at a temperature of at least about 650° C.

In some aspects, the soluble metal salt comprises a main group transition metal, a rare earth metal, an alkaline earth metal, or a combination thereof. In some aspects, the soluble metal salt comprises copper, iron, nickel, silver, calcium, magnesium, or a combination thereof. In some aspects, the soluble metal salt comprises lanthanum, cerium, praseodymium, neodymium, promethium, samarium, europium, gadolinium, terbium, dysprosium, holmium, erbium, thulium, ytterbium, lutetium, or a combination thereof.

In some aspects, adding the polyamic acid salt solution to a solution comprising a soluble metal salt comprises dripping the aqueous solution of polyamic acid salt into the solution of the soluble metal salt, spraying the aqueous solution of polyamic acid salt under pressure through one or more nozzles into the solution of the soluble metal salt, or electrospraying the aqueous solution of polyamic acid salt into the solution of the soluble metal salt.

In some aspects, the method comprises electrospraying the polyamic acid salt solution through one or more needles at a voltage in a range from about 5 to about 60 kV.

In some aspects, drying a polyimide gel comprises: optionally, washing or solvent exchanging the polyimide gel; and subjecting the optionally washed or solvent exchanged polyimide gel to elevated temperature conditions, lyophilizing the optionally washed or solvent exchanged polyimide gel, or contacting the optionally washed or solvent exchanged polyimide gel with supercritical fluid carbon dioxide.

In some aspects, the washing or solvent exchanging is performed with water, a C1 to C3 alcohol, acetone, acetonitrile, ether, tetrahydrofuran, toluene, liquid carbon dioxide, or a combination thereof.

In some aspects, the carbon additive is graphene, graphene oxide, carbon black, single wall carbon nanotubes, multiple wall carbon nanotubes, carbon nanofibers, or a combination thereof.

In some aspects, the carbon additive is soft carbon, the method comprising adding a soft carbon precursor. In some aspects, the soft carbon precursor comprises or is perylene tetracarboxylic dianhydride (PTCDA). In some aspects, the soft carbon precursor comprises or is pitch.

In some aspects, the carbon aerogel further comprises silicon, the method further comprising adding silicon to the aqueous solution.

In some aspects, the carbon aerogel further comprises void spaces within the aerogel, the method further comprising adding a sacrificial material to the aqueous solution. In some aspects, the sacrificial material is poly(methyl methacrylate) particles.

In some aspects, the carbon aerogel further comprises silicon, and void spaces within the aerogel, wherein at least a portion of the silicon is present in the void spaces, the method further comprising adding silicon particles modified with a sacrificial material to the aqueous solution. In some aspects, the sacrificial material comprises poly(methyl methacrylate).

In a yet further aspect is provided a carbon aerogel comprising a carbon additive, the carbon aerogel prepared according to the method disclosed herein.

In some aspects, the carbon aerogel comprises about 0.1 to about 20 by weight of carbon black.

In some aspects, the carbon aerogel comprises from about 0.01 to about 5% by weight of graphene or graphene oxide.

In some aspects, the carbon aerogel comprises about 0.1 to about 20% by weight of soft carbon.

In some aspects, the carbon aerogel comprises about 0.01 to about 10% by weight of single wall carbon nanotubes, multiple wall carbon nanotubes, carbon nanofibers, or a combination thereof.

In some aspects, the carbon aerogel further comprises silicon.

In some aspects, the carbon aerogel further comprises void spaces.

In some aspects, the carbon aerogel further comprises silicon and void spaces, wherein at least a portion of the silicon is present in the void spaces.

In some aspects, the carbon aerogel is in the form of a monolith. In some aspects, the carbon aerogel is in the form of beads.

### BRIEF DESCRIPTION OF THE DRAWINGS

In order to provide an understanding of aspects of the technology, reference is made to the appended drawings, which are not necessarily drawn to scale. The drawings are exemplary only, and should not be construed as limiting the technology. The disclosure described herein is illustrated by way of example and not by way of limitation in the accompanying figures.

FIG. 1 is flow chart depicting a generalized process for preparing a carbon aerogel material doped with a carbon additive according to a non-limiting aspect of the disclosure.

FIG. 2 is flow chart summarizing several generalized routes for forming carbon aerogel materials doped with a carbon additive according to non-limiting aspects of the disclosure.

FIG. 3A is flow chart depicting a process for preparing an alkali metal salt solution of a polyamic acid according to a non-limiting aspect of the disclosure.

FIG. 3B is flow chart depicting a process for preparing a solution of an ammonium salt of a polyamic acid according to a non-limiting aspect of the disclosure.

FIG. 3C is flow chart depicting three routes for in situ preparation of a solution of an ammonium salt of a polyamic acid according to non-limiting aspects of the disclosure.

FIG. 4 is flow chart depicting a process for preparing polyimide aerogel monoliths doped with a carbon additive or precursor according to a non-limiting aspect of the disclosure.

FIG. 5 is flow chart depicting another process for preparing polyimide aerogel monoliths doped with a carbon additive or precursor according to a non-limiting aspect of the disclosure.

FIG. 6 is flow chart depicting a process for preparing polyimide aerogel beads doped with a carbon additive or precursor according to a non-limiting aspect of the disclosure.

FIG. 7 is flow chart depicting another process for preparing polyimide aerogel microbeads doped with a carbon additive or precursor according to a non-limiting aspect of the disclosure.

FIG. 8 is flow chart depicting another process for preparing polyimide aerogel microbeads doped with a carbon additive or precursor according to a non-limiting aspect of the disclosure.

FIG. 9 is flow chart depicting a process for preparing polyamic acid aerogel monoliths doped with a carbon additive or precursor according to a non-limiting aspect of the disclosure.

FIG. 10A is flow chart depicting a process for preparing polyamic acid aerogel beads doped with a carbon additive or precursor according to a non-limiting aspect of the disclosure.

FIG. 10B is a cartoon illustration depicting formation of a polyamic acid wet-gel bead according to a non-limiting aspect of the disclosure.

FIG. 11 is flow chart depicting a process for preparing polyamic acid aerogel microbeads doped with a carbon additive or precursor according to a non-limiting aspect of the disclosure.

FIG. 12 is flow chart depicting a process for preparing metal polyamate aerogel beads doped with a carbon additive or precursor according to a non-limiting aspect of the disclosure.

FIG. 13 is flow chart depicting a process for preparing carbon aerogels doped with a carbon additive from polyamic acid aerogels according to a non-limiting aspect of the disclosure.

FIG. 14 is flow chart depicting a process for preparing carbon aerogels from polyamic acid or polyimide aerogels and carbon aerogels doped with a carbon additive according to non-limiting aspects of the disclosure.

FIG. 15 is flow chart depicting a process for preparing metal- or metal oxide-doped carbon aerogels further comprising a carbon additive from metal polyamate salt aerogels according to a non-limiting aspect of the disclosure.

FIG. 16A is a photomicrograph of graphene oxide doped polyimide gel beads according to a non-limiting aspect of the disclosure.

FIG. 16B is a high magnification scanning electron microscopy (SEM) photograph of carbon aerogel beads doped with graphene oxide according to a non-limiting aspect of the disclosure.

FIG. 17A is a photomicrograph of soft carbon doped polyimide gel beads according to a non-limiting aspect of the disclosure.

FIG. 17B is a high magnification scanning electron microscopy (SEM) photograph of carbon aerogel beads doped with soft carbon according to a non-limiting aspect of the disclosure.

FIG. 18A is a photomicrograph of carbon black doped polyimide gel beads according to a non-limiting aspect of the disclosure.

FIG. 18B is a high magnification scanning electron microscopy (SEM) photograph of carbon aerogel beads doped with carbon black according to a non-limiting aspect of the disclosure.

FIG. 19A is a photomicrograph of silicon/hard carbon doped polyimide aerogel beads according to a non-limiting aspect of the disclosure.

FIG. 19B is a high magnification scanning electron microscopy (SEM) photograph of silicon/carbon composite aerogel beads doped with hard carbon according to a non-limiting aspect of the disclosure.

FIG. 20A is a photomicrograph of silicon/PTCDA doped polyimide aerogel beads according to a non-limiting aspect of the disclosure.

FIG. 20B is a high magnification scanning electron microscopy (SEM) photograph of silicon/carbon composite aerogel beads doped with soft carbon according to a non-limiting aspect of the disclosure.

FIG. 21 is a plot showing the first cycle charge-discharge profiles with first cycle efficiency (FCE) of carbon aerogel beads tested in half-cell using lithium metal as counter electrode according to non-limiting aspects of the disclosure.

FIG. 22 is a plot showing the delithiation capacity over various numbers of cycles for silicon/carbon composite aerogel beads according to non-limiting aspects of the disclosure.

### DETAILED DESCRIPTION

Before describing several example aspects of the technology, it is to be understood that the technology is not limited to the details of construction or process steps set forth in the following description. The technology is capable of other aspects and of being practiced or being carried out in various ways. The aspects described herein are interchangeable, that is that features mentioned in the context of a particular aspect are not limited to that aspect but may be applied to and combined with each and every other aspect.

In general, the technology is directed to carbon materials, such as porous carbon materials, which include (i.e., are doped with) carbon additives such as soft carbon, graphene, graphene nanoribbons, graphene nanoplatelets, graphene oxide, carbon black, single wall carbon nanotubes, multiple wall carbon nanotubes, carbon nanofibers, or combinations thereof, and optionally further doped with silicon. The present technology is further directed to methods of preparation of such carbon additive-containing porous carbon materials. The methods generally comprise providing an organogel precursor; adding a carbon additive or precursor thereof to the organogel precursor; inducing gelation of the organogel precursor to provide an organogel doped with the carbon additive or precursor thereof; drying the organogel to form an organic aerogel doped with the carbon additive or precursor thereof; and pyrolyzing the doped organic aerogel. In the case of porous carbon materials comprising soft carbon as the additive, the method comprises adding a precursor of the soft carbon, such as pitch or perylene tetracarboxylic dianhydride (PTCDA). During subsequent pyrolyzation, such precursors are thermally converted to soft carbon.

As described above, it was surprisingly found according to the present disclosure that carbon aerogel beads comprising certain carbon additives, prepared as described herein, exhibited improved first cycle efficiency, reversible capacity, and lithiation potential relative to reference carbon aerogel beads (i.e., not including a carbon additive). Further, according to the present disclosure, it was surprisingly found that carbon aerogel materials comprising soft carbon retained the high efficiency of carbon aerogel materials comprising hard carbon. The disclosed sol-based methods are highly flexible with respect to the nature of the organogel precursor, the variety of forms of carbon additive which may be provided, and the overall ability to customize various aspects of the method, for example, to provide carbon aerogel materials with different physical forms and properties, and with different properties for the carbon additives therein.

Accordingly, provided herein is a method of forming a carbon aerogel comprising a carbon additive, the method comprising: providing a solution comprising an organogel precursor and a solvent; adding a carbon additive or precursor thereof to the organogel precursor solution; initiating gelation of the organogel precursor to provide an organogel comprising the carbon additive or precursor thereof; drying the organogel to form an organic aerogel comprising the carbon additive or precursor thereof; and isomorphically converting the organic aerogel to the carbon aerogel comprising the carbon additive, the converting comprising pyrolyzing the organic aerogel under an inert atmosphere at a temperature of at least about 650° C. The method may be conducted using aqueous or organic conditions, a wide variety of organogel precursors, and a wide variety of carbon additives or precursors thereof. Within the general method are numerous method permutations to accommodate the different additives, organogel precursors, and conditions, as well as to enable preparation of different forms of the carbon aerogel material (e.g., beads, microbeads, monoliths) and carbon aerogel materials doped with a further electroactive material (e.g., silicon). Each of the various methods are described further herein below.

### Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 angstroms. However, framework structures of the present disclosure can also include networks of interconnected oligomers, polymers, or colloidal particles of all diameter sizes that form the solid structure within in a gel or aerogel.

As used herein, the term “aerogel” refers to a solid object, irrespective of shape or size, comprising a framework of interconnected solid structures, with a corresponding network of interconnected pores integrated within the framework, and containing gases such as air as a dispersed interstitial medium. As such, and irrespective of the drying method used, aerogels are open non-fluid colloidal or polymer networks that are expanded throughout their whole volume by a gas, and are formed by the removal of all swelling agents from a corresponding wet-gel. Reference to an “aerogel” herein includes any open-celled porous materials which can be categorized as aerogels, xerogels, cryogels, ambigels, microporous materials, and the like, regardless of material (e.g., polyimide, polyamic acid, or carbon), unless otherwise stated.

Generally, aerogels possess one or more of the following physical and structural properties: (a) an average pore diameter ranging from about 2 nm to about 100 nm; (b) a porosity of about 60% or more; (c) a specific surface area of about 0 to about 100 m²/g or more, typically from about 0 to about 20, about 0 to about 100, or from about 100 to about 1000 m²/g. Typically, such properties are determined using nitrogen porosimetry testing and/or helium pycnometry. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite.

In some aspects, a gel material may be referred to specifically as a xerogel. As used herein, the term “xerogel” refers to a type of aerogel comprising an open, non-fluid colloidal or polymer networks that is formed by the removal of all swelling agents from a corresponding gel without any precautions taken to avoid substantial volume reduction or to retard compaction. A xerogel generally comprises a compact structure. In some embodiments, the xerogel may be a non-porous material. Xerogels suffer substantial volume reduction during ambient pressure drying, and generally have surface areas of 0-100 m²/g, such as from about 0 to about 20 m²/g as measured by nitrogen sorption analysis.

As used herein, reference to a “conventional” or “organic solvent-based” method of forming a polyamic acid or polyimide gel refers to a method in which a polyamic acid or polyimide gel is prepared in an organic solvent solution from condensation of a diamine and a tetracarboxylic acid dianhydride to form a polyamic acid, and optionally, dehydration of the polyamic acid to form a polyimide. See, for example, U.S. Pat. Nos. 7,071,287 and 7,074,880 to Rhine et al., and U.S. Patent Application Publication No. 2020/0269207 to Zafiropoulos, et al.

As used herein, the term “gelation” or “gel transition” refers to the formation of a wet-gel from a polymer system, e.g., a polyimide or polyamic acid as described herein. At a point in the polymerization or dehydration reactions as described herein, which is defined as the “gel point,” the sol loses fluidity. Without intending to be bound to any particular theory, the gel point may be viewed as the point where the gelling solution exhibits resistance to flow. In the present context, gelation proceeds from an initial sol state (e.g., a solution of an ammonium salt of a polyamic acid), through a highly viscous disperse state, until the disperse state solidifies and the sol gels (the gel point), yielding a wet-gel (e.g., polyimide or polyamic acid gel). The amount of time it takes for the polymer (e.g., ammonium salt of a polyamic acid or a polyimide) in solution to transform into a gel in a form that can no longer flow is referred to as the “phenomenological gelation time.” Formally, gelation time is measured using rheology. At the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G″ Crossover?” Polym. Eng. Sci., 1987, 27, 1698-1702; S.-Y. Kim, D.-G. Choi and S.-M. Yang “Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658.

Within the context of the present disclosure, the term “void” or “void space” used throughout this specification refer to the space that is “empty”, namely the space not utilized by either silicon or the three-dimensional carbon network.

As used herein, the term “wet-gel” or “wet organogel” refers to a gel in which the mobile interstitial phase within the network of interconnected pores is primarily comprised of a liquid phase such as a conventional solvent or water, liquefied gases such as liquid carbon dioxide, or a combination thereof. Aerogels typically require the initial production of a wet-gel, followed by processing and extraction to replace the mobile interstitial liquid phase in the gel with air or another gas. Examples of wet-gels include, but are not limited to: alcogels, hydrogels, ketogels, carbonogels, and any other wet-gels known to those in the art.

The term “alkyl” as used herein refers to a straight chain or branched, saturated hydrocarbon group generally having from 1 to 20 carbon atoms (i.e., C1 to C20). Representative alkyl groups include, but are not limited to, methyl, ethyl, n-propyl, n-butyl, n-pentyl, and n-hexyl; while branched alkyl groups include, but are not limited to, isopropyl, sec-butyl, isobutyl, tert-butyl, isopentyl, and neopentyl. An alkyl group can be unsubstituted or substituted. It is to be appreciated that ranges of carbon atoms described herein e.g. “C1 to C20” explicitly include each and every integer falling within the range ends as well as the range ends themselves i.e., C1, C2, C3, C4, C5 up to C20 as well as all subranges falling therewithin.

The term “alkenyl” as used herein refers to a hydrocarbon group generally having from 1 to 20 carbon atoms (i.e., C1 to C20), and having at least one site of unsaturation, i.e., a carbon-carbon double bond. Examples include, but are not limited to: ethylene or vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. An alkenyl group can be unsubstituted or substituted.

The term “alkynyl” as used herein refers to a hydrocarbon group generally having from 1 to 20 carbon atoms (i.e., C1 to C20), and having at least one carbon-carbon triple bond. Examples of alkynyl groups include, but are not limited to ethynyl and propargyl. An alkynyl group can be unsubstituted or substituted.

The term “aryl” as used herein refers to aromatic carbocyclic group generally having from 6 to 20 carbon atoms (i.e., C6 to C20). Examples of aryl groups include, but are not limited to, phenyl, naphthyl, and anthracenyl. An aryl group can be unsubstituted or substituted.

The term “cycloalkyl” as used herein refers to a saturated carbocyclic group, which may be mono- or bicyclic. Cycloalkyl groups include a ring having 3 to 7 carbon atoms (i.e., C3 to C7) as a monocycle, or 7 to 12 carbon atoms (i.e., C7 to C12) as a bicycle. Examples of monocyclic cycloalkyl groups include cyclopropyl, cyclobutyl, cyclopentyl, cyclohexyl, cycloheptyl, and cyclooctyl. A cycloalkyl group can be unsubstituted or substituted.

The term “substituted” as used herein and as applied to any of the above groups (alkyl, alkenyl, alkynyl, aryl, cycloalkyl, and the like), means that one or more hydrogen atoms of said group are each independently replaced with a substituent. Typical substituents include, but are not limited to, —X, —R, —OH, —OR, —SH, —SR, NH₂, —NHR, —N(R)₂, −N⁺(R)₃, —CX₃, —CN, —OCN, —SCN, —NCO, —NCS, —NO, —NO₂, —N₃, —NC(═O)H, —NC(═O)R, —C(═O)H, —C(═O)R, —C(═O)NH₂, —C(═O)N(R)₂, —SO₃—, —SO₃H, —S(═O)₂R, —OS(═O)₂OR, —S(═O)₂NH₂, —S(═O)₂N(R)₂, —S(═O)R, —OP(═O)(OH)₂, —OP(═O)(OR)₂, —P(═O)(OR)₂, —PO₃, —PO₃H₂, —C(═O)X, —C(═S)R, —CO₂H, —CO₂R, —CO₂—, —C(═S)OR, —C(═O)SR, —C(═S)SR, —C(═O)NH₂, —C(═O)N(R)₂, —C(═S)NH₂, —C(═S)N(R)₂, —C(═NH)NH₂, and —C(═NR)N(R)₂; wherein each X is independently selected for each occasion from F, Cl, Br, and I; and each R is independently selected for each occasion from C₁-C₂₀ alkyl and C₆-C₂₀ aryl. Wherever a group is described as “optionally substituted,” that group can be substituted with one or more of the above substituents, independently for each occasion.

It is to be understood that certain naming conventions can include various attachment scenarios, depending on the context. For example, where a substituent requires two points of attachment to the rest of the molecule, it is understood that the substituent is bidentate. For example, a substituent identified as alkyl but that requires two points of attachment includes forms such as —CH₂—, —CH₂CH₂—, —CH₂CH(CH₃)CH₂—, and the like. Other naming conventions clearly indicate that a group is bidentate, such as “alkylene,” “alkenylene,” “arylene,” and the like. Wherever a substituent is bidentate, it is to be understood that the substituent can be attached in any directional configuration unless otherwise indicated.

The term “substantially” as used herein, unless otherwise indicated, means to a great extent, for example, greater than about 95%, greater than about 99%, greater than about 99.9%, greater than 99.99%, or even 100% of a referenced characteristic, quantity, etc. as pertains to the particular context (e.g., substantially pure, substantially the same, and the like).

Reference herein to an aqueous solution means that the solution is substantially free of any organic solvent. The term “substantially free” as used herein in the context of organic solvents means that no organic solvent has been intentionally added, and no organic solvent is present beyond trace amounts. For example, in certain aspects, the aqueous solution can be characterized as having less than 1% by volume of organic solvent, or less than 0.1%, or less than 0.01%, or even 0% by volume of organic solvent.

### I. Method of Forming a Carbon Aerogel Comprising a Carbon Additive

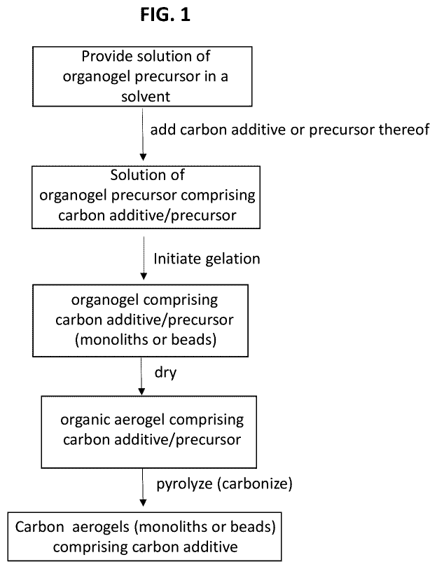

In one aspect is provided a method of forming a carbon aerogel comprising a carbon additive. The method generally comprises: providing a solution comprising an organogel precursor and a solvent; adding a carbon additive or precursor thereof to the organogel precursor solution; initiating gelation of the organogel precursor to provide an organogel comprising the carbon additive or precursor thereof; drying the organogel to form an organic aerogel comprising the carbon additive or precursor thereof; and pyrolyzing the organic aerogel comprising the carbon additive or precursor thereof. FIG. 1 provides a general, non-limiting flow chart illustrating the method according to an aspect of the disclosure. With reference to FIG. 1, the method comprises first providing a solution comprising an organogel precursor and a solvent. The organogel precursor, the solvent, and the method of providing the solution may vary.

### Organogels and Organogel Precursors

In some aspects, the organogel comprises a resorcinol-formaldehyde (RF) polymer, a phloroglucinol-furfuraldehyde (PF) polymer, polyacrylonitrile (PAN), a polyurethane (PU), a polyurea (PUA), a polyamine (PA), polybutadiene, polydicyclopentadiene, or a combination thereof. In such aspects, the precursor is the corresponding monomer (e.g., phloroglucinol and furfuraldehyde, acrylonitrile, an appropriate alcohol and appropriate isocyanate, an appropriate amine and appropriate isocyanate, an appropriate amine and appropriate reactive species, butadiene, cyclopentadiene, or combination thereof, respectively). One of skill in the art will recognize the appropriate reactants required to form the desired organogel.

In some aspects, the organogel comprises a polyimide, polyamic acid, or a combination thereof. In some aspects, the organogel is a polyimide, and the organogel precursor is a polyamic acid salt. Polyimides, polyamic acids, and polyamic acid salts, as well as methods of providing solutions of any thereof, are described further herein below.

The solvent utilized to provide the organogel precursor solution may vary based on, for example, the particular organogel precursor and the desired properties of the organogel. For example, the solvent may be water in cases where the organogel precursor is water soluble. In particular aspects, the organogel is a polyimide, polyamic acid, or a combination thereof, the organogel precursor is a polyamic acid salt, and the solvent is water. In some aspects, utilization of a predominantly or exclusively water-based process may be advantageous in, e.g., avoiding use of potentially toxic and expensive solvents and their associated disposal costs.

In other aspects, the solvent is a polar, aprotic organic solvent. Such organic solvents may be utilized for the preparation of any of the aforementioned organogels, including but not limited to polyimide and polyamic acid organogels. In some aspects, the solvent is N,N-dimethylacetamide, N,N-dimethylformamide, N-methylpyrrolidone, or a combination thereof.

### Carbon Additives and Precursors

With continued reference to FIG. 1, the method comprises adding a carbon additive or precursor thereof to the organogel precursor solution. In some aspects, the carbon additive is graphene, graphene nanoribbons, graphene nanoplatelets, graphene oxide, carbon black, single wall carbon nanotubes, multiple wall carbon nanotubes, carbon nanofibers, or a combination thereof. In such aspects, the method comprises adding the appropriate carbon additive to the organogel precursor solution. As described further herein below, once the organogel precursor is caused to undergo gelation, forming the corresponding organogel, the organogel comprises the carbon additive dispersed in the organogel matrix. After subsequent drying and pyrolysis, further herein below, the corresponding carbon aerogel is obtained, in which the carbon additive is dispersed in the carbon aerogel matrix.

In some aspects, the carbon additive is carbon black.

In some aspects, the carbon additive is single wall carbon nanotubes, multiple wall carbon nanotubes, or carbon nanofibers.

In some aspects, the carbon additive is graphene or graphene oxide. In some aspects, the carbon additive is graphene nanoribbons, graphene nanoplatelets, Graphene ribbons are described in, for example, U.S. Pat. No. 10,640,384 to Nguyen, incorporated by reference herein.

In other aspects, the carbon additive is soft carbon. In such aspects, the method comprises adding a soft carbon precursor to the organogel precursor solution. In some aspects, the soft carbon precursor comprises or is perylene tetracarboxylic dianhydride (PTCDA). In some aspects, the soft carbon precursor comprises or is or pitch. As described further herein below, once the organogel precursor is caused to undergo gelation, forming the corresponding organogel, the organogel comprises the carbon additive precursor dispersed in the organogel matrix. After subsequent drying and pyrolysis, further herein below, the corresponding carbon aerogel is obtained, in which the carbon additive is dispersed in the carbon aerogel matrix. Specifically, it has been found according to the present disclosure that pyrolysis of an organogel material comprising suitable soft carbon precursors, such as PTCDA or pitch, surprisingly results in carbonization of the carbon precursor material, providing soft carbon dispersed throughout the carbon aerogel matrix. Depending on the pyrolysis temperature, the soft carbon precursor may also be graphitized (e.g., by utilizing high pyrolysis temperatures, such as about 2000° C.). Advantageously, conversion of the soft carbon precursor to soft carbon may be achieved at temperatures of less than 1000° C., such as about 850° C. Such lower pyrolysis temperatures are desirable in reducing the energy demands associated with such pyrolysis.

As described herein above, the disclosed method of forming a carbon aerogel comprising a carbon additive has multiple advantages relative to other potential methods of incorporating carbon materials into carbon aerogels. Particularly, the method is highly flexible with respect to the type of carbon incorporated, the type of organogel which may be utilized, and the conditions under which the gelation may be performed. Further, the method allows the fine tuning of the properties of the carbon aerogel, the carbon additive within the aerogel, and the associated physical and electrochemical properties of the carbon aerogel. The method is further amenable to the simultaneous incorporation of electroactive materials such as silicon with the carbon additive, as described further herein below.

### Initiating Gelation

With continued reference to FIG. 1, the method comprises initiating gelation of the organogel precursor to provide an organogel comprising the carbon additive or precursor thereof. Initiating gelation may comprise exposure of the organogel precursor solution to various conditions or reagents depending on the specific organogel precursor utilized. In some aspects, the organogel comprises a resorcinol-formaldehyde (RF) polymer, a phloroglucinol-furfuraldehyde (PF) polymer, polyacrylonitrile (PAN), a polyurethane (PU), a polyurea (PUA), a polyamine (PA), polybutadiene, polydicyclopentadiene, or a combination thereof, and initiating gelation comprises one or more of contacting corresponding reactive components with one another under suitable conditions, heating the organogel precursor solution, exposing the organogel precursor solution to an appropriate polymerization catalyst, or the like. Suitable conditions for initiating gelation (e.g., polymerizing) the organogel precursor(s) will be known to one of skill in the art, and may be readily selected.

In some aspects, the organogel comprises a polyamic acid, the organogel precursor is a polyamic acid salt, and initiating gelation comprises inducing precipitation of the corresponding polyamic acid. In some aspects, the organogel comprises or is a polyimide, the organogel precursor is a polyamic acid salt, and initiating gelation comprises imidizing the polyamic acid salt. Organogels comprising polyimides or polyamic acids, the corresponding organogel precursors and methods of providing solutions thereof, as well as methods of initiating gelation of each thereof are all further described herein below.

### Electroactive Material-Doped Gels

In some aspects, any of the organogels and aerogels as disclosed herein may be doped with an electroactive material, for example, silicon, such as silicon particles, to provide electroactive material-doped carbon aerogels. Accordingly, in some aspects, the method further comprises adding silicon particles to the organogel precursor solution.

Within the context of the present disclosure, the term “silicon particles” refers to silicon or silicon-based materials with a range of particle sizes suitable for use with polyimide or carbon gels as disclosed herein. Silicon particles of the present disclosure can be nanoparticles, e.g., particles with two or three dimensions in the range of about 1 nm to about 150 nm. Silicon particles of the present disclosure can be fine particles, e.g., micron-sized particles with a maximum dimension, e.g., a diameter for a substantially spherical particle, in the range of about 150 nm to about 10 micrometers or larger. For example, silicon particles of the present disclosure can have a maximum dimension, e.g., a diameter for a substantially spherical particle, of about 10 nm, 50 nm, 100 nm, 150 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values. In some aspects, the particles are flat fragmented shapes, e.g., platelets, having two dimensions, e.g., a length and a width, of about 10 nm, 50 nm, 100 nm, 150 nm, 200 nm, 500 nm, 1 micrometer, 1.5 micrometers, 2 micrometers, 3 micrometers, 5 micrometers, 10 micrometers, 20 micrometers, 40 micrometers, 50 micrometers, 100 micrometers, or in a range between any two of these values. In some aspects, the silicon particles can be monodispersed or substantially monodispersed. In other aspects, the silicon particles can have a particle size distribution. Within the context of the present disclosure, the dimensions of silicon particles are provided based upon the median of the particle size distribution, i.e., the D50. Silicon particles of the present disclosure can be silicon wires, crystalline silicon, amorphous silicon, silicon alloys, silicon oxides (SiOₓ), coated silicon, e.g., carbon coated silicon, and any combinations of silicon particle materials disclosed herein. In some aspects, silicon particles can be substantially planar flakes, i.e., having a flat fragmented shape, which can also be referred to as a platelet shape. For example, the particles have two substantially flat major surfaces connected by a minor surface defining the thickness between the major surfaces. In other aspects, particles of silicon or other electroactive materials can be substantially spherical, cubic, obloid, elliptical, disk-shaped, or toroidal. Silicon may also be present in the form of a thin film e.g., a thin film including silicon formed after vapor deposition of silicon (e.g., chemical vapor deposition) into the composite material.

Silicon particles can be produced by various techniques, including electrochemical reduction and mechanical milling, i.e., grinding. Grinding can be conducted using wet or dry processes. In dry grinding processes, powder is added to a vessel, together with grinding media. The grinding media typically includes balls or rods of zirconium oxide (yttrium stabilized), silicon carbide, silicon oxide, quartz, or stainless steel. The particle size distribution of the resulting ground material is controlled by the energy applied to the system and by matching the starting material particle size to the grinding media size. However, dry grinding is an inefficient and energy consuming process. Wet grinding is similar to dry grinding with the addition of a grinding liquid. An advantage of wet grinding is that the energy consumption for producing the same result is 15-50% lower than for dry grinding. A further advantage of wet grinding is that the grinding liquid can protect the grinding material from oxidizing. It has also been found that wet grinding can produce finer particles and result in less particle agglomeration.

Wet grinding can be performed using a wide variety of liquid components. In an exemplary aspect, the grinding liquid or components included in the grinding liquid are selected to reduce or eliminate chemical functionalization on the surface of the silicon particles during or after grinding. In other aspects, the grinding liquid or components included in the grinding liquid are selected to provide a desired surface chemical functionalization of the particles, e.g., the silicon particles, during or after grinding. The grinding liquid or components included in the grinding liquid can also be selected to control the chemical reactivity or crystalline morphology of the particles, e.g., the silicon particles. In exemplary aspects, the grinding liquid or components included in the grinding liquid can be selected based on compatibility or reactivity with downstream materials, processing steps or uses for the particles, e.g., the silicon particles. For example, the grinding liquid or components included in the grinding liquid can be compatible with, useful in, or identical to the liquid or solvent used in a process for forming or manufacturing organic or inorganic aerogel materials. In yet another aspect, the grinding liquid can be selected such that the grinding liquid or components included in the grinding liquid produce a coating on the silicon particle surface or an intermediary species, such as an aliphatic or aromatic hydrocarbon, or by cross-linking or producing cross-functional compounds, that react with the organic or inorganic aerogel material.

The solvent or mixture of solvents used for grinding can be selected to control the chemical functionalization of the particles during or after grinding. Using silicon as an example, and without being bound by theory, grinding silicon in alcohol-based solvents, such as isopropanol, can functionalize the surface of the silicon and covalently bond alkyl surface groups, e.g., isopropyl, onto the surface of the silicon particles. With air exposure, the alkyl groups can transform to corresponding alkoxides through oxidation as evidenced by FTIR-ATR analysis. In exemplary aspects, grinding can be carried out in polar aprotic solvents such as DMSO, DMF, NMP, DMAC, THF, 1,4-dioxane, diglyme, acetonitrile, water or any combination thereof.

Generally, the electroactive material (e.g., silicon) particles are incorporated during the sol-gel process (i.e., the particles are added to the organogel precursor solution prior to or during gelation thereof). In some aspects, electroactive material (e.g., silicon) particles are dispersed in a solvent, e.g., water, or a polar, aprotic solvent, before combination with the organogel precursor solution. In one non-limiting aspect, the organogel precursor is a polyamic acid salt solution, and the electroactive material (e.g., silicon) particles are dispersed in the polyamic acid salt solution prior to imidization, or during the imidization process. In some aspects, an electroactive material is added to an aqueous solution of a polyamic acid salt. In some aspects, the electroactive material is silicon.

In some aspects, the individual silicon particles are dispersed heterogeneously throughout the three-dimensional carbon network. In some aspects, the individual silicon particles are dispersed homogenously throughout the three-dimensional carbon network. The expression “homogenously dispersed” refers to a distribution of the Si particles throughout the three-dimensional carbon network without large variations in the local concentration across the accessible network surface.

In some aspects, about 30 wt % to 70 wt %, about 20 wt % to about 50 wt % of the dispersed individual silicon particles within the plurality of silicon particles are in an agglomerated state. In some aspects, less than about 30 wt %, less than about 20 wt %, less than about 10 wt % of the dispersed individual silicon particles within the plurality of silicon particles are in an agglomerated state. In some aspects, homogenously distributed Si particles may refer to a distribution of the plurality of Si particles throughout the porous polymer network having less than about 30 wt %, less than about 20 wt %, less than about 10 wt % of the dispersed individual silicon particles within the plurality of silicon particles in an agglomerated state.

### Void Spaces

In some aspects, the carbon aerogel materials disclosed herein comprise void spaces within the aerogel matrix. Such void spaces may be produced by introducing sacrificial particles into the matrix during preparation thereof. In some aspects, the carbon aerogel material includes sacrificial particles. In some aspects, sacrificial particles of the present disclosure are made from sacrificial materials. In some aspects, sacrificial particles of the present disclosure include sacrificial materials. Within the context of the present disclosure, the term “sacrificial material” refers to a material that is intended to be sacrificed or at least partially removed in response to mechanical, thermal, chemical and/or electromagnetic conditions experienced by the material. For example, the sacrificial material can decompose when exposed to high temperatures or high and/or continuous stress.

The sacrificial material can be selected from the group consisting of siloxanes, polyolefins, polyurethanes, phenolics, melamine, cellulose acetate, and polystyrene. In some cases, material layer is in the form of foam. In some aspects, the sacrificial material can be worn away due to exposure to mechanical (such as cyclical) loads. In some aspects, sacrificial layer decomposes after exposure to a singular mechanical, chemical and/or thermal event.

In some aspects, the onset temperature of chemical decomposition of the sacrificial material is in the range of about 100° C. to about 700° C., about 100° C. to about 500° C., about 200° C. to about 400° C. The sacrificial particles can be made of polymers, metals, natural and synthetic organics, salts, ceramic compounds or combination thereof.

Polymers for use in the sacrificial material can be selected from a wide variety of thermoplastic resins, blends of thermoplastic resins, or thermosetting resins. Examples of thermoplastic resins that can be used include polyacetals, polyacrylics, styrene acrylonitrile, polyolefins, acrylonitrile-butadiene-styrene, polycarbonates, polystyrenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, and the like, or a combination comprising at least one of the foregoing thermoplastic resins.

Examples of blends of thermoplastic resins that can be used in the sacrificial material include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR), and the like, or a combination comprising at least one of the foregoing blends.

Examples of polymeric thermosetting resins that can be used in the sacrificial material include polyurethanes, epoxies, phenolics, polyesters, polyamides, silicones, and the like, or a combination comprising at least one of the foregoing thermosetting resins. Blends of thermosetting resins as well as blends of thermoplastic resins with thermosetting resins can be used.

In some aspects, the sacrificial particles comprise a polymer having a pyrolysis yield of less than 30 wt %, less than 20 wt %, less than 18 wt %, less than 15 wt %, less than 10 wt %, less than 8.0 wt %, or less than 5.0 wt %.

In some aspects, the sacrificial particles are formed from a material selected from polymethylmethacrylate (PMMA), polyvinylpyrrolidone (PVP), polyvinyl acetate (PVAc), polyvinyl alcohol (PVA), polyacrylonitrile (PAN), polyethylene oxide (PEO), polypropylene oxide (PPO), polyethyleneimine (PEI), polyurethane, poly(3,4-ethylenedioxythiophene, PEDOT), polyvinylbutyral, polyethylene oxide copolymer, polypropylene oxide copolymer, polycarbonate (PC), polyvinylchloride (PVC), polycaprolactone, polyvinylidene fluoride, polystyrene or combination thereof.

In some aspects, the sacrificial particles comprise poly-(styrene), poly-(ester), poly-(methacrylate), poly-(acrylate), poly-(ethylene glycol), poly-(acid amides), poly-(norborene), or combination thereof. In one aspect, the sacrificial particles comprise poly(methyl methacrylate).

The sacrificial particles are typically provided from the same source and have a known, desired particle size, shape, porosity and other material attributes that are substantially similar. In some examples, the sacrificial particles have a diameter of less than 1000 nm, less than 800 nm, less than 500 nm, less than 300 nm, less than 250 nm, less than 200 nm, less than 150 nm or less than 100 nm.

Accordingly, in some aspects, the method further comprises adding polymer particles to the organogel precursor solution prior to gelation. This sacrificial polymer particulate material forms voids in the corresponding carbon aerogel material during for example, subsequent pyrolysis. In some aspects, the sacrificial polymer particulate material is poly(methyl methacrylate).

In some aspects, the carbon aerogel comprises void spaces within the aerogel matrix, and the carbon aerogel further comprises silicon, where at least a portion of the silicon resides within said void spaces. In some aspects, the carbon aerogel material provided herein further comprises silicon particles and a three-dimensional carbon network, wherein the void space is between an exterior surface of the silicon particles and the three-dimensional carbon network. The void space between the exterior surface of the silicon particles and the three-dimensional carbon network may lead to a good dispersion and aggregation resistant of silicon particles. A void space which sufficiently accommodates the volume expansion of the silicon particles provide free space for volume expansion accommodation. The existence of voids may reserve space for silicon particles during volume expansion and buffer the mechanical pressure of the three-dimensional carbon network, resulting in significantly enhanced structural integrity. Without wishing to be bound by theory, accommodating volume expansion of silicon particles may delay fracturing of silicon particles due to continuous charging and discharging battery cycles.

In some aspects, the void space is between an exterior surface of the silicon particles and the three-dimensional carbon network. That is, the voids at least partially surround or encompass the silicon particles, and as a result are able to accommodate volumetric changes in the silicon particles.

In some aspects, a volume of the void space is between 1% to 20%, between 3% to 15%, between 5% to 15%, between 3% to 10%, between 5% to 10% of a volume of the silicon particles.

### Sacrificial Layer

In some aspects, in order to produce a silicon-carbon composite material having void spaces at least partially surrounding or encompassing the silicon particles, a sacrificial layer is first produced on at least a portion the exterior surface of the silicon particles. The sacrificial layer of the present technology provides the advantage of designing a void space, the volume of which can be controlled. That is, the void space between the exterior surface of the silicon particles and the three-dimensional carbon network can be created by partial or complete removal of the sacrificial layer. By adjusting the thickness of the sacrificial layer of the present technology, the volume of the void space can be controlled.

In another aspect, the volume of the void space can be adjusted by controlling the amount of sacrificial layer that is removed (e.g. decomposed) when exposed to external stimulus/agent. Without wishing to be bound by the theory, as the amount of sacrificial layer that is removed increases, the volume of the void space becomes larger.

In some aspects, the volume of void space is tailored or controlled by controlling the distribution of silicon particles. In certain aspects, the volume of void space is tailored or controlled by designing the number or silicon particles (e.g., volume percent of particles, volume percent of sacrificial layer content) within the composite material.

Accordingly, in some aspects, the method further comprises adding sacrificial material coated silicon to the organogel precursor solution, wherein the sacrificial material forms voids in the corresponding carbon aerogel during the subsequent pyrolyzing. Methods of providing sacrificial material coated silicon material are further described below.

In some aspects, prior to formation of a sacrificial layer, the silicon particle (e.g., silicon nanoparticle) surface can be modified with functional groups that can aid in dispersing the silicon particles in a porous network. In another example, formation of the sacrificial layer may can further aid in dispersing the silicon particles in a porous network. In an example, the porous network can be a sol-gel, aerogel, xerogel, foam structure, among others.

For example, functional groups can be grafted onto the surface of the silicon particles by covalent bonds. Before functionalization, the surface of the silicon particles includes silane groups, such as silicon hydride, and/or silicon oxide groups. In some aspects, at least a portion of those silane and silicon oxide groups can be present in combination with the bonded functional groups after functionalization of the surface of the silicon particle, e.g., the silicon particle surface can include silane groups and the covalently attached functional groups, silicon oxide groups and the covalently attached functional groups, or both silane and silicon oxide groups and the covalently attached functional groups. The presence of the functional groups on the surface of the silicon particles can be detected by various techniques, for example, by infrared spectroscopy.

The surface of the silicon particles can be functionalized with hydrophilic groups to aid in improved dispersion within the porous network. Without being bound by theory, the functionalization with hydroxide groups creates increased covalent bonding between the surface groups on the silicon particles and the porous network. As a result, the functionalized silicon particles can be uniformly dispersed within the porous network. For example, hydrophilic hydroxide groups can be grafted to the surface of the particles by unsaturated glycol to increase the hydrophilicity of silicon particle surfaces. Increasing the hydrophilicity of the silicon particles allows for the particles to be and remain more uniformly dispersed in the network and remain uniformly dispersed in the network in any additional processing (e.g., pyrolysis). In an example, functionalization via glycol can improve the dispersion of silicon particles within a polyimide sol-gel and/or aerogel or carbon aerogel. Any suitable glycol can be used including, but not limited to, ethylene glycol methyl ether methacrylate, poly(ethyleneglycol) methyl ether methacrylate, among others.

To provide silicon particles comprising a sacrificial layer, first, silicon particles are provided. In general, the silicon particles should be homogenous. That is, the silicon particles are typically provided from the same source and have a known, desired particle size, shape, porosity and other material attributes that are substantially similar. After procuring the silicon particles, the method includes oxidizing a surface of the particles to obtain hydroxyl functional groups on the surface. Oxidation of the surfaces of silicon particles is necessary for further functionalization of the surfaces. Oxidizing the surface of silicon particles may lead to complete or partial oxidation of surface Si—H groups. That is, all or certain percentage of Si—H groups on the surface of the silicon particles are converted to Si—OH groups after the oxidation process. The silicon particles may be oxidized in a single or multiple step(s). The oxidation can be thermal (e.g. at elevated temperatures under air), chemical (e.g. acid and/or oxidizing agent), electrochemical or combinations thereof.

Oxidizing a surface of the plurality of the silicon particles may comprise an acid treatment step. In some aspects, the acid treatment step comprises the use of sulphochromic acid or H₂O₂ (hydrogen peroxide). In some examples, the acid treatment step comprises a step of sonicating the plurality of the silicon particles for a certain period of time, e.g. at least 5 minutes, at least 10 minutes, at least 20 minutes, at least 30 minutes, or at least 60 minutes. Oxidizing a surface of the plurality of the silicon particles may comprise a step of pyrolysis at a temperature about at 300, about 400, or about 500, to about 600, about 650, about 700, about 800, about 850, or about 900° C. In some aspects, the temperature is about 650° C.

The third step is to form a sacrificial layer onto at least a portion of a surface of the silicon particles. The formation of sacrificial layer on the surface of the silicon particles is performed before introducing the silicon particles into a sol-gel solution comprising a precursor of porous three-dimensional network. The properties of the sacrificial layer (e.g. thickness, the type of the material) formed in the third step can affect the dispersion of the silicon particles in the sol-gel solution. The sacrificial layer can be made of polymers, metals, natural and synthetic organics, salts, ceramic compounds or combination thereof.

In some aspects, the sacrificial layer is formed from a material selected from polymethylmethacrylate (PMMA), polyvinylpyrrolidone (PVP), polyvinyl acetate PVAc), polyvinyl alcohol (PVA), polyacrylonitrile (PAN), polypropylene oxide (PEO), polypropylene oxide (PPO), polyethylene oxide copolymer, polypropylene oxide copolymer, polycarbonate (PC), polyvinylchloride (PVC), polycaprolactone, polyvinylidene fluoride, polystyrene or combination thereof. In some aspects, the sacrificial layer is formed from polymethylmethacrylate (PMMA).

In some aspects, the sacrificial layer has a thickness of less than or equal to about 100 nm, or a thickness between about 100 nm and about 60 nm, or a thickness of about 60 nm to 0.3 nm. In some aspects, the sacrificial layer has a thickness in the range of about 20% to about 0.01% of the diameter of the silicon particle.

In some aspects, the sacrificial layer has a carbonization yield of less than about 20 wt %. In some aspects, the temperature of chemical decomposition of the sacrificial material layer is in the range of about 130° C. to about 850° C.

In some aspects, forming the sacrificial layer comprises: i. grafting a polymer initiator on the surface of the silicon particles to react with a monomer; ii. polymerizing the monomer on the surface of the silicon particles to form the sacrificial layer. In the first step, the silicon particles having hydroxyl functional groups on the surface thereof covalently reacts with a functional silane group. The step of covalently reacting hydroxyl groups on the surface of the silicon particles includes the use of at least one functional group selected from 3-aminopropyltriethoxysilane (APTES), 3-aminopropyltrimethoxysilane (APTMS), N-(2-aminoethyl)-3-aminopropyltriethoxysilane (AEAPTES), and N-(2-aminoethyl)-3-aminopropyltrimethoxysilane (AEAPTMS), and N-(6-aminohexyl)aminomethyltriethoxysilane (AHAMTES), or combination thereof. In some aspects, 3-aminopropyltriethoxysilane (APTES) may be used as the functional silane group. Hydroxyl groups react with the silane groups in a polar solvent (e.g. ethanol). The selected polar solvent should be suitable for dissolving each component, e.g. the polymer initiator, the silicon particles, of the reaction.

After covalently attaching the at least one functional group (e.g., APTES) on the surface of the silicon particles to form silicon particles comprising —NH₂ groups on the surface, a polymer initiator is grafted on the surface of the silicon particles for further reaction with a monomer. In some aspects, the polymer initiator comprises azobis(4-cyanovaleric acid) (ACPA), 2,2′-azobis(2-amidinopropane) hydrochloride (V50), ammonium persulfate, 2,2′-azobis (N,N′-dimethylene isobutyramidine) dihydrochloride (VA044), and ammonium persulfate/sodium meta bisulfite. In some aspects, the polymer initiator comprises azobis(4-cyanovaleric acid) (ACPA).

Grafting a polymer initiator on the surface of the silicon particles takes place in a polar solvent (e.g. ethanol). The monomer initiators on the surface the silicon particles undergo a polymerization reaction with a monomer e.g. methyl methacrylate. The monomer chosen for the polymerization reaction depends on the type of the sacrificial layer that is desired on the surface. The polymerization reaction can take place in a polar solvent (e.g. water). The polymerization reaction takes place at a temperature higher than 25° C.

In some aspects, the surface modification takes place prior to adding the silicon particles to the sol precursor solution. In other aspects, the surface modification is performed within the sol precursor solution during or after initiation of gelation. In some aspects, the surface modification is performed both prior to dispersing the silicon particles in the sol precursor and after the sacrificial layer has been formed.

After formation of the sacrificial layer, either before dispersing the modified silicon particles in the sol precursor solution, after dispersing the modified silicon particles in the sol precursor solution, or both, and following processing of the organogel material as described herein below, at least a portion of the sacrificial layer is removed.

The sacrificial layer of the present disclosure can be partially or completely removed by mechanical, thermal, chemical and/or electromagnetic forces and/agents applied to the sacrificial layer. The way that the sacrificial material is removed depends primarily on the type of the sacrificial material is used. For example, synthetic and natural organics when used as a sacrificial layer can be partially or completely removed through pyrolysis by applying long thermal treatments at temperatures between 130 and 850° C. Sacrificial layer of the present technology can be partially or completely removed during charging and discharging battery cycles due to continuous mechanical and/or temperature and/or chemical changes experienced by the sacrificial layer. Partial or complete removal of the sacrificial layer during battery cyclic processes may generate void spaces between the surface of the silicon particles and the three-dimensional network. Without wishing to be bound by theory, the generated void spaces may allow accommodating volume changes of Si particles upon lithiation process.

In one aspect, the sacrificial layer of the present technology provides the advantage of designing in void spaces the size of which can be adjusted. That is, the size of the void space between the surface of the silicon particles and the three-dimensional network created by removal of the sacrificial layer can be tailored by changing the thickness of the sacrificial layer provided herein.

In one aspect, the amount of sacrificial layer that is removed depends on the duration of heat treatment, e.g. pyrolysis, applied to the porous carbon network comprising the silicon particles. In some aspects, the method further comprises processing the porous carbon network comprising the silicon particles to substantially remove the sacrificial layer e.g. pyrolyzing the porous network. In one aspect, the processing includes heating the porous carbon network comprising the silicon particles to a chemical decomposition temperature of the sacrificial layer. In some aspects, the chemical decomposition temperature of the sacrificial material layer is in the range of about 130° C. to about 850° C. In certain aspects, processing the composite material to partially or completely remove the sacrificial layer provides a void space around the silicon particles. In some aspects, the sacrificial layer is removed simultaneously during pyrolysis of the organic aerogel material including the carbon additive or precursor thereof. In other aspects, the sacrificial layer is removed or partially removed in a separate step prior to pyrolysis to convert the organic aerogel material and carbon precursor, when present, to the corresponding carbon-silicon composite material comprising the carbon material.

### Drying the Organogel

With continued reference to FIG. 1, the method comprises drying the organogel to form an organic aerogel comprising the carbon additive or precursor thereof. In some aspects, drying the organogel comprises optionally, washing or solvent exchanging the organogel; and subjecting the organogel to elevated temperature conditions, lyophilizing the organogel, or contacting the organogel with supercritical fluid carbon dioxide.

The wet organogel material obtained from gelation of the organogel precursor material may be washed or solvent exchanged in a suitable secondary solvent to replace the primary reaction solvent (i.e., water) present in the wet-gel. Such secondary solvents may be linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclic ethers or their derivatives. In some aspects, the secondary solvent is water, a C1 to C3 alcohol (e.g., methanol, ethanol, propanol, isopropanol), acetone, tetrahydrofuran, ethyl acetate, acetonitrile, supercritical fluid carbon dioxide (CO₂), or a combination thereof. In some aspects, the secondary solvent is ethanol.

Following the optional washing or solvent exchange, the liquid phase of the organogel material can then be at least partially extracted from the wet organogel material using extraction methods, including processing and extraction techniques, to form an aerogel material (i.e., “drying”). Liquid phase extraction, among other factors, plays an important role in engineering the characteristics of aerogels, such as porosity and density, as well as related properties such as thermal conductivity. Generally, aerogels are obtained when a liquid phase is extracted from a wet-gel in a manner that causes low shrinkage to the porous network and framework of the wet-gel. Wet-gels can be dried using various techniques to provide aerogels or xerogels. In exemplary aspects, wet-gel materials can be dried at ambient pressure, under vacuum (e.g., through freeze drying), at subcritical conditions, or at supercritical conditions to form the corresponding dry gel (e.g., an aerogel, such as a xerogel).

In some aspect, it may be desirable to fine tune the surface area of the dry gel. If fine tuning of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet-gel material at a temperature and pressure near or above the critical point of the liquid mobile phase. Once the critical point is reached (near critical) or surpassed (supercritical; i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain aspects of the present disclosure, the use of near-critical conditions just below the critical point of the solvent system may allow production of aerogels or compositions with sufficiently low shrinkage, thus producing a commercially viable end-product.

Wet organogels can be dried using various techniques to provide aerogels. In example aspects, wet organogel material can be dried at ambient pressure, at subcritical conditions, or at supercritical conditions.

Both room temperature and high temperature processes can be used to dry gel materials at ambient pressure. In some aspects, a slow ambient pressure drying process can be used in which the wet organogel material is exposed to air in an open container for a period of time sufficient to remove solvent, e.g., for a period of time in the range of hours to weeks, depending on the solvent, the quantity of wet organogel material, the exposed surface area, the size of the wet organogel material, and the like.

In another aspect, the wet organogel material is dried by heating. For example, the wet organogel material can be heated in a convection oven for a period of time to evaporate most of the solvent (e.g., ethanol). After partially drying, the gel can be left at ambient temperature to dry completely for a period of time, e.g., from hours to days. This method of drying produces xerogels.

In some aspects, the wet organogel material is dried by freeze drying. By “freeze drying” or “lyophilizing” is meant a low temperature process for removal of solvent that involves freezing a material (e.g., the wet organogel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet organogel materials. This method of drying produces cryogels, which may closely resemble aerogels.

Both supercritical and sub-critical drying can be used to dry wet organogel materials. In some aspects, the wet organogel material is dried under subcritical or supercritical conditions. In an example aspect of supercritical drying, the gel material can be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure. Generally, aerogels are obtained by this process.

In an example aspect of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying aerogels, as well as ambient drying techniques. For example, Kistler (J. Phys. Chem. (1932) 36: 52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically extracting the fluid from the sol-gel. U.S. Pat. No. 6,315,971 discloses a process for producing gel compositions comprising: drying a wet gel comprising gel solids and a drying agent to remove the drying agent under drying conditions sufficient to reduce shrinkage of the gel during drying. U.S. Pat. No. 5,420,168 describes a process whereby resorcinol/formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction. Other examples of extracting a liquid phase from aerogel materials can be found in U.S. Pat. Nos. 5,275,796 and 5,395,805.

In some aspects, extracting the liquid phase from the wet organogel material uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber. In other aspects, extraction can be performed using any suitable mechanism, for example altering the pressures, timings, and solvent discussed above.

### Formation of Carbon Aerogels Comprising a Carbon Additive

With continued reference to FIG. 1, the method comprises converting the organic aerogel to a carbon aerogel comprising a carbon additive. Generally, the converting comprises pyrolyzing (carbonizing) the organic aerogel, meaning the aerogel is heated at a temperature and for a time sufficient to convert substantially all of the organic material into carbon. As used herein in the context of pyrolysis, “substantially all” means that greater than 95% of the organic material is converted to carbon, such as 99%, or 99.9%, or 99.99%, or even 100% of the organic material is converted to carbon. Pyrolyzing the organic aerogel converts the organic aerogel to an isomorphic carbon aerogel, meaning the physical properties (e.g., porosity, surface area, pore size, diameter, and the like) are substantially retained in the corresponding carbon aerogel, and the carbon additive or precursor thereof is retained or converted to the corresponding carbon additive, respectively. The time and temperature required for pyrolyzing may vary. In some aspects, the organic aerogel is subjected to a treatment temperature of about 650° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic aerogel. Generally, the pyrolysis is conducted under an inert atmosphere to prevent combustion of the organic or carbon material. Suitable atmospheres include, but are not limited to, nitrogen, argon, or combinations thereof. In some aspects, pyrolysis is performed under nitrogen.

In some aspects, the organic aerogel is a polyimide, a polyamic acid, or a combination thereof, and may be in monolithic or bead form. In some aspects, the organic aerogel is a polyamic acid, which may be directly converted to a carbon aerogel (i.e., without first imidizing to provide a polyimide aerogel). In some aspects, the organic aerogel is a polyamic acid, which is thermally imidized as disclosed herein to first provide a polyimide aerogel, which is then subsequently pyrolyzed to provide the carbon aerogel. In some aspects, the organic aerogel is a polyimide, which is pyrolyzed to provide the carbon aerogel. In some aspects, the organic aerogel is a polyamic acid metal salt aerogel which is pyrolyzed to provide the carbon aerogel. In such an aspect, upon pyrolyzing, the ions of the soluble metal salt which are present may either form a corresponding metal oxide, or may sinter and form the corresponding metal, depending on the metal species and the pyrolysis conditions.

Carbon Aerogel Comprising a Carbon Additive Prepared from Polyamic Acid Salt Solution

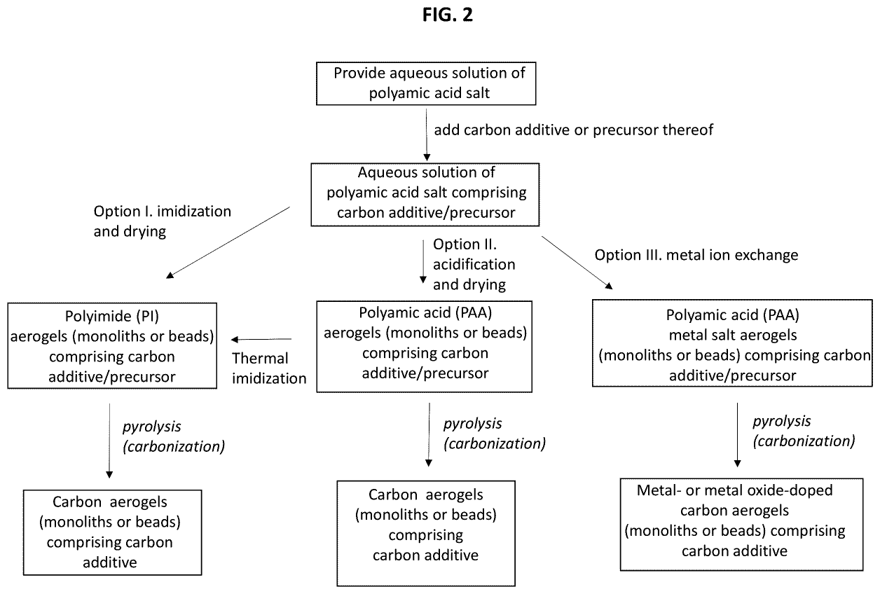

In some aspects, the organogel is a polyimide, polyamic acid, or polyamic acid metal salt. Each of the polyimide, polyamic acid, or polyamic acid metal salt organogels may be obtained from an aqueous solution of a polyamic acid salt. FIG. 2 provides a general, non-limiting overview of three options for preparing polyimide aerogels, polyamic acid aerogels, and polyamic acid metal salt aerogels comprising a carbon additive or precursor, and their corresponding carbon aerogels comprising a carbon additive, all from an aqueous solution of a polyamic acid salt.

In some aspects, the organogel is a polyimide. With reference to FIG. 2, in Option 1, the aqueous solution of polyamic acid is imidized and dried to provide a polyimide (PI) aerogel in the form of monoliths or beads. Optionally, the PI aerogels may be pyrolyzed to form the corresponding carbon aerogels.

With further reference to FIG. 2, in Option 2, the aqueous solution of polyamic acid is acidified and dried to form polyamic acid (PAA) aerogels, either as monoliths or beads. The PAA aerogels may be converted to PI aerogels by thermal imidization, or may be converted directly to the corresponding carbon aerogel by pyrolysis.

With still further reference to FIG. 2, in Option 3, the aqueous solution of polyamic acid is subjected to a metal ion exchange to form a PAA metal salt aerogel in the form of monoliths or beads. Such PAA metal salt aerogels may be directly pyrolyzed to form the corresponding metal- or metal oxide-doped carbon aerogel.

### Providing an Aqueous Solution of a Polyamic Acid Salt

In each option illustrated in FIG. 2, the common denominator is the aqueous solution of a polyamic acid salt. Accordingly, in some aspects, the method of forming a carbon aerogel comprising a carbon additive comprises providing an aqueous solution of a polyamic acid salt, the polyamic acid salt comprising a polyamic acid including carboxylic acid groups, wherein the carboxylic acid groups are associated with cationic species and are substantially present as carboxylate anions; and adding a carbon additive or precursor thereof as described herein above to the aqueous solution. Such polyamic acid salt solutions may be provided in a number of different manners, further described herein below.

In some aspects, a polyamic acid is purchased or previously prepared, and dissolved in water in the presence of a base to provide the polyamic acid salt solution. In other aspects, the solution may be obtained by in situ preparation from polyamic acid precursors (diamine and tetracarboxylic dianhydride) under aqueous conditions in the presence of a base. Each option is described further herein below.

### Polyamic Acid

In some aspects, the method comprises providing a polyamic acid or salt thereof. Polyamic acids are polymeric amides having repeat units comprising carboxylic acid groups, carboxamido groups, and aromatic or aliphatic moieties which comprise the diamine and tetracarboxylic acid from which the polyamic acid is derived. A “repeat unit” as defined herein is a part of the polyamic acid (or corresponding polyimide) whose repetition would produce the complete polymer chain (except for the terminal amino groups or unreacted anhydride termini) by linking the repeat units together successively along the polymer chain. One of skill in the art will recognize that the polyamic acid repeat units result from partial condensation of tetracarboxylic acid dianhydride carboxyl groups with the amino groups of a diamine.

In some aspects, the polyamic acid is any commercially available polyamic acid. In other aspects, the polyamic acid has been previously formed (“pre-formed”) and isolated, e.g., prepared by reaction of a diamine and a tetracarboxylic dianhydride in an organic solvent according to conventional synthetic methods. In either case, whether purchased or prepared and isolated, a suitable polyamic acid is in substantially pure form. Pre-formed and isolated or commercially available polyamic acids may be in, for example, solid form, such as a powder or crystal form, or in liquid form.

The structure of suitable polyamic acids may vary. In some aspects, the polyamic acid has a structure represented by Formula I:

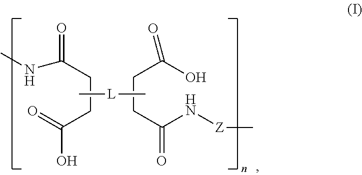

wherein:
   Z is a group connecting the two terminal amino groups of a diamine;
   L is a group connecting the carboxyl groups; and
   n is an integer indicating the number of polyamic acid repeat units, and which determines the molecular weight of the polyamic acid.

In some aspects, Z is aliphatic (e.g., alkyl, alkenyl, alkynyl, or cycloalkyl) as described herein above. Accordingly, in some aspects, the polyamic acid comprises as the repeat unit an amide of an aliphatic diamine. In some aspects, the polyamic acid comprises as the repeat unit an amide of an alkane diamine having from 2 to 12 carbon atoms (i.e., C2 to C12). In some aspects, the polyamic acid comprises as the repeat unit an amide of a C2 to C6 alkane diamine, such as, but not limited to, ethylenediamine, 1,3-diaminopropane, 1,4-diaminobutane, 1,5-diaminopentane, or 1,6-diaminohexane. In some aspects, one or more of carbon atoms of the C2 to C6 alkane of the diamine is substituted with one or more alkyl groups, such as methyl.

In some aspects, Z is aryl as described herein above. Accordingly, in some aspects, the polyamic acid comprises as the repeat unit an amide of an aryl diamine. In some aspects, the polyamic acid comprises as the repeat unit an amide of a phenylene diamine, a diaminodiphenyl ether, or an alkylenedianiline. In some aspects, the polyamic acid comprises as the repeat unit an amide of an aryl diamine selected from the group consisting of 1,3-phenylenediamine, 1,4-phenylenediamine, 4,4′-diaminodiphenyl ether, 4,4′-methylenedianiline, and combinations thereof. In some aspects, the polyamic acid comprises as the repeat unit an amide of an aryl diamine selected from the group consisting of 1,4-phenylenediamine, 4,4′-methylenedianiline, 4,4′-diaminodiphenyl ether. In some aspects, the polyamic acid comprises as the repeat unit an amide of an aryl diamine which is 1,4-phenylenediamine (PDA).

In some aspects, L comprises an alkyl group, a cycloalkyl group, an aryl group, or a combination thereof, each as described herein above. In some aspects, L comprises an aryl group. In some aspects, L comprises a phenyl group, a biphenyl group, or a diphenyl ether group. In some aspects, the polyamic acid comprises as the repeat unit an amide of a tetracarboxylic acid selected from the group consisting of benzene-1,2,4,5-tetracarboxylic acid, [1,1′-biphenyl]-3,3′,4,4′-tetracarboxylic acid, 4,4′-oxydiphthalic acid, 4,4′-sulfonyldiphthalic acid, 4,4′-carbonyldiphthalic acid, 4,4′-(propane-2,2-diyl)diphthalic acid, 4,4′-(perfluoropropane-2,2-diyl)diphthalic acid, naphthalene-1,4,5,8-tetracarboxylic acid, 4-(2-(4-(3,4-dicarboxyphenoxy)phenyl)propan-2-yl)phthalic acid, perylene tetracarboxylic acid, and combinations thereof. In some aspects, the polyamic acid comprises as the repeat unit an amide of a tetracarboxylic acid which is benzene-1,2,4,5-tetracarboxylic acid,

### Polyamic Acid Salts

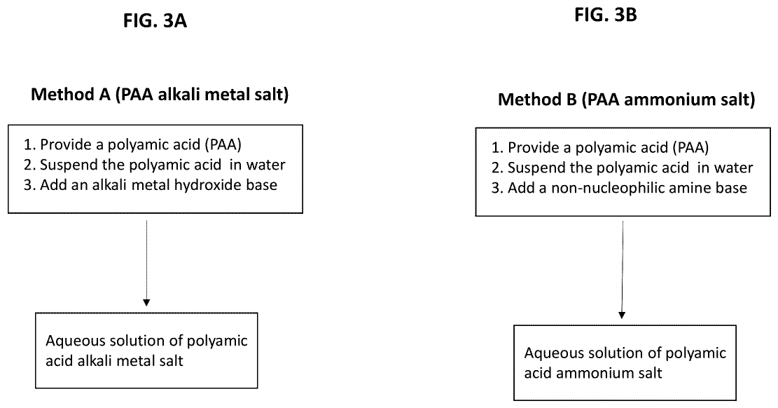

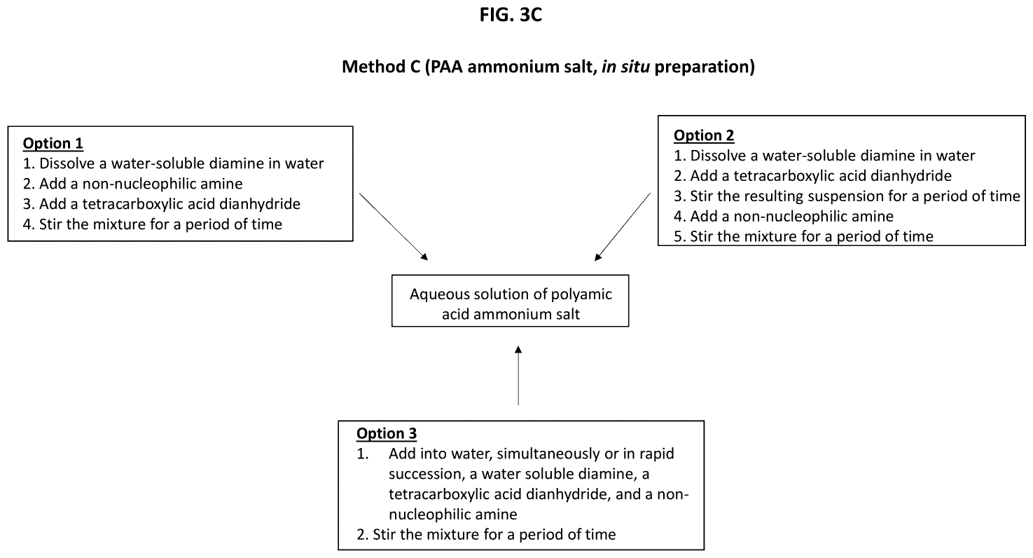

While polyamic acids are generally insoluble in water, it has been found according to the present disclosure that certain polyamic acid salts, in which the carboxylic acid groups of the polyamic acid are associated with cationic species and are substantially present as carboxylate anions, possess useful water solubility. By “substantially present as carboxylate anions” it is meant that greater than about 95%, greater than about 99%, greater than about 99.9%, greater than 99.99%, or even 100% of the free carboxylic acid groups present within the polyamic acid molecules are in their unprotonated (i.e., —CO₂⁻) state. The cationic species may be, for example, an alkali metal cation or an ammonium cation. With reference to FIGS. 3A and 3B, generally, providing a polyamic acid salt in solution comprises adding a polyamic acid to water to form an aqueous suspension of the polyamic acid, and adding a base to the aqueous suspension of the polyamic acid to form the aqueous solution of the polyamic acid salt. The polyamic acid is as described herein above, and may be purchased or may be prepared as described herein.

The base may vary. For example, in some aspects, the base is an alkali metal hydroxide, and the cation is an alkali metal ion. With reference to FIG. 3A, a polyamic acid is suspended in water, and an alkali metal hydroxide is added to the suspension, resulting in an aqueous solution of the polyamic acid alkali metal salt. Suitable alkali metal hydroxides include, but are not limited to, lithium hydroxide, sodium hydroxide, and potassium hydroxide. In some aspects, the base is a water-soluble carbonate or bicarbonate salt. Suitable carbonate and bicarbonate salts, and methods of using such salts to form polyamic acids, polyimides, and carbon materials therefrom, including aerogel materials, are described in International Patent Application PCT/US2023/016821 incorporated by reference herein in its entirety. One of skill in the art will recognize that certain methods described therein may be applied to the present methods of preparing porous carbon materials comprising a carbon additive, and such methods are contemplated herein.

The quantity of alkali metal hydroxide added may vary, but is generally sufficient to react with (e.g., neutralize or deprotonate) substantially all of the free carboxylic acid groups present in the polyamic acid, and such that substantially all of the polyamic acid dissolves. As used herein in the context of neutralizing carboxylic acid groups, “substantially all” means that greater than 95% of the carboxylic acid groups are neutralized, such as 99%, or 99.9%, or 99.99%, or even 100% of the carboxylic acid groups are neutralized. As used herein in the context of dissolution of the polyamic acid, “substantially all” means that greater than 95% of the polyamic acid, such as 99%, or 99.9%, or 99.99%, or even 100% of the polyamic acid dissolves. In some aspects, a molar ratio of the alkali metal hydroxide to the polyamic acid is from about 0.1 to about 8, such as from about 2 to about 8. In some aspects, a molar ratio of the alkali metal hydroxide to the polyamic acid is from about 2 to about 4, or from about 2.2 to about 2.5.

The quantity of water utilized will vary depending on the desired concentration, the scale at which the solution is formed, and the solubility of the polyamic acid salt in water. In some aspects, a range of concentration of the alkali metal salt of the polyamic acid in the solution is from about 0.01 to about 0.3 g/cm³, based on the weight of the polyamic acid.

In some aspects, the base is a non-nucleophilic amine base, and the cation is an ammonium ion. With reference to FIG. 3B, a polyamic acid is suspended in water, and a non-nucleophilic amine base is added to the suspension, resulting in an aqueous solution of the polyamic acid ammonium salt. Typical non-nucleophilic amines are bulky, tertiary, or both, such that protons can attach to the basic center, but alkylation, acylation, complexation, and the like are impossible or too slow to be of any practical consequence. Suitable non-nucleophilic amine bases include, but are not limited to, tertiary amines, such as alkyl, cycloalkyl, and aromatic tertiary amines. As used herein in the context of amines, “tertiary” means that the amine nitrogen atom has three bonds or organic substituents attached thereto. Generally, suitable non-nucleophilic amines will have a solubility in water of at least about 4 grams per liter at 20° C. Particularly suitable non-nucleophilic amine bases are the water-soluble lower trialkylamines, including cyclic trialkylamines. In some aspects, the non-nucleophilic amine base is selected from the group consisting of trimethylamine, triethylamine, tri-n-propylamine, tri-n-butylamine, N-methylpyrrolidine, N-methylpiperidine, diisopropylethylamine, and combinations thereof. In some aspects, the non-nucleophilic amine base is triethylamine. In some aspects, the non-nucleophilic amine base is diisopropylethylamine.

The quantity of non-nucleophilic amine base added may vary, but is generally sufficient to react with (e.g., neutralize or deprotonate) substantially all of the free carboxylic acid groups present in the polyamic acid, and such that substantially all of the polyamic acid dissolves. In some aspects, the non-nucleophilic amine is added in a quantity sufficient to maintain substantially all of the polyamic acid in solution. In some aspects, a molar ratio of the non-nucleophilic amine base to the polyamic acid is from about 0.1 to about 8, such as from about 2 to about 8. In some aspects, a molar ratio of the non-nucleophilic amine base to the polyamic acid is from about 2 to about 4, or from about 2.2 to about 2.5.

The quantity of water utilized will vary depending on the desired concentration, the scale at which the solution is formed, and the solubility of the polyamic acid salt and/or the non-nucleophilic amine base in water. In some aspects, a range of concentration of the ammonium salt of the polyamic acid in the solution is from about 0.01 to about 0.3 g/cm³, based on the weight of the polyamic acid (i.e., the free acid weight).

### Polyamic Acid Ammonium Salt, In Situ Preparation

In some aspects, the aqueous solution of a polyamic acid salt is prepared in situ by e.g., reaction of a diamine and a tetracarboxylic acid dianhydride in the presence of a non-nucleophilic amine, providing an aqueous solution of the polyamic acid ammonium salt. Generally, the diamine is allowed to react with the tetracarboxylic acid dianhydride in the presence of the non-nucleophilic amine to form the polyamic acid ammonium salt. In some aspects, combinations of more than one diamine may be used. Combinations of diamines may be used in order to optimize the properties of the gel material. In some aspects, a single diamine is used. Generally, the diamine has appreciable solubility in water. For example, suitable diamines may have a solubility in water at 20° C. of at least about 0.1 g per 100 ml, at least about 1 g per 100 ml, or at least about 10 g per 100 ml.

A non-limiting, generic reaction sequence is provided in Scheme 1. In some aspects, the reactions occur generally according to Scheme 1, and the reagents and product have structures according to the formulae in Scheme 1.

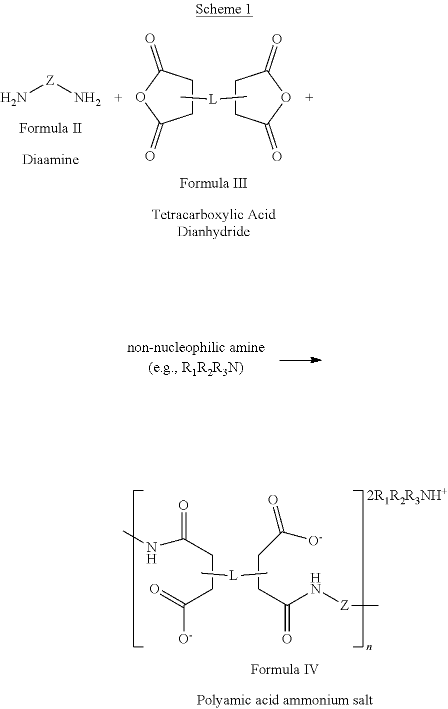

With reference to Scheme 1, each of Z, L, and n are as defined herein above with reference to Formula I, and the non-nucleophilic amine is a non-nucleophilic amine base as described herein above (e.g., R₁, R₂, and R₃ are alkyl, cycloalkyl aryl, or combinations thereof). Suitable diamines, tetracarboxylic acid dianhydrides, and non-nucleophilic amines are further described below. The order of addition of the individual reactants may vary, as may the structure of the reactants. Suitable reactant structures and reaction conditions, as well as orders of addition, are described further herein below.

With reference to FIG. 3C, there are three general options for providing an aqueous solution of a polyamic acid salt in accordance with general Scheme 1.

### Option 1

In some aspects, the polyamic acid is prepared in situ. In some such aspects, providing an aqueous solution of a polyamic acid salt comprises:
dissolving a water-soluble diamine in water to form an aqueous diamine solution;
adding a non-nucleophilic amine to the aqueous diamine solution;
adding a tetracarboxylic acid dianhydride to the aqueous diamine solution; and
stirring the resulting solution for a period of time in a range from about 1 hour to about 24 hours at a temperature in a range from about 15 to about 60° C.

With reference to FIG. 3C, Option 1 and Scheme 1, a water-soluble diamine is dissolved in water. The structure of the diamine may vary. In some aspects, the diamine has a structure according to Formula II, where Z is aliphatic (i.e., alkylene, alkenylene, alkynylene, or cycloalkylene) or aryl, each as described herein above. In some aspects, Z is alkylene, such as C2 to C12 alkylene or C2 to C6 alkylene. In some aspects, the diamine is a C2 to C6 alkane diamine, such as, but not limited to, ethylenediamine, 1,3-diaminopropane, 1,4-diaminobutane, 1,5-diaminopentane, or 1,6-diaminohexane. In some aspects, the C2 to C6 alkylene of the alkane diamine is substituted with one or more alkyl groups, such as methyl.

In some aspects, Z is aryl. In some aspects, the aryl diamine is 1,3-phenylenediamine, 1,4-phenylenediamine, or a combination thereof. In some aspects, the diamine is 1,4-phenylenediamine (PDA).

With continued reference to FIG. 3C, Option 1 and Scheme 1, a non-nucleophilic amine is added to the aqueous diamine solution. Suitable non-nucleophilic amines are described herein above. In some aspects, the non-nucleophilic amine is selected from the group consisting of triethylamine, trimethylamine, tri-n-butylamine, N-methylpyrrolidine, N-methylpiperidine, diisopropylethylamine, and combinations thereof. In some aspects, the non-nucleophilic amine is triethylamine. In some aspects, the non-nucleophilic amine is diisopropylethylamine.

The quantity of non-nucleophilic amine added may vary. In some aspects, the molar ratio of the non-nucleophilic amine to the diamine is from about 2 to about 4, or from about 2 to about 3. In some aspects, the molar ratio is from about 2.0, about 2.1, about 2.2, about 2.3, about 2.4, or about 2.5, to about 2.6, about 2.7, about 2.8, about 2.9, or about 3.0. In some aspects, a molar ratio of the non-nucleophilic amine to the diamine is from about 2 to about 2.5. Without wishing to be bound by any particular theory, it is believed that in some exemplary aspects, at least enough amine is required to allow neutralization of substantially all free carboxylic acid groups of the polyamic acid (i.e., form a salt with). It has been observed according to the present disclosure that molar ratios below 2.0, or below 2.2, may in some aspects result in precipitation of the polyamic acid. Accordingly, the molar ratio may require optimization for each set of reactants and conditions. In some aspects, the molar ratio is selected so as to maintain solubility of the polyamic acid. In some aspects, the molar ratio is selected so as to avoid any precipitation of the polyamic acid.

With continued reference to FIG. 3C, Option 1 and Scheme 1, a tetracarboxylic acid dianhydride is added. In some aspects, more than one tetracarboxylic acid dianhydride is added. Combinations of tetracarboxylic acid dianhydrides may be used in order to optimize the properties of the gel material. In some aspects, a single tetracarboxylic acid dianhydride is added.

The structure of the tetracarboxylic acid dianhydride may vary. In some aspects, the tetracarboxylic acid dianhydride has a structure according to Formula III, where L comprises an alkylene group, a cycloalkylene group, an arylene group, or a combination thereof, each as described herein above. In some aspects, L comprises an arylene group. In some aspects, L comprises a phenyl group, a biphenyl group, or a diphenyl ether group. In some aspects, the tetracarboxylic acid dianhydride of Formula III has a structure selected from one or more structures as provided in Table 1.

TABLE 1
Non-limiting list of potential tetracarboxylic acid dianhydrides

| Structure | IUPAC Name | Common/Alternative Name |
|---|---|---|
| 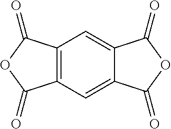 [SMILES: O=c1oc(=O)c2cc3c(=O)oc(=O)c3cc12] | 1H,3H-benzo[1,2-c: 4,5-c′]difuran- 1,3,5,7-tetraone | pyromellitic anhydride (PMDA) |
| 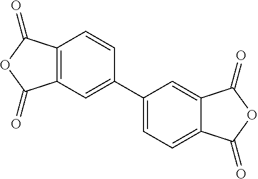 [SMILES: O=C1OC(=O)c2cc(-c3ccc4c(c3)C(=O)OC4=O)ccc21] | [5,5′-biisobenzo- furan]- 1,1′,3,3′- tetraone | 3,3′,4,4′- bisphenyltetracarboxylic dianhydride; biphthalic dianhydride (BPDA) |
| 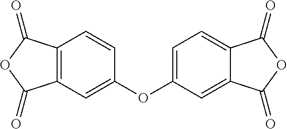 [SMILES: O=C1OC(=O)c2cc(Oc3ccc4c(c3)C(=O)OC4=O)ccc21] | 5,5′-oxybis (isobenzofuran-1,3- dione) | 4,4′-oxydiphthalic dianhydride (ODPA) |
| 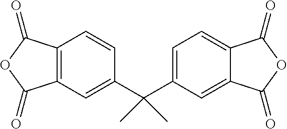 [SMILES: CC(C)(c1ccc2c(c1)C(=O)OC2=O)c1ccc2c(c1)C(=O)OC2=O] | 5,5′-(propane-2,2- diyl)bis(isobenzo- furan-1,3-dione) | 4,4′- (isopropylidene)diphathalic dianhydride |
| 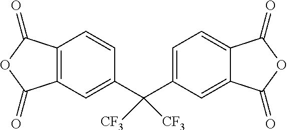 [SMILES: O=C1OC(=O)c2cc(C(c3ccc4c(c3)C(=O)OC4=O)(C(F)(F)F)C(F)(F)F)ccc21] | 5,5′-(perfluoropropane-2,2- diyl)bis(isobenzo- furan-1,3-dione) | 4,4′- (hexafluoroisopropylidene) diphathalic dianhydride (6FDA) |
| 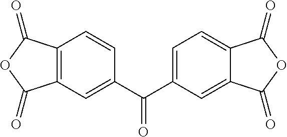 [SMILES: O=C(c1ccc2c(c1)C(=O)OC2=O)c1ccc2c(c1)C(=O)OC2=O] | 5,5′-carbonylbis (isobenzofuran-1,3- dione) | 3,3′,4,4′- benzophenonetetracarboxylic dianhydride (BTDA) |
| 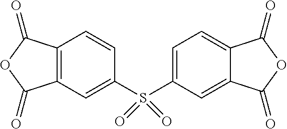 [SMILES: O=C1OC(=O)c2cc(S(=O)(=O)c3ccc4c(c3)C(=O)OC4=O)ccc21] | 5,5′-sulfonylbis (isobenzofuran-1,3- dione) | 3,3′,4,4′- diphenylsulfonetetracarboxylic dianhydride |
| 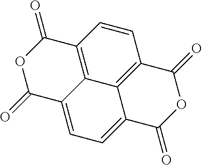 [SMILES: O=C1OC(=O)c2ccc3c4c(ccc1c24)C(=O)OC3=O] | isochromeno[6,5,4- def]isochromene- 1,3,6,8-tetraone | 1,4,5,8- Naphthalenetetracarboxylic dianhydride |
| 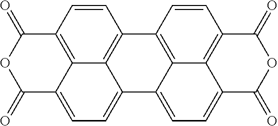 [SMILES: O=C1OC(=O)c2ccc3c4ccc5c6c(ccc(c7ccc1c2c73)c64)C(=O)OC5=O] | anthra[2,1,9-def:6,5,10- d′e′f]diisochromene-1,3,8,10- tetraone | perylene tetracarboxylic anhydride |
| 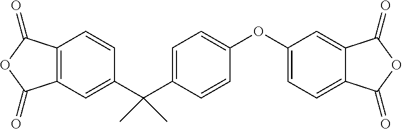 [SMILES: CC(C)(c1ccc(Oc2ccc3c(c2)C(=O)OC3=O)cc1)c1ccc2c(c1)C(=O)OC2=O] | 5-(2-(4-((1,3-dioxo-1,3- dihydroisobenzofuran-5- yl)oxy)phenyl)propan-2- yl)isobenzofuran-1,3-dione | |
| 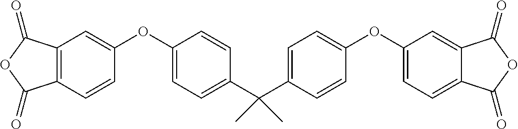 [SMILES: CC(C)(c1ccc(Oc2ccc3c(c2)C(=O)OC3=O)cc1)c1ccc(Oc2ccc3c(c2)C(=O)OC3=O)cc1] | 5,5′-((propane-2,2-diylbis(4,1- phenylene))bis(oxy))bis (isobenzofuran-1,3-dione) | 4,4′-(4,4′)- isopropylidenediphenoxy) bisphthalic dianhydride (BPADA) |

In some aspects, the tetracarboxylic acid dianhydride is selected from the group consisting of pyromellitic anhydride (PMDA), biphthalic dianhydride (BPDA), oxydiphthalic dianhydride (ODPA), benzophenone tetracarboxylic dianhydride (BTDA), ethylenediaminetetraacetic dianhydride (EDDA), 1,4,5,8-naphthalenetetracarboxylic dianhydride, and combinations thereof. In some aspects, the tetracarboxylic acid dianhydride is PMDA.

The molar ratio of the diamine to the dianhydride may vary according to desired reaction time, reagent structure, and desired material properties. In some aspects, the molar ratio is from about 0.1 to about 10, such as from about 0.1, about 0.5, or about 1, to about 2, about 3, about 5, or about 10. In some aspects, the ratio is from about 0.5 to about 2. In some aspects, the ratio is about 1 (i.e., stoichiometric), such as from about 0.9 to about 1.1. In specific aspects, the ratio is from about 0.99 to about 1.01.

With reference to Scheme 1, the diamine and the dianhydride are allowed to react with each other in the presence of the non-nucleophilic amine, forming the polyamic acid. Without wishing to be bound by theory, it is believed that the polyamic acid, in the presence of the non-nucleophilic amine, forms an ammonium salt of the polyamic acid having a structure according to Formula IV, and the water solubility of this salt allows the ammonium salt of the polyamic acid to remain in solution.

The molecular weight of the polyamic acid may vary based on reaction conditions (e.g., concentration, temperature, duration of reaction, nature of diamine and dianhydride, etc.). The molecular weight is based on the number of polyamic acid repeat units, as denoted by the value of the integer “n” for the structure of Formula IV in Scheme 1. The specific molecular weight range of polymeric materials produced by the disclosed method may vary. Generally, the noted reaction conditions may be varied to provide a gel with the desired physical properties without specific consideration of molecular weight. In some aspects, a surrogate for molecular weight is provided in the viscosity of the polyamic acid ammonium salt solution, which is determined by variables such as temperature, concentrations, molar ratios of reactants, reaction time, and the like.

The molar ratio of the diamine to the dianhydride may vary according to desired reaction time, reagent structure, and desired material properties. In some aspects, the molar ratio is from about 0.1 to about 10, such as from about 0.1, about 0.5, or about 1, to about 2, about 3, about 5, or about 10. In some aspects, the ratio is from about 0.5 to about 2. In some aspects, the ratio is about 1 (i.e., stoichiometric), such as from about 0.9 to about 1.1. In specific aspects, the ratio is from about 0.99 to about 1.01.

The molar ratio of the non-nucleophilic amine to the diamine or the dianhydride determines the solubility of the polyamic acid. In some aspects, the molar ratio of the non-nucleophilic amine to the diamine is from about 2 to about 4, or from about 2 to about 3. In some aspects, the molar ratio is from about 2.0, about 2.1, about 2.2, about 2.3, about 2.4, or about 2.5, to about 2.6, about 2.7, about 2.8, about 2.9, or about 3.0. Without wishing to be bound by any particular theory, it is believed that in some exemplary aspects, at least enough amine is required to allow neutralization of substantially all free carboxylic acid groups of the polyamic acid (i.e., form a salt with). It has been observed according to the present disclosure that molar ratios below 2.0, or below 2.2, may in some aspects result in precipitation of the intermediate polyamic acid (e.g., because of evaporative loss of the non-nucleophilic amine). Accordingly, the molar ratio may require optimization for each set of reactants and conditions. In some aspects, the molar ratio is selected so as to maintain solubility of the reaction components (e.g., the polyamic acid). In some aspects, the molar ratio is adjusted so as to avoid any precipitation.

The temperature at which the reaction is conducted may vary. A suitable range is generally between about 10° C. and about 100° C. In some aspects, the reaction temperature is from about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

In some aspects, as the temperature is increased, polyimide gels may be produced with a different pore size distribution and different structural properties. Without wishing to be bound by theory, it is believed that properties such as pore size distribution and structural rigidity may, in certain aspects, vary with temperature, perhaps as a consequence of polyimide molecular weights, degree of chemical cross linking (when possible), and other factors which may exhibit a temperature dependence.

The reaction is allowed to proceed for a period of time, and is generally allowed to proceed until all of the available reactants (e.g., diamine and dianhydride) have reacted with one another. The time required for complete reaction may vary based on reagent structures, concentration, temperature. In some aspects, the reaction time is from about 1 minute to about 1 week, for example, from about 15 minutes to about 5 days, from about 30 minutes to about 3 days, or from about 1 hour to about 1 day. In some aspects, the reaction time is from about 1 hour to about 12 hours.

### Option 2

In some aspects, the polyamic acid is prepared in situ, and providing an aqueous solution of a polyamic acid salt comprises:
dissolving a water-soluble diamine in water to form an aqueous diamine solution;
adding a tetracarboxylic acid dianhydride to the aqueous diamine solution;
stirring the resulting suspension for a period of time in a range from about 1 hour to about 24 hours at a temperature in a range from about 15 to about 60° C.
adding a non-nucleophilic amine to the aqueous diamine solution; and
stirring the resulting suspension for a period of time in a range from about 1 hour to about 24 hours at a temperature in a range from about 15 to about 60° C.

With reference to FIG. 3C, Option 2 and Scheme 1, a water-soluble diamine is dissolved in water as described above with respect to Option 1. However, in this aspect, the tetracarboxylic acid dianhydride (as described herein above with respect to Option 1) is added to the aqueous diamine solution to form a suspension. The relative quantities of the reactants may vary as described above with respect to Option 1.

In some aspects, the suspension is stirred for a period of time ranging from about 1 hour to about 1 day, such as from about 1 hour to about 12 hours.

The temperature at which the suspension is stirred may vary. A suitable range is generally between about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

With reference to FIG. 3C, Option 2 and Scheme 1, a non-nucleophilic amine is added. Suitable non-nucleophilic amines are described herein above. In some aspects, the non-nucleophilic amine is selected from the group consisting of triethylamine, trimethylamine, tri-n-butylamine, N-methylpyrrolidine, N-methylpiperidine, diisopropylethylamine, and combinations thereof. In some aspects, the non-nucleophilic amine is triethylamine. In some aspects, the non-nucleophilic amine is diisopropylethylamine.

The quantity of non-nucleophilic amine added may vary as described above with respect to Option 1. In some aspects, a molar ratio of the non-nucleophilic amine to the diamine is from about 2 to about 2.5.

In some aspects, the resulting mixture is stirred for a period of time ranging from about 1 hour to about 1 day, such as from about 1 hour to about 12 hours.

The temperature at which the mixture is stirred may vary. A suitable range is generally between about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

### Option 3

In some aspects, the polyamic acid is prepared in situ, and providing an aqueous solution of a polyamic acid salt comprises:
adding to water, simultaneously or in rapid succession, a water-soluble diamine,
a tetracarboxylic acid dianhydride, and a non-nucleophilic amine; and
stirring the resulting solution for a period of time in a range from about 1 hour to about 24 hours at a temperature in a range from about 15 to about 60° C.

With reference to FIG. 3C, Option 3 and Scheme 1, the water-soluble diamine, the tetracarboxylic acid dianhydride, and the non-nucleophilic amine are added to water, either simultaneously or in rapid succession. Each of the water-soluble diamine, the tetracarboxylic acid dianhydride, and the non-nucleophilic amine, and the relative quantities thereof are as described above with respect to Options 1 and 2.

In some aspects, the resulting mixture is stirred for a period of time ranging from about 1 hour to about 1 day, such as from about 1 hour to about 12 hours.

The temperature at which the mixture is stirred may vary. A suitable range is generally between about 15 to about 60° C., such as about 20, about 25, about 30, about 35, about 40, about 45, about 50, about 55, or about 60° C. In some aspects, the temperature is from about 15 to about 25° C. In some aspects, the temperature is from about 50 to about 60° C.

In each of the foregoing options for preparing a solution of a polyamic acid salt, and for preparing polyamic acids, it should be noted that while reference has been made extensively to use of aqueous solutions, it is contemplated herein that organic solvents as described herein may be used as well, and any disclosure with respect to aqueous solutions should not be inferred as being so limited.

### Imidizing the Polyamic Acid Salt to Form a Polyimide Gel

With continued reference to FIG. 2, option I, in some aspects, the organogel is a polyimide, and the method comprises imidizing a polyamic acid salt as described herein above to form a polyimide gel comprising the carbon additive or precursor thereof. The polyimide gel and corresponding aerogel may be in the form of monoliths or in bead form. The salt of the polyamic acid may be an alkali metal salt or an ammonium salt as described herein above. The various permutations for preparing polyimide aerogels from such polyamic acid salt solutions are described further herein below.

A. Monolithic Polyimide Aerogels from an Aqueous Solution of a Salt of a Polyamic Acid by Chemical Imidization

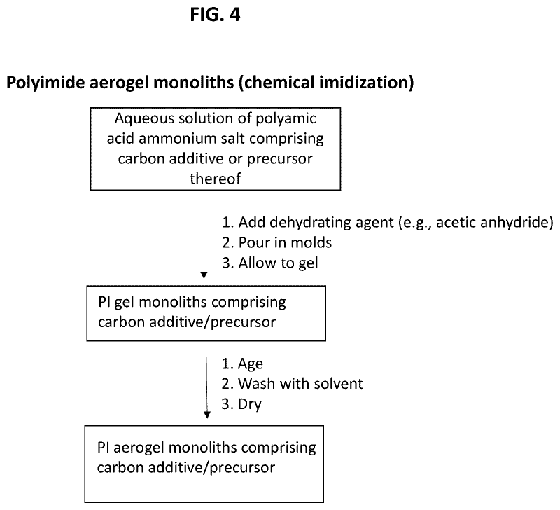

In some aspects, the polyimide gel and corresponding aerogel are in monolithic form, and the salt of the polyamic acid in the aqueous solution is an ammonium salt, prepared as described above with reference to FIG. 3B or FIG. 3C (Options 1, 2, or 3). In such aspects, the imidization may be chemical imidization, and the method may be that generally described in FIG. 4.

With reference to FIG. 4, imidizing the polyamic acid salt comprises adding a dehydrating agent to the aqueous solution of the polyamic acid salt to form a gelation mixture (a “sol”), pouring the gelation mixture into molds, and allowing the gelation mixture to gel. The dehydrating agent is added to initiate and drive imidization, forming the polyimide wet-gel from the polyamic acid ammonium salt. A non-limiting, generic reaction sequence is provided in Scheme 2. In some aspects, the polyimide has a structure according to Formula V as illustrated in Scheme 2, wherein L, Z, and n are each as described herein above with respect to forming the polyamic acid ammonium salt of Formula IV.

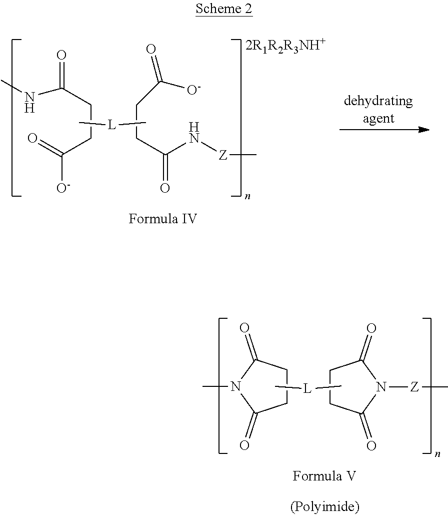

The structure of the dehydrating agent may vary, but is generally a reagent that is at least partially soluble in the reaction solution, reactive with the carboxylate groups of the ammonium salt, and effective in driving the imidization of the polyamic acid carboxyl and amide groups, while having minimal reactivity with the aqueous solution. One example of a class of suitable dehydrating agents is the carboxylic acid anhydrides, such as acetic anhydride, propionic anhydride, and the like. In some aspects, the dehydrating agent is acetic anhydride. Surprisingly, according to the present disclosure, it has been found that addition of acetic anhydride to the aqueous solution of the ammonium salt resulted in rapid gelation of the polyimide without observing the intuitively expected substantial hydrolysis of the acetic anhydride with water. Any hydrolysis which did occur was not sufficient to compete with the function of the acetic anhydride in polyimide formation.

In some aspects, the quantity of dehydrating agent may vary based on the quantity of tetracarboxylic acid dianhydride. For example, in some aspects, the dehydrating agent is present in various molar ratios with the tetracarboxylic acid dianhydride. The molar ratio of the dehydrating agent to the tetracarboxylic acid dianhydride may vary according to desired reaction time, reagent structure, and desired material properties. In some aspects, the molar ratio is from about 2 to about 10, such as from about 2, about 3, about 4, or about 5, to about 6, about 7, about 8, about 9, or about 10. In some aspects, the ratio is from about 4 to about 5. In some aspects, the ratio is 4.3.

The temperature at which the dehydration reaction is allowed to proceed may vary, but is generally less than about 50° C., such as from about 10 to about 50° C., or from about 15 to about 25° C.

With further reference to FIG. 4, the gelation mixture is poured into molds and the gelation mixture allowed to gel. Generally, the resulting wet-gel material is allowed to remain in the mold (“cast”) for a period of time. The time required for complete gelation of the gelation mixture, forming the wet-gel, may vary. The period of time may vary based on many factors, such as the desirability of aging the material, but will generally be between a few hours and a few days.

The process of transitioning the gelation mixture into a wet-gel material can also include an aging step (also referred to as curing) prior to drying. Aging a wet-gel material after it reaches its gel point can further strengthen the gel framework. For example, in some aspects, the framework may be strengthened during aging. The duration of gel aging can be adjusted to control various properties within the corresponding aerogel material. This aging procedure can be useful in preventing potential volume loss and shrinkage during liquid phase extraction of the wet-gel material. Aging can involve: maintaining the gel (prior to extraction) at a quiescent state for an extended period; maintaining the gel at elevated temperatures; or any combination thereof. The preferred temperatures for aging are usually between about 10° C. and about 200° C. Aging may also take place during solvent exchange, as described herein below. The aging of a wet-gel material may also be referred to as “curing,” and typically continues up to the liquid phase extraction of the wet-gel material.

The resulting wet-gel monolith may vary in size and shape. In some aspects, the wet-gel monolith has a thickness from about 5 to about 25 mm. In some aspects, the monolith is in the form of a film, such as a film having a thickness from about 50 microns to about 1 mm.

B. Monolithic Polyimide Aerogels from an Aqueous Solution of a Salt of a Polyamic Acid by Thermal Imidization

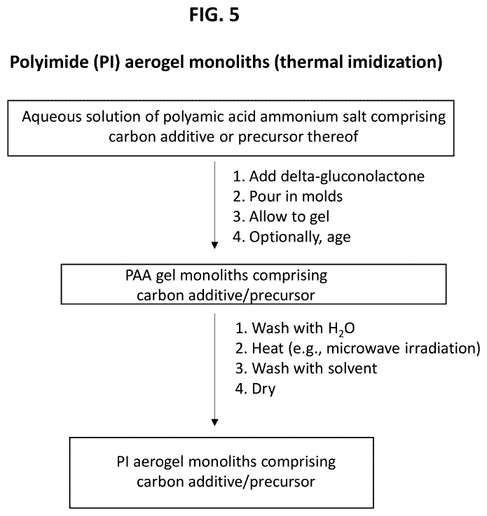

In some aspects, the imidization may be thermal imidization, and the method may be that generally described in FIG. 5. With reference to FIG. 5, in this aspect, imidizing the polyamic acid ammonium salt comprises:
adding delta-gluconolactone to the aqueous solution of the polyamic acid salt to form a gelation mixture;
pouring the gelation mixture into a mold and allowing the gelation mixture to gel;
washing the resulting polyamic acid gel with water; and
thermally imidizing the polyamic acid gel to form the polyimide gel, the thermally imidizing comprising exposing the polyamic acid gel to microwave frequency irradiation.

In an aqueous environment, DGL reacts slowly with water to form delta-gluconic acid (DGA; Eq. 1), which serves to at least begin the acidification process for polyamic acid gelation.

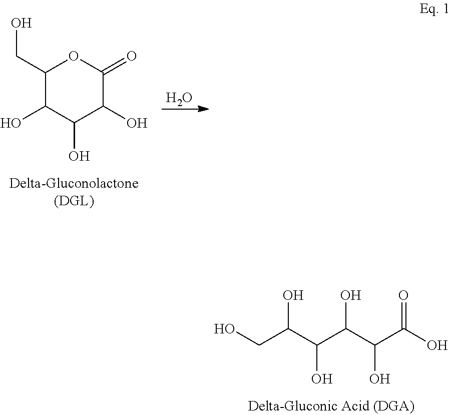 [SMILES: O=C1OC(CO)C(O)C(O)C1O ; O ; O=C(O)C(O)C(O)C(O)C(O)CO]

The gelation mixture is poured into molds and the gelation mixture allowed to gel. Upon acidification, the polyamic acid becomes insoluble in the aqueous environment, forming a polyamic acid wet-gel. In some aspects, the polyamic acid ammonium salt has a structure according to Formula IV, and the polyamic acid gel has a structure according to Formula VI (Scheme 3), wherein L, Z, and n are each as described herein above, and the acid is DGA.

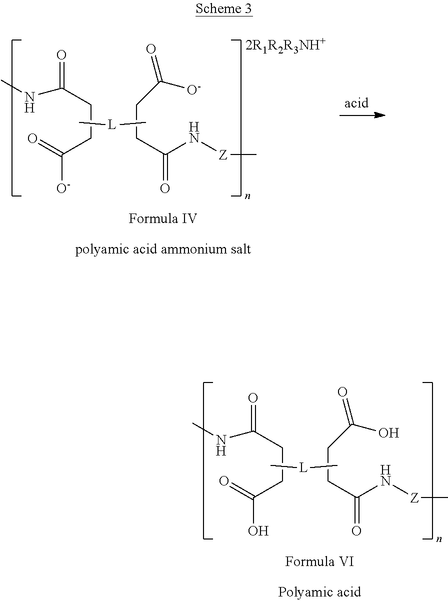

The time required for complete gelation of the gel-forming solution (sol; e.g. polyamic acid), forming the wet-gel, may vary. Generally, gelation occurs in about 1.5 hours or less. Generally, the wet-gel material is allowed to remain in the mold (“cast”) for a period of time. The period of time may vary based on many factors, such as the desirability of aging the material as described herein above with respect to chemical imidization.

With reference to FIG. 5, the resulting polyamic acid gel monolith is then washed with water. The washing is performed for a sufficient time and with a sufficient amount of water to remove any water-soluble by products, such as ammonium salts, DGA or DGL, and other byproducts from formation of the polyamic acid ammonium salt solution.

With continued reference to FIG. 5, following formation and washing of the polyamic acid wet-gel monolith, thermal treatment (e.g., microwave exposure) is utilized to dehydrate (i.e., imidize) the polyamic acid gel to form the corresponding polyimide gel. A non-limiting, generic reaction sequence is provided in Scheme 4. In some aspects, the polyimide has a structure according to Formula V as illustrated in Scheme 4, wherein L, Z, and n are each as described herein above.

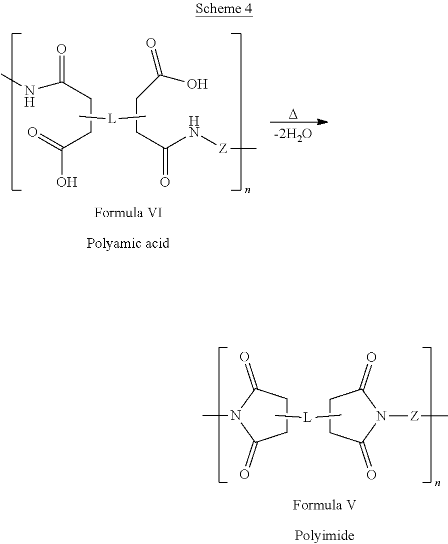

Irradiation of the wet-gel material with microwave frequency energy is one particularly suitable thermal treatment. A microwave is a low energy electromagnetic wave with a wavelength in the range of 0.001-0.3 meters and a frequency in the range of 1,000-300,000 MHz. Typical microwave devices operate with microwaves at a frequency of 2450 MHz. The electric field component of the microwaves is primarily responsible for generation of heat, interacting with molecules via dipolar rotation and ionic conduction. In dipolar rotation, a molecule rotates back and forth constantly, attempting to align its dipole with the ever-oscillating electric field; the friction between each rotating molecule results in heat generation. In ionic conduction, a free ion or ionic species moves translationally through space, attempting to align with the changing electric field. As with dipolar rotation, the friction between these moving species results in heat generation. In both cases, the more polar and/or ionic the molecular species, the more efficient the rate of heat generation. In comparison to conventional heating, which relies on slow thermal conduction, microwave heating allows rapid and efficient energy transfer. Accordingly, microwave heating is particularly suitable for conducting the present thermal imidization reactions. Generally, the microwave frequency irradiation is at a power and for a length of time sufficient to convert a substantial portion of the amide and carboxyl groups of the polyamic acid to imide groups. As used herein in the context of converting the amide and carboxyl groups to imide groups, “substantial portion” means that greater than 90%, such as 95%, 99%, or 99.9%, or 99.99%, or even 100%, of the amide and carboxyl groups are converted to imide groups.

With continued reference to FIG. 5, following the heating and formation of the polyimide gel monoliths, the polyimide gel monoliths are washed (solvent exchanged) and dried as described herein above with respect to chemically imidized polyimide monoliths, to form the polyimide aerogel monoliths.

C. Polyimide Aerogel Beads from an Aqueous Solution of an Ammonium Salt of a Polyamic Acid by Chemical Imidization (Droplet Method in Aqueous Solution)

In some aspects, the polyimide gel and corresponding aerogel are in bead form, and the salt if the polyamic acid in the aqueous solution is an ammonium salt, prepared as described above with reference to FIG. 3B or FIG. 3C (Options 1, 2, or 3). In such aspects, the imidization may be chemical imidization, and the method may be that generally described in FIG. 5. As used herein, the term “beads” or “bead form” is meant to include discrete small units or pieces having a generally spherical shape. In some aspects, the gel beads are substantially spherical. The beads are generally uniform in composition, such that each bead in a plurality of beads comprises the same polyimide in approximately the same amounts within normal variations expected in preparing such beads. The size of the beads may vary according to the desired properties and method of preparing.

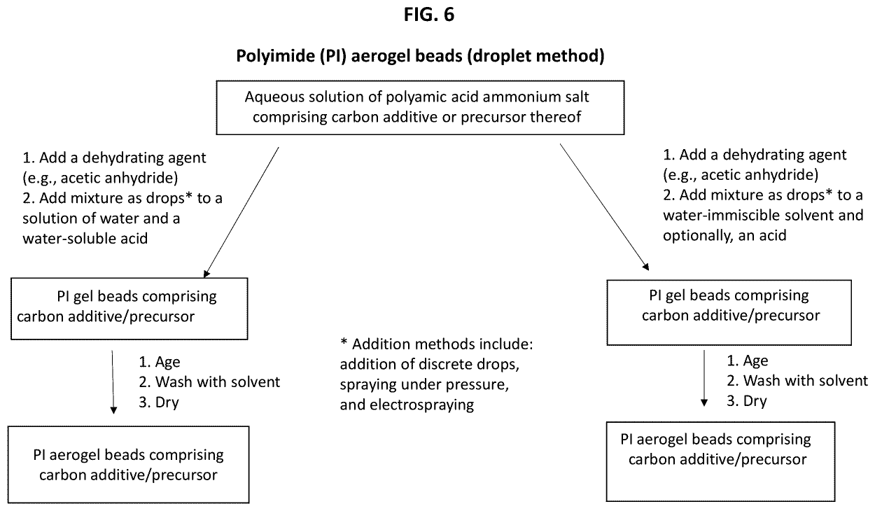

With reference to FIG. 6, the polyamic acid ammonium salt is imidized chemically by adding a dehydrating agent to the aqueous solution of the polyamic acid ammonium salt, forming a gelation mixture as described herein above with respect to FIG. 4. In some aspects, the dehydrating agent is acetic anhydride. However, in this aspect, instead of pouring the gelation mixture into molds to form monoliths, the method comprises adding the gelation mixture, prior to gelation, to a solution of a water-soluble acid in water, or adding the gelation mixture to a water-immiscible solvent, optionally comprising an acid, to form polyimide gel beads. Generally, the sol is added rapidly in order to complete the dropwise addition before gelation of the sol occurs. The adding can be performed by a number of different techniques, including dripping the gelation mixture into the solution of the water-soluble acid in water, spraying the gelation mixture under pressure through one or more nozzles into the solution of the water-soluble acid in water, or electrospraying the gelation mixture through one or more needles into the solution of the water-soluble acid in water.

With reference to FIG. 6, in some aspects, the method comprises adding the gelation mixture to a solution of a water-soluble acid in water. The water-soluble acid may vary, and may be, for example, an organic acid or a mineral acid. In some aspects, the acid is a mineral acid, such as hydrochloric, sulfuric, or phosphoric acid. In some aspects, the acid is an organic acid. The organic acid may vary, but is typically a lower carboxylic acid, including, but not limited to, formic, acetic, or propionic acid. In some aspects, the acid is acetic acid. The quantity of acid present may vary, but is typically from about 10 to about 20% by volume in the water. In some aspects, the solution comprises acetic acid in an amount of about 10%, or an amount of about 20% by volume.

The size of the polyimide gel beads may vary based on the size of the drops added to the solution of water-soluble acid in water. In some aspects, the gelation mixture is added as discrete droplets (e.g., dripped in from a pipet or other suitable drop-forming device, either manually or in an automated fashion). The polyimide gel beads produced from such droplets tend to be relatively large in diameter, e.g., having a diameter in a range from about 0.5 to about 10 millimeters, for example from about 0.5, about 1, about 2, about 3, about 4, or about 5, to about 6, about 7, about 8, about 9, or about 10 mm. In some aspects, the beads have a size ranging from about 0.5 to about 5 mm in diameter.

With reference to FIG. 6, in some aspects, the gelation mixture is added by spraying, producing relatively smaller polyimide gel beads (e.g., on the order of microns). The spraying may be conducted using a variety of aerosol formation techniques known in the art, such as pressurized gas assisted aerosol formation or electrospraying. In particular aspects, the spraying is electrospraying. Generally, electrospraying is carried out by pumping the solution comprising the gelation mixture through one or more needles into a bath of the solution of the water-soluble acid in water while applying a voltage differential of about 5 to 60 kV between the bath and the one or more needles. This method results in very fine droplets of the gelation mixture being introduced to the solution of the water-soluble acid in water. Upon contact, the micron-size droplets react with the acid to form a polyamic acid skin around the droplet, which gradually gels to form the polyimide beads. Without wishing to be bound by theory, it is believed that the water-soluble acid protonates the carboxylate groups of the polyamic acid salt, forming an initial skin, which is penetrated by the dehydrating agent, imidizing the salt of the polyamic acid within the droplet, forming a wet-gel polyimide bead. In some aspects, the beads have a size ranging from about 5 to about 200 microns in diameter, for example from about 5, about 10, about 20, about 30, about 40, or about 50, to about 60, about 70, about 80, about 90, about 100, or about 200 microns in diameter.

With continued reference to FIG. 6, following the formation of the polyimide gel beads by dripping or spraying, the polyimide gel beads are aged, washed (solvent exchanged), and dried as described herein above with respect to chemically imidized polyimide monoliths, to form the corresponding polyimide aerogel beads.

D. Polyimide Aerogel Beads from an Aqueous Solution of an Ammonium Salt of a Polyamic Acid by Chemical Imidization (Droplet Method; Water-Immiscible Solvent)

With continued reference to FIG. 6, in another aspect, a gelation mixture as described herein above with respect to the aqueous droplet method. However, in this aspect, instead of adding the gelation mixture as drops into the solution of the water-soluble acid in water, the method comprises adding the gelation mixture to a water-immiscible solvent, optionally containing an acid, to form polyimide gel beads. Generally, the sol is added rapidly in order to complete the dropwise addition before gelation of the sol occurs.

The adding can be performed by a number of different techniques, including dripping the gelation mixture into the water-immiscible solvent, spraying the gelation mixture under pressure through one or more nozzles into the water-immiscible solvent, or electrospraying the gelation mixture through one or more needles into the water-immiscible solvent, each as described herein above.

The water-immiscible solvent may vary. Suitable solvents include, but are not limited to, oils such as silicone oil or mineral oil, aliphatic hydrocarbons, aromatic hydrocarbons, and chlorinated hydrocarbons. In some aspects, the solvent is a five to twelve carbon atom (C5-C12) aliphatic or aromatic hydrocarbon. In some aspects, the solvent is hexane. In particular aspects, the solvent is mineral spirits.

The optional acid may vary, but is typically a lower carboxylic acid, including, but not limited to, formic, acetic, or propionic acid. In some aspects, the acid is acetic acid. The quantity of acid present may vary, but when present, is typically from about 10 to about 20% by volume of the water-immiscible solvent. Without wishing to be bound by theory, it is believed that the presence of acid during the gelation may form an outer surface of the bead having carboxyl groups which do not react to form imide groups, and the presence of such acid groups on the outer surface may avoid coalescence of the beads.

In some aspects, the gelation mixture is added as discrete droplets (e.g., dripped in from a pipet or other suitable drop-forming device, either manually or in an automated fashion). The polyimide gel beads produced from such droplets tend to be relatively large in diameter, e.g., having a diameter in a range from about 0.5 to about 10 millimeters, for example from about 0.5, about 1, about 2, about 3, about 4, or about 5, to about 6, about 7, about 8, about 9, or about 10 mm. In some aspects, the beads have a size ranging from about 0.5 to about 5 mm in diameter.

In some aspects, the gelation mixture is added by spraying, producing relatively smaller polyimide gel beads (e.g., on the order of microns). The spraying may be conducted using a variety of aerosol formation techniques known in the art, such as pressurized gas assisted aerosol formation or electrospraying. In particular aspects, the spraying is electrospraying. Generally, electrospraying is carried out by pumping the solution comprising the gelation mixture through one or more needles into a bath of the solution of the water-soluble acid in water while applying a voltage differential of about 5 to 60 kV between the bath and the one or more needles. This method results in very fine droplets of the gelation mixture being introduced to the solution of the water-soluble acid in water. Upon contact, the micron-size droplets react with the acid to form a polyamic acid skin around the droplet, which gradually gels to form the polyimide beads. Without wishing to be bound by theory, it is believed that the water-soluble acid protonates the carboxylate groups of the polyamic acid salt, forming an initial skin, which is penetrated by the dehydrating agent, imidizing the salt of the polyamic acid within the droplet, forming a wet-gel polyimide bead. In some aspects, the beads have a size ranging from about 5 to about 200 microns in diameter, for example from about 5, about 10, about 20, about 30, about 40, or about 50, to about 60, about 70, about 80, about 90, about 100, or about 200 microns in diameter.

With continued reference to FIG. 6, following the formation of the polyimide gel beads by dripping or spraying, the polyimide gel beads are aged, washed (solvent exchanged), and dried as described herein above with respect to chemically imidized polyimide monoliths, to form the corresponding polyimide aerogel beads.

E. Polyimide Aerogel Beads from an Aqueous Solution of an Ammonium Salt of a Polyamic Acid by Chemical Imidization (Emulsion Method 1)

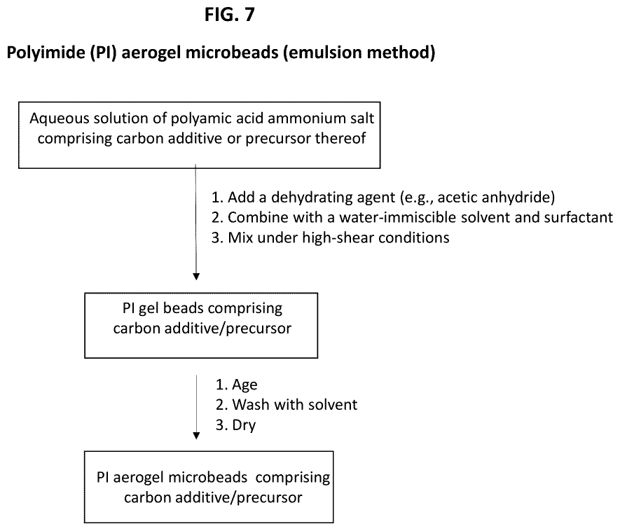

In some aspects, the polyimide gel and corresponding aerogel are in bead form, and the salt if the polyamic acid in the aqueous solution is an ammonium salt, prepared as described above with reference to FIG. 3B or FIG. 3C (Options 1, 2, or 3). In such aspects, the imidization may be chemical imidization, and the method may be that generally described in FIG. 7. With reference to FIG. 7, imidizing the polyamic acid salt comprises adding a dehydrating agent to the aqueous solution of the polyamic acid salt to form a gelation mixture as described herein above. The method further comprises combining the gelation mixture with a water-immiscible solvent comprising a surfactant; and mixing the resulting mixture under high-shear conditions.

Mixing the biphasic mixture under high-shear conditions generally provides micron-sized polyimide beads. In some aspects, the water-immiscible solvent and surfactant are added to the aqueous gelation mixture. In some aspects, the aqueous gelation mixture is added to the water-immiscible solvent and surfactant.

The water-immiscible solvent may vary. Suitable solvents include, but are not limited to, oils such as silicone oil or mineral oil, aliphatic hydrocarbons, aromatic hydrocarbons, and chlorinated hydrocarbons. In some aspects, the solvent is a C5-C12 aliphatic or aromatic hydrocarbon. In some aspects, the solvent is hexane. In particular aspects, the solvent is mineral spirits.

The surfactant may vary. As used herein, the term “surfactant” refers to a substance which aids in the formation and stabilization of emulsions by promoting dispersion of hydrophobic and hydrophilic (e.g., oil and water) components. Suitable surfactants are generally non-ionic, and include, but are not limited to, polyethylene glycol esters of fatty acids, propylene glycol esters of fatty acids, polysorbates, polyglycerol esters of fatty acids, sorbitan esters of fatty acid, and the like. Suitable surfactants have an HLB number ranging from about 0 to about 20. In some aspects, the HLB number is from about 3.5 to about 6. As will be understood by one skilled in the art, HLB is the hydrophilic-lipophilic balance of an emulsifying agent or surfactant is a measure of the degree to which it is hydrophilic or lipophilic. The HLB value may be determined by calculating values for the different regions of the molecule, as described by Griffin in Griffin, William C. (1949), “Classification of Surface-Active Agents by ‘HLB’” (PDF), Journal of the Society of Cosmetic Chemists, 1 (5): 311-26 and Griffin, William C. (1954), “Calculation of HLB Values of Non-Ionic Surfactants” (PDF), Journal of the Society of Cosmetic Chemists, 5 (4): 249-56, and by Davies in Davies JT (1957), “A quantitative kinetic theory of emulsion type, I. Physical chemistry of the emulsifying agent” (PDF), Gas/Liquid and Liquid/Liquid Interface, Proceedings of the International Congress of Surface Activity, pp. 426-38. HLB value may be determined in accordance with the industry standard text book, namely “The HLB SYSTEM, a time-saving guide to emulsifier selection” ICI Americas Inc., Published 1976 and Revised, March, 1980.

Examples of suitable surfactants generally include, but are not limited to: polyoxyethylene-sorbitan-fatty acid esters; e.g., mono- and tri-lauryl, palmityl, stearyl and oleyl esters; e.g., products of the type known as polysorbates and commercially available under the trade name Tween®; polyoxyethylene fatty acid esters, e.g., polyoxyethylene stearic acid esters of the type known and commercially available under the trade name Myrj®; polyoxyethylene ethers, such as those available under the trade name Brij®; polyoxyethylene castor oil derivatives, e.g., products of the type known and commercially available as Cremophors®, sorbitan fatty acid esters, such as the type known and commercially available under the name Span® (e.g., Span 80); polyoxyethylene-polyoxypropylene co-polymers, e.g., products of the type known and commercially available as Pluronic® or Poloxamer®; glycerol triacetate; and monoglycerides and acetylated monoglycerides, e.g., glycerol monodicocoate (Imwitor® 928), glycerol monocaprylate (Imwitor® 308), and mono- and di-acetylated monoglycerides. In some aspects, the one or surfactants comprise a commercially available polymeric surfactant of the type known under the trade name Hypermer® (Croda Industrial Chemicals; Edison, NJ, USA).

In some aspects, the one or more surfactants comprise Tween 20, Tween 80, Span 20, Span 40, Span 60, Span 80, or a combination thereof. In some aspects, the surfactant is Span 20, Tween 80, or a mixture thereof. In some aspects, the one or more surfactants is Hypermer© B246SF. In some aspects, the one or more surfactants is Hypermer® A70.

The concentration of the surfactant may vary. In some aspects, the surfactant, or a mixture of surfactants, is present in the water-immiscible solvent in amount by weight from about 1 to about 5%, such as about 1, about 2, about 3, about 4, or about 5%.

Spherical droplets of the aqueous sol form in the water-immiscible solvent by virtue of the interface tension. The droplets gel and strengthen during the time in the water-immiscible solvent, e.g., mineral spirits. Agitation of the mixture is typically used to form an emulsion and/or to prevent the droplets from agglomerating. For example, the mixture of aqueous gelation mixture and water-immiscible solvent can be agitated (e.g., stirred) to form an emulsion, which may be stable or temporary. Exemplary aspects of agitation to provide gel beads from the sol mixture and water-immiscible solvent include magnetic stirring (up to about 600 rpm), mechanical mixing (up to about 1500 rpm) and homogenization (i.e., mixing at up to about 9000 rpm). In some aspects, mixing is performed under high-shear conditions e.g., using a high-shear mixer or homogenizer). Fluid undergoes shear when one area of fluid travels at a different velocity relative to an adjacent area. A high-shear mixer (homogenizer) uses a rotating impeller or high-speed rotor, or a series of such impellers or inline rotors, to “work” the fluid, creating flow and shear. The tip velocity (i.e., the speed encountered by the fluid at the outside diameter of the rotor), will be higher than the velocity encountered at the center of the rotor, with this velocity difference creating shear. Generally, higher shear results in smaller beads.

In some aspects, an additional solvent, e.g., water or ethanol, can be added after gelation to produce smaller beads and reduce agglomeration of large clusters of beads.

The size of the wet-gel beads may vary. In some aspects, the wet-gel beads have a size ranging from about 5 to about 500 microns in diameter, for example from about 5, about 10, about 20, about 30, about 40, or about 50, to about 60, about 70, about 80, about 90, about 100, about 200, about 300, about 400, or about 500 microns in diameter.

With continued reference to FIG. 7, following the formation of the polyimide gel beads, the polyimide gel beads are aged, washed (solvent exchanged), and dried as described herein above with respect to chemically imidized polyimide beads from the droplet methods, to form the corresponding polyimide aerogel beads.

F. Polyimide Aerogel Beads from an Aqueous Solution of an Ammonium Salt of a Polyamic Acid by Chemical Imidization (Emulsion Method 2)

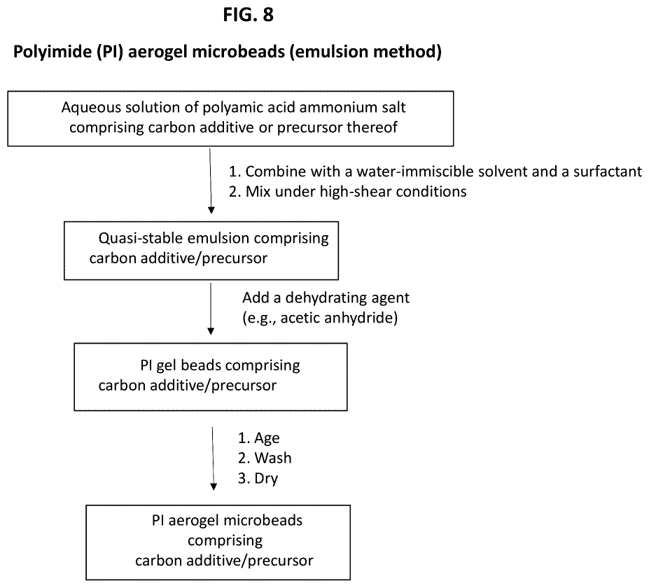

In some aspects, the polyimide gel and corresponding aerogel are in bead form, and the salt if the polyamic acid in the aqueous solution is an ammonium salt, prepared as described above with reference to FIG. 3B or FIG. 3C (Options 1, 2, or 3). In such aspects, the imidization may be chemical imidization, and the method may be that generally described in FIG. 8. With reference to FIG. 8, the method comprises: combining the gelation mixture with a water-immiscible solvent comprising a surfactant; mixing the resulting mixture under high-shear conditions to form a quasi-stable emulsion; and adding a dehydrating agent to the quasi-stable emulsion. The method differs from that of emulsion method 1 described herein above only in that a quasi-stable emulsion of the aqueous polyamic acid ammonium salt and the water-immiscible solvent is formed first, followed by adding the dehydrating agent.

Each of the surfactant, the water-immiscible solvent, and the mixing conditions are as described above with respect to emulsion method 1. In some aspects, the water-immiscible organic solvent is a C5-C12 hydrocarbon. In some aspects, the water-immiscible organic solvent is mineral spirits. In some aspects, the dehydrating agent is acetic anhydride.

Monolithic Polyamic Acid and Polyimide Aerogels from an Aqueous Solution of a Salt of a Polyamic Acid

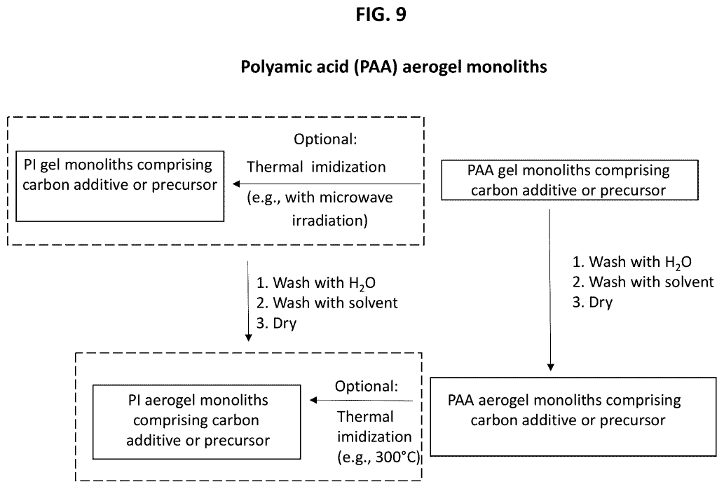

In another aspect is provided a method of forming a polyamic acid aerogel in monolithic form. The method generally comprises: providing an aqueous solution of a polyamic acid salt; acidifying the polyamic acid salt solution to form a polyamic acid gel; and drying the polyamic acid gel to form the polyamic acid aerogel. In some aspects, acidifying the polyamic acid salt comprises adding delta-gluconolactone to the aqueous solution of the polyamic acid salt to form a gelation mixture and pouring the gelation mixture into a mold and allowing the gelation mixture to gel, each as described with respect to FIG. 5. Accordingly, the polyamic acid gel monolith as described with reference to FIG. 5 may be the starting point for providing the polyamic acid aerogel monolith. In some aspects, the polyamic acid aerogel monolith may be prepared from the corresponding polyamic acid gel monolith according to FIG. 9. With reference to FIG. 9, the polyamic acid gel monolith is washed with water, solvent exchanged, and dried, each as described herein above, to provide the polyamic acid aerogel monolith.

In some aspects, the method further comprises preparing a polyimide gel monolith from the polyamic acid gel monolith. With reference to FIG. 9, thermal imidization (e.g., by subjecting the polyamic acid gel monolith to a temperature of about 300° C. for a period of time) converts the polyamic acid gel monolith to a corresponding polyimide gel monolith.

In some aspects, the method further comprises preparing a polyimide aerogel monolith from the polyamic acid aerogel monolith. With reference to FIG. 9, thermal imidization (e.g., by subjecting the polyamic acid gel monolith to a temperature of about 300° C. for a period of time) converts the polyamic acid aerogel monolith to a corresponding polyimide aerogel monolith.

In some aspects, the method further comprises preparing a polyimide aerogel monolith from the polyimide aerogel monolith. With further reference to FIG. 8, the polyimide gel monolith is washed with water, solvent exchanged, and dried, each as described herein above, to provide the polyimide aerogel monolith.

Polyamic Acid and Polyimide Aerogel Beads from an Aqueous Solution of a Salt of a Polyamic Acid

### A. Droplet Method

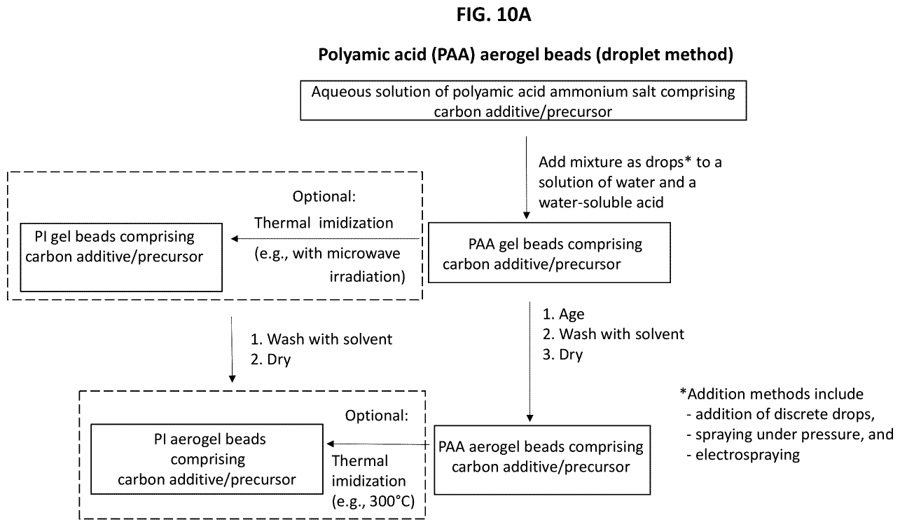

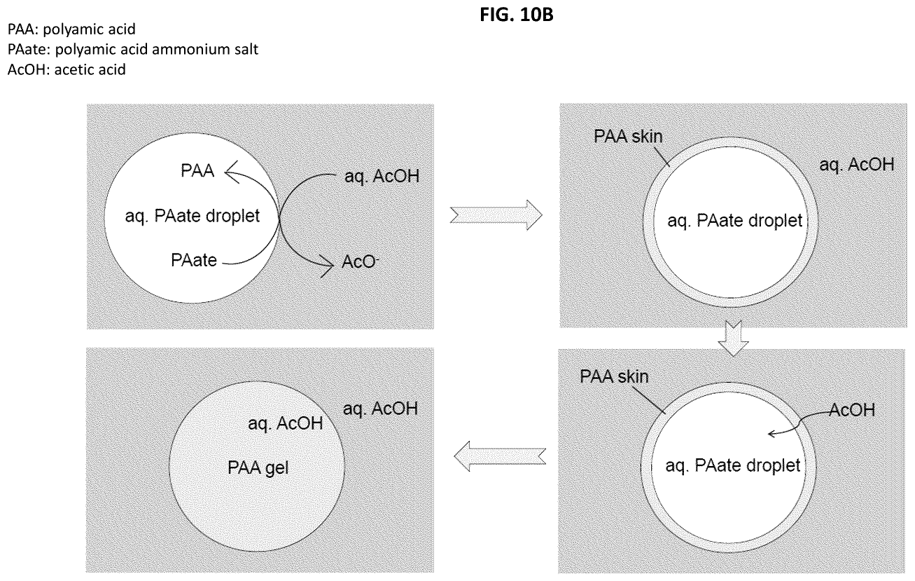

In another aspect is provided a method of forming a polyamic acid aerogel in bead form. In some aspects, the method may be that generally described in FIG. 10A. With reference to FIG. 10A, the method generally comprises: providing an aqueous solution of a polyamic acid salt; acidifying the polyamic acid salt solution to form a polyamic acid gel; and drying the polyamic acid gel to form the polyamic acid aerogel. In some aspects, acidifying the polyamic acid salt comprises adding the aqueous solution of polyamic acid salt to a solution of a water-soluble acid in water to form the polyamic acid gel beads, wherein adding comprises dripping the aqueous solution of polyamic acid salt into the solution of the water-soluble acid in water, spraying the aqueous solution of polyamic acid salt under pressure through one or more nozzles into the solution of the water-soluble acid in water using pressure; or electrospraying the aqueous solution of polyamic acid salt into the solution of the water-soluble acid in water, each as described with respect to FIG. 6. A non-limiting cartoon illustration of the process believed to occur during the bead formation is provided in FIG. 10B. Without wishing to be bound by theory, it is believed that the water-soluble acid (e.g., acetic acid) protonates the carboxylate groups of the polyamate, forming an initial skin, which is penetrated by the water-soluble acid, protonating the carboxylate groups of the polyamic acid ammonium salt within the droplet, forming a wet-gel polyamic acid bead.

In some aspects, the polyamic acid gel beads as described with reference to FIG. 6 are the starting point for providing the polyamic acid aerogel beads of FIG. 10A. With reference to FIG. 10A, the polyamic acid gel beads are washed with water, solvent exchanged, and dried, each as described herein above, to provide the polyamic acid aerogel beads.

In some aspects, the method further comprises preparing polyimide gel beads from the polyamic acid gel beads. With reference to FIG. 10A, thermal imidization (e.g., by subjecting the polyamic acid gel beads to a temperature of about 300° C. for a period of time) converts the polyamic acid gel beads to the corresponding polyimide gel beads.

In some aspects, the method further comprises preparing polyimide aerogel beads from the polyamic acid aerogel beads. With reference to FIG. 10A, thermal imidization (e.g., by subjecting the polyamic acid gel beads to a temperature of about 300° C. for a period of time) converts the polyamic acid aerogel beads to the corresponding polyimide aerogel beads.

In some aspects, the method further comprises preparing polyimide aerogel beads from the polyimide aerogel beads. With further reference to FIG. 10A, the polyimide gel beads are washed with water, solvent exchanged, and dried, each as described herein above, to provide the polyimide aerogel beads.

### B. Emulsion Method

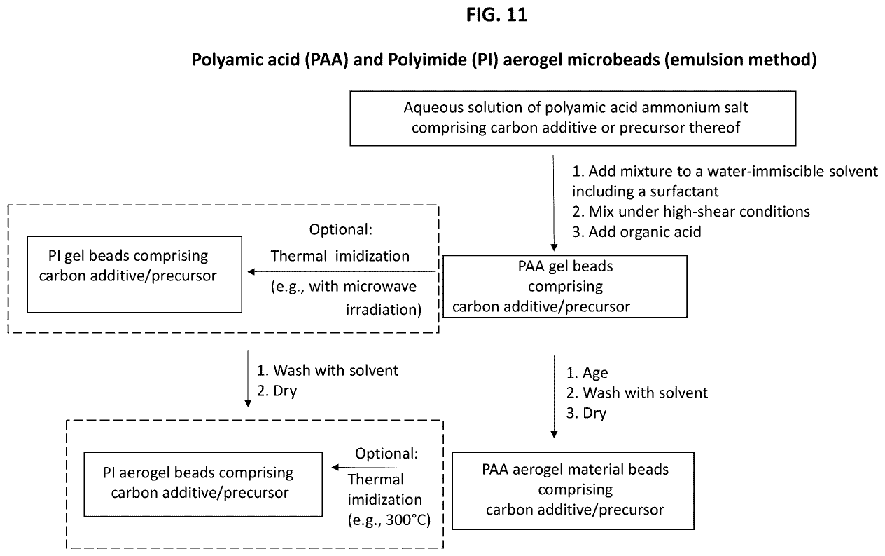

In another aspect is provided a method of forming a polyamic acid aerogel in bead form. In some aspects, the method may be that generally described in FIG. 11. With reference to FIG. 11, the method generally comprises: providing an aqueous solution of a polyamic acid salt; combining the aqueous solution of polyamic acid salt with a water-immiscible solvent comprising a surfactant; mixing the resulting mixture under high-shear conditions to form an emulsion; and adding an organic acid to the emulsion.

The water-immiscible solvent may vary. Suitable solvents include, but are not limited to, oils such as silicone oil or mineral oil, aliphatic hydrocarbons, aromatic hydrocarbons, and chlorinated hydrocarbons. In some aspects, the solvent is a C5-C12 aliphatic or aromatic hydrocarbon. In particular aspects, the solvent is mineral spirits.

The water-immiscible solvent includes a surfactant as described herein above. In some aspects, the surfactant comprises Tween® 20, Tween® 80, Span® 20, Span® 40, Span® 60, Span® 80, or a combination thereof. In some aspects, the surfactant is Span® 20, Tween® 80, or a mixture thereof. In some aspects, the surfactant is Hypermer® B246SF. In some aspects, the surfactant is Hypermer© A70.

The concentration of the surfactant may vary. In some aspects, the surfactant, or a mixture of surfactants, is present in the water-immiscible solvent in amount by weight from about 1 to about 5%, such as about 1, about 2, about 3, about 4, or about 5%.

In some aspects, combining comprises adding the aqueous solution of the polyamic acid ammonium salt to the water-immiscible solvent including the surfactant. In some aspects, combining comprises adding the water-immiscible solvent including the surfactant to the aqueous solution of the polyamic acid ammonium salt.

Mixing the biphasic mixture under high-shear conditions generally provides micron-sized polyamic acid beads. The size of the polyamic acid wet-gel beads may vary. In some aspects, the wet-gel beads have a size ranging from about 5 to about 500 microns in diameter, for example from about 5, about 10, about 20, about 30, about 40, or about 50, to about 60, about 70, about 80, about 90, about 100, about 200, about 300, about 400, or about 500 microns in diameter.

With continued reference to FIG. 11, the polyamic acid gel beads are washed with water, solvent exchanged, and dried, each as described herein above, to provide the polyamic acid aerogel beads.

In some aspects, the method further comprises preparing polyimide gel beads from the polyamic acid gel beads. With reference to FIG. 11, thermal imidization (e.g., by subjecting the polyamic acid gel beads to a temperature of about 300° C. for a period of time) converts the polyamic acid gel beads to the corresponding polyimide gel beads.

In some aspects, the method further comprises preparing polyimide aerogel beads from the polyamic acid aerogel beads. With reference to FIG. 11, thermal imidization (e.g., by subjecting the polyamic acid aerogel beads to a temperature of about 300° C. for a period of time) converts the polyamic acid aerogel beads to the corresponding polyimide aerogel beads.

In some aspects, the method further comprises preparing polyimide aerogel beads from the polyimide gel beads. With further reference to FIG. 11, the polyimide gel beads are washed with water, solvent exchanged, and dried, each as described herein above, to provide the polyimide aerogel beads.

Polyamic Acid Metal Salt Aerogel Beads from an Aqueous Solution of a Salt of a Polyamic Acid

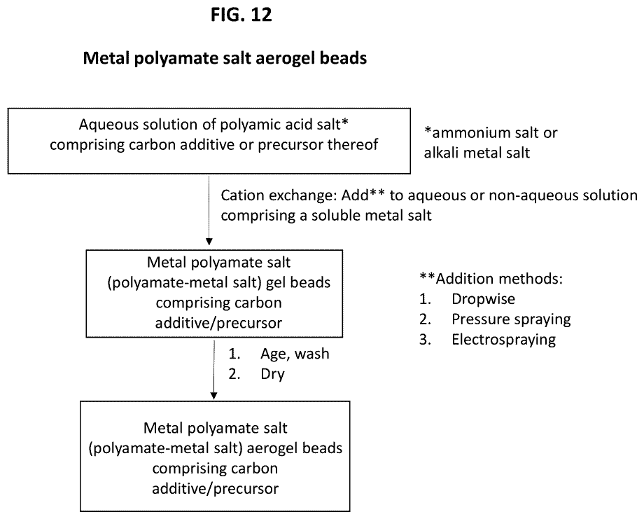

In another aspect is provided a method of forming a polyamic acid metal salt aerogel in the form of beads. In some aspects, the method may be that generally described in FIG. 12. With reference to FIG. 12, the method generally comprises:
providing an aqueous solution of an ammonium or alkali metal salt of a polyamic acid;
performing a metal ion exchange comprising adding the solution of the polyamic acid salt to a solution comprising a soluble metal salt to form polyamate metal salt gel beads; and
drying the polyamic acid metal salt gel beads to form the polyamic acid metal salt aerogel beads.

In some aspects, the salt is prepared as described above with reference to FIG. 3A, FIG. 3B, or FIG. 3C. In some aspects, the salt is an ammonium salt. In some aspects, the salt is an alkali metal salt. The method comprises performing a metal ion exchange. With reference to FIG. 12, the metal ion exchange comprises adding the solution of the polyamic acid salt to a solution comprising a soluble metal salt. In some aspects, the addition comprises dripping the aqueous solution of polyamic acid salt into the solution of the soluble metal salt, spraying the aqueous solution of polyamic acid salt under pressure through one or more nozzles into the solution of the soluble metal salt, or electrospraying the aqueous solution of polyamic acid salt into the solution of the soluble metal salt, wherein each of the dripping, spraying, and electrospraying are as described herein above. In particular aspects, the method comprises electrospraying the polyamic acid salt solution through one or more needles at a voltage in a range from about 5 to about 60 kV.

In some aspects, the soluble metal salt comprises a main group transition metal, a rare earth metal, an alkaline earth metal, or combinations thereof. In some aspects, the soluble metal salt comprises copper, iron, nickel, silver, calcium, magnesium, yttrium, or a combination thereof. In some aspects, the soluble metal salt comprises lanthanum, cerium, praseodymium, neodymium, promethium, samarium, europium, gadolinium, terbium, dysprosium, holmium, erbium, thulium, ytterbium, lutetium, or a combination thereof.

Without wishing to be bound by theory, it is believed that the droplets of the aqueous solution of the ammonium or alkali metal salt of the polyamic acid, upon contact with metal ions in the solution comprising a soluble metal salt, generates an outer crust of insoluble polyamate metal salt, followed by migration of ions of the soluble metal salt into the interior of the droplet, thus forming a polyamate metal salt gel bead in which a substantial portion of the polyamic acid carboxylate groups are associated with anions of the soluble metal salt.

With continued reference to FIG. 12, the resulting polyamic acid metal salt gel beads are aged, washed with water, solvent exchanged, and dried, each as described herein above, to provide the polyamic acid metal salt (polyamate) aerogel beads.

As noted above with respect to formation of polyamic acids and salts thereof, the imidization options discussed above, while generally referencing water-based methods, is not to be construed as so limited. One of skill in the art will recognize that many opportunities exist to replace aqueous solutions with organic solvent solutions, and such substitutions are contemplated herein.

Carbon Aerogels Comprising Carbon Additive from Polyimide, Polyamic Acid, and Metal Polyamate Salt Aerogels

As described herein above, the method generally comprises converting an organic aerogel comprising a carbon additive or precursor thereof to a carbon aerogel comprising a carbon additive, the converting comprising pyrolyzing (carbonizing) the organic aerogel. In some aspects, the organic aerogel is a polyimide, a polyamic acid, or a combination thereof, which may be in monolithic or bead form.

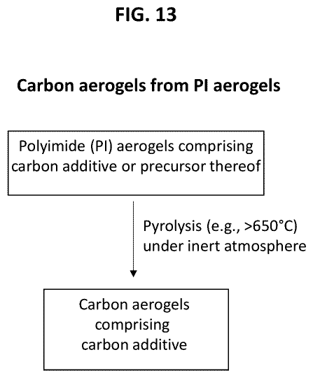

In some aspects, the organic aerogel is a polyimide, which is pyrolyzed to provide the carbon aerogel comprising a carbon additive. A non-limiting illustration of this aspect is provided in FIG. 13.

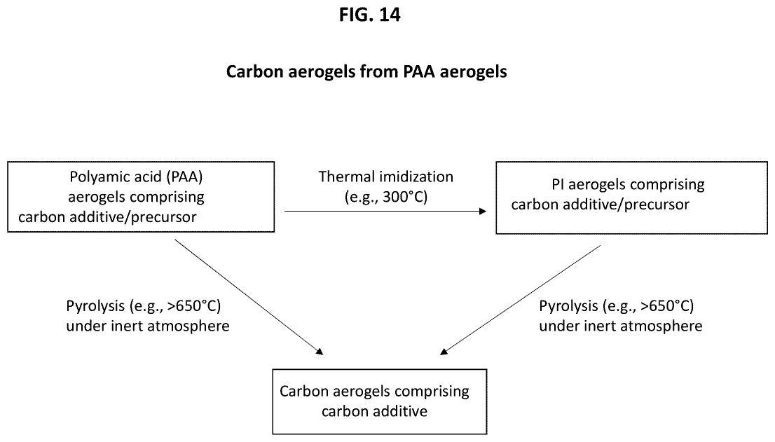

In some aspects, the organic aerogel is a polyamic acid, which may be directly converted to a carbon aerogel comprising a carbon additive (i.e., without first imidizing to provide a polyimide aerogel). In some aspects, the organic aerogel is a polyamic acid, which is thermally imidized as disclosed herein to first provide a polyimide aerogel, which is then subsequently pyrolyzed to provide the carbon aerogel comprising a carbon additive. A non-limiting illustration of these aspects is provided in FIG. 14.

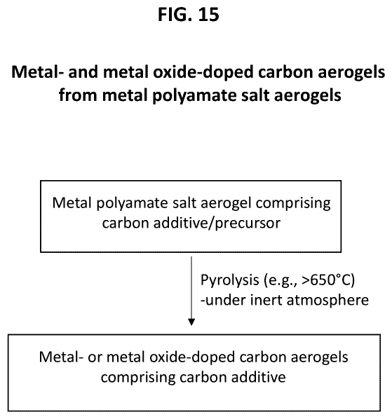

In some aspects, the organic aerogel is a polyamic acid metal salt aerogel which is pyrolyzed to provide the carbon aerogel comprising a carbon additive. In such an aspect, upon pyrolyzing, the ions of the soluble metal salt which are present may either form a corresponding metal oxide, or may sinter and form the corresponding metal, depending on the metal species and the pyrolysis conditions. A non-limiting illustration of this aspect is provided in FIG. 15.

### II. Physical Properties of Carbon Aerogels Comprising a Carbon Additive

In some aspects, the carbon aerogel comprising a carbon additive as disclosed herein can take the form of a monolith. As used herein, the term “monolith” refers to aerogel materials in which a majority (by weight) of the aerogel included in the aerogel material is in the form of a macroscopic, unitary, continuous, self-supporting object. Monolithic aerogel materials include aerogel materials which are initially formed to have a well-defined shape, but which can be subsequently cracked, fractured or segmented into non-self-repeating objects. For example, irregular chunks are considered as monoliths. Monolithic aerogels may take the form of a freestanding structure, or a reinforced material with fibers or an interpenetrating foam.

In other aspects, the carbon aerogel comprising a carbon additive of the disclosure may be in particulate form, for example as beads or particles from, e.g., crushing monolithic material, or from preparative methods directed to bead formation. The aerogel in particulate form can have various particle sizes. In the case of spherical particles (e.g., beads), the particle size is the diameter of the particle. In the case of irregular particles, the term particle size refers to the maximum dimension (e.g., a length, width, or height). The particle size may vary depending on the physical form, preparation method, and any subsequent physical steps performed. In some aspects, the aerogel in particulate form can have a particle size from about 1 micrometer to about 10 millimeters. For example, the aerogel in particulate form can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, about 60 micrometers, about 70 micrometers, about 80 micrometers, about 90 micrometers, about 100 micrometers, about 200 micrometers, about 300 micrometers, about 400 micrometers, about 500 micrometers, about 600 micrometers, about 700 micrometers, about 800 micrometers, about 900 micrometers, about 1 millimeter, about 2 millimeters, about 3 millimeters, about 4 millimeters, about 5 millimeters, about 6 millimeters, about 7 millimeters, about 8 millimeters, about 9 millimeters, about 10 millimeters, or in a range between any two of these values. In some aspects, the aerogel can have a particle size in the range of about 5 micrometers to about 100 micrometers, or from about 5 to about 50 micrometers. In some aspects, the aerogel can have a particle size in the range of about 1 to about 4 millimeters.

The quantity of the carbon additive present in the carbon aerogel may vary, depending on initial loading of the additive or precursor, the efficiency of the incorporation, and the efficiency of the conversion of precursor to additive, for example. In some aspects, the carbon aerogel comprises from about 0.1 to about 20% by weight of carbon black, such as from about 0.1, about 0.5, or about 1, to about 2, about 3, about 4, about 5, about 6, about 7, about 8, about 9, or about 10% by weight of carbon black. In some aspects, the carbon aerogel comprises about 0.1 to about 20% by weight of soft carbon, such as from about 0.1, about 0.5, about 1, to about 2, about 3, about 4, about 5, about 6, about 7, about 8, about 9, or about 10, to about 15, or about 20% by weight of soft carbon. In some aspects, the carbon aerogel comprises from about 0.1 to about 5% by weight of graphene or graphene oxide, such as from about 0.1, about 0.5, or about 1, to about 2, about 3, about 4, or about 5% by weight of graphene or graphene oxide.

In some aspects, the carbon aerogel comprises about 0.1 to about 10% by weight of single wall carbon nanotubes, multiple wall carbon nanotubes, carbon nanofibers, or a combination thereof, such as from about 0.1, about 0.5, or about 1, to about 2, about 3, about 4, about 5, about 6, about 7, about 8, about 9, or about 10% by weight of single wall carbon nanotubes, multiple wall carbon nanotubes, carbon nanofibers, or a combination thereof.

In some aspects, the carbon aerogel further comprises silicon. The amount of silicon present in the aerogel may vary. In some aspects, at least a portion of the silicon is present in voids in the carbon aerogel.

In some aspects of the disclosure, the carbon aerogels (aerogel or xerogel, monolith or beads) may comprise a fibrillar morphology. Within the context of the present disclosure, the term “fibrillar morphology” refers to the structural morphology of a nanoporous material (e.g., a carbon aerogel) being inclusive of struts, rods, fibers, or filaments.

### Measurement of Carbon Aerogel Properties

The carbon aerogels can be characterized by properties such as pore volume, porosity, surface area, and pore size distribution. These properties and associated terms are defined herein below, along with methods of measuring and/or calculating such properties.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It is typically recorded as cubic centimeters per gram (cm³/g or cc/g).

Within the context of the present disclosure, the term “porosity” when used with respect to the polymeric network or the carbon aerogels disclosed herein, refers to a volumetric ratio of pores that does not contain another material (e.g., an electrochemically active species such as silicon particles) bonded to the walls of the pores. For clarification and illustration purposes, it should be noted that within the specific implementation of silicon-doped polymeric network e.g., an aerogel as the primary anodic material in a LIB, porosity refers to the void space after inclusion of silicon particles. As such, porosity may be, for example, about 10%-70% when the anode is in a pre-lithiated state (to accommodate for ion transport and silicon expansion) and about 1%-50% when the anode is in a post-lithiated state. It should be noted that pore volume and porosity are different measures for the same property of the pore structure, namely the “empty space” within the pore structure. For example, when silicon is used as the electrochemically active species contained within the pores of the network (e.g., a carbon aerogel as described herein), pore volume and porosity refer to the space that is “empty”, namely the space not utilized by the silicon or the carbon.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus optimizing the amount of pores that can surround the electrochemically active species and maximizing use of the pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It is typically recorded as any unit length of pore size, for example micrometers or nanometers (nm).

Within the context of the present disclosure, the term “BET surface area” has its usual meaning of referring to the Brunauer-Emmett-Teller method for determining surface area by N₂ adsorption measurements. The BET surface area, expressed in m²/g, is a measure of the total surface area of a porous material per unit of mass. Unless otherwise stated, “surface area” refers to BET surface area. As an alternative to BET surface area, a geometric outer surface area of e.g., a polyimide or carbon bead may be calculated based on the diameter of the bead. Generally, such geometric outer surface areas for beads of the present disclosure are within a range from about 3 to about 700 μm².

As used herein, the term “particle size D50” which is a volume-based accumulative 50% size which is a particle size at a point of 50% on an accumulative curve (i.e., a diameter of a particle in the 50th percentile (median) of the volumes of particles) when the accumulative curve is drawn so that a particle size distribution is obtained on the volume basis and the whole volume is 100%.

Within the context of the present disclosure, the term “density” refers to a measurement of the mass per unit volume of a material (e.g., a carbon aerogel as described herein). The term “density” generally refers to the true or skeletal density of a material, as well as to the bulk density of a material or composition. Density is typically reported as g/cm³, g/cc, or g/mL.

The carbon aerogels properties can be determined using mercury intrusion porosity and helium pycnometry experiments. Mercury intrusion porosity can be used to determine porosity, pore size distribution and pore volume to solid particles. During a typical mercury intrusion porosity, a pressurized chamber is used to force mercury into the voids in a porous substrate. As pressure is applied, mercury fills the larger pores first. As the pressure increases, the mercury can enter into smaller pores. The mercury pycnometry can access and measure pores greater than about 3 nm. Mercury intrusion porosity can be used measure bulk density, skeletal density and porosity. By varying testing parameters (e.g., the pressure range), pores with different sizes can be excluded. The lower pore size limit if mercury intrusion porosity is about 3 nm.

Helium pycnometry uses helium gas to measure the volume of pores of a solid material. During helium pycnometry, a sample is sealed in a compartment and helium gas is added to the compartment. The helium gas penetrates into small pores in the material. After the system has equilibrated, the change in pressure can be used to determine the skeletal density of the solid material. The helium pycnometry can access and measure pores greater than about 0.3 nm, for example, pores sizing from about 3 nm to about 300 nm.

The “Hg skeletal density” (g/cm³) is measured by dividing the mass (g) of the composite material particles by the volume (cm³) of the particles, where the volume is measured by controlling (e.g., by pressure) the mercury access to pores of the particles greater than 3 nm during the measurement. This volume does not include the volume of the mercury accessible pores of the composite materials greater than 3 nm. Instead, the volume only includes the volume of the “skeleton” of the composite material particles. The volume of the pores less than 3 nm is considered as part of the skeleton and included in the skeletal density calculation.

The “Hg bulk density” is measured by dividing the mass (g) of the carbon aerogel particles by the volume (cm³) of the particles, where the volume is measured by controlling (e.g., by pressure) the mercury not to access pores of the particles during the measurement. This volume includes the volume of the pores of the carbon aerogel, including pores greater than 3 nm and less than 3 nm.

The “He skeletal density” is measured by dividing the mass (g) of the carbon aerogel particles by the volume (cm³) of the particles, where the volume is measured by controlling (e.g., by pressure) the helium to access pores of the particles greater than 0.3 nm during the measurement. This volume does not include the volume of the helium accessible pores of the carbon aerogel greater than 0.3 nm. Instead, the volume only includes the volume of the “skeleton” of the carbon aerogel particles. The volume of the pores less than 0.3 nm is considered as part of the skeleton and included in the skeletal density calculation.

The carbon aerogel may also include pores not accessible to either helium nor mercury during the helium pycnometry or mercury pycnometry tests. For example, some of pores formed by removing sacrificial particles may be enclosed in the three-dimensional network and therefore accessible to neither helium pycnometry nor the mercury pycnometry. These non-accessible pores are usually a very small amount in the composite materials disclosed herein. The non-accessible pores are treated as part of the volume of the skeleton without introducing significant variations.

Various physical properties can be calculated according to the formulas below using mercury (Hg) intrusion skeletal density measurements (Hg skeletal density) measured by mercury pycnometry, mercury intrusion bulk density (Hg bulk density) measured by mercury pycnometry, and helium (He) skeletal density (He skeletal density) tested by He pycnometry

$$Total beads level porosity ( \% ) = \{ ( 1 - \frac{Hg bulk density}{He skeletal density} ) / 1 \} * 100 \qquad ( 1 )$$

$$Total pore volume ( {cm}^{3} / g ) = \frac{1}{Hg bulk density} * \frac{Total beads level porosity}{100} \qquad ( 2 )$$

$$Micropore volume ( {cm}^{3} / g ) = \frac{1}{Hg skeletal density} - \frac{1}{He skeletal density} \qquad ( 3 )$$

$$Micropore volume percentage ( \% , vs total pore volume ) = micropore volume / total pore volume \qquad ( 4 )$$

$$\begin{matrix}Mesopore volume percentage ( \% , vs total pore volume ) can be obtained through the mercury intrusion by excluding all the pores > 50 nm \\ Macropore volume percentage ( \% , vs total pore volume ) = 1 - micropore volume perc entage - mesopore volume percentage\end{matrix} \qquad ( 5 )$$

The “total beads level porosity” (%) refers to the ratio of the volume of the pores in the carbon aerogel particles to the volume of the composite material particles. The total beads level porosity is calculated by equation (1). The total beads level porosity includes pores of greater than 0.3 nm that can be accessed by helium and mercury.

The “total pore volume” (cm³/g) refers to the total pore volume of unit weight of the carbon aerogel particles. The total pore volume is calculated by equation (2). The total pore volume includes pores greater than 0.3 nm that can be accessed by helium and mercury.

The “micropore volume” (cm³/g) refers to the micropore volume of unit weight of the carbon aerogel particles. The micropore volume (cm³/g) of the composite material is the difference between of the reciprocal (cm³/g) of the mercury skeletal density (g/cm³) and the reciprocal (cm³/g) of the helium skeletal density (g/cm³) according to equation (3). The micropore volume includes pores greater than 0.3 nm but less than 3 nm. The micropores are accessible by helium but not accessible by mercury.

The “micropore volume percentage” (%) refers to the volumetric ratio between the volume of the micropore to the total pore volume. The micropore volume percentage is calculated by equation (4).

The “mesopore volume percentage” (%) refers to the volumetric ratio between the volume of the mesopores to the total pore volume. Mesopores refers to pores between about 3 nm to about 50 nm that are accessible by mercury. Pores below 3 nm are not accessible by mercury. Mesopore volume percentage can be directly measured using mercury pycnometry by excluding pores greater than 50 nm. The mesopore volume percentage can also be obtained by subtracting micropore volume percentage (calculated in equation (4)) and macropore volume percentage (measured by mercury pycnometry) from total pore volume percentage (100%).

The “macropore volume percentage” (%) refers to the volumetric ratio between the volume of the macropores to the total pore volume. Macropores are greater than about 50 nm that are accessible by mercury. Macropore volume percentage can be directly measured using mercury pycnometry by excluding pores smaller than 50 nm. The macropore volume percentage can also be obtained by subtracting micropore volume percentage (calculated in equation (4)) and mesopore volume percentage (measured by mercury pycnometry) from total pore volume percentage (100%).

### Carbon Aerogel Properties

### Total Porosity

Carbon aerogels described herein generally include micropores (<3 nm), mesopores (3 nm-50 nm), and macropores (>50 nm). The carbon aerogels described herein include a three-dimensional carbon network having a substantial amount of macropores. In some aspects, the total level of porosity of the three-dimensional carbon network is greater than 10%, greater than 20%, greater than 30%, greater than 40%, greater than 50%, greater than 60%, or greater than 70%. In some aspects, the total level of porosity of the three-dimensional carbon network is 25% to 35%, 30% to 40%, 35% to 45%, 40% to 50%, 55% to 65%, or 60% to 70%.

### Total Pore Volume

In certain aspects, carbon aerogels of the present disclosure (without incorporation of electrochemically active species, e.g., silicon) have a relatively large total pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other aspects, carbon aerogels of the present disclosure (with incorporation of electrochemically active species, e.g., silicon) have a total pore volume of about 0.03 cc/g or more, 0.1 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values. In further aspects, the total pore volume of the carbon aerogel (with incorporation of electrochemically active species, e.g., silicon) is from about 0.1 cm³/g to about 1.5 cm³/g, about 0.1 cm³/g to about 1.0 cm³/g, about 0.1 cm³/g to about 0.5 cm³/g, about 0.1 cm³/g to about 0.4 cm³/g, about 0.4 cm³/g to about 1.0 cm³/g, or about 0.9 cm³/g to about 1.4 cm³/g.

### Pore Size Distribution

In certain embodiments, aerogel materials of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

### Macropores, Mesopores, and Micropores

In some aspects, the macropores constitute a volume fraction of greater than about 5%, greater than about 10%, greater than about 20%, greater than about 30%, greater than about 40%, greater than about 50%, greater than about 60%, greater than about 70%, or greater than about 80% of the total pore volume of the three-dimensional carbon network. In some aspects, the macropores constitute a volume fraction of 45% to 55%, 55% to 65%, 65% to 75%, or 70% to 80% of the total pore volume of the three-dimensional carbon network. The carbon aerogels described herein generally have a low volume fraction of mesopores. In some aspects, the mesopores constitute a volume fraction of less than 20%, less than 10%, less than 5%, less than 2%, or less than 1% of the total pore volume of the three-dimensional carbon network. In some aspects, the mesopores constitute a volume fraction of 10% to 20%, 5% to 10%, or 1% to 5% of the total pore volume of the three-dimensional carbon network.

The carbon aerogels described herein include a higher percentage of micropores compared to mesopores. In some aspects, the micropores constitute a volume fraction of less than 80%, less than 70%, less than 65%, less than 55%, less than 50%, less than 45%, less than 40%, less than 35%, less than 30%, less than 25%, less than 20%, less than 15%, or less than 10% of the total pore volume of the three-dimensional carbon network. In some aspects, the micropores constitute a volume fraction of about 10% to about 50%, about 10% to about 45%, about 10% to about 40%, about 10% to about 35%; about 10% to about 30%, about 10% to about 25%, about 10% to about 20%, about 10% to about 15%, about 15% to about 25%, about 25% to about 35%, about 35% to about 45%, or about 45% to about 55% of the total pore volume of the three-dimensional carbon network.

### Skeletal Density

In some aspects, the carbon aerogels have a skeletal density, measured using helium pycnometry, of about 1.0 g/mL to about 2.5 g/mL, about 1.5 g/mL to about 2.5 g/mL, about 1.0 g/mL to about 2.0 g/mL, or 1.0 g/mL to about 1.5 g/mL. In some aspects, the carbon aerogels have a skeletal density, measured using mercury intrusion, of about 0.5 g/mL to about 2.5 g/mL, about 1.5 g/mL to about 2.5 g/mL, about 1.5 g/mL to about 2.0 g/mL, about 0.5 g/mL to about 2.0 g/mL, about 0.5 g/mL to about 1.5 g/mL, or about 0.5 g/mL to about 1.0 g/mL. In some aspects, the carbon aerogels have a bulk density, measured using mercury pycnometry, of 0.5 g/mL to about 2.5 g/mL, of 0.5 g/mL to about 2.0 g/mL, about 0.5 g/mL to about 1.5 g/mL, or about 0.5 g/mL to about 1.0 g/mL.

### III. Electrochemical Properties of the Carbon Aerogels Comprising Carbon Additives

In some aspects, carbon aerogel beads comprising a carbon additive as disclosed herein have an improved first cycle coulombic efficiency relative to carbon only carbon aerogel beads (i.e., not having a carbon additive). In some aspects, the low surface area (<20 m²/g) carbon aerogel beads comprising a carbon additive as disclosed herein have a first cycle coulombic efficiency in a range of about 60-68%. Surprisingly, in comparison, carbon beads that do not contain the carbon additive have a first cycle coulombic efficiency of about 50-58%.

In some aspects, carbon-silicon composite aerogel beads comprising a carbon additive as disclosed herein have an improved rate performance relative to Si/C beads that do not contain carbon additives. Particularly, it was surprisingly found that Si/C beads with soft carbon and carbon black as additives both showed higher capacities at higher current rates relative to Si/C beads that do not contain carbon additives.

The electrical conductivity of the disclosed materials may vary. Within the context of the present disclosure, the term “electrical conductivity” refers to a measurement of the ability of a material to conduct an electric current or other allow the flow of electrons there through or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84—resistivity (R) measurements obtained by measuring voltage (V) divided by current (I), unless otherwise stated. In certain aspects, materials of the present disclosure (e.g., carbon aerogels comprising carbon additives, alone or with silicon particles) have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any aspects or aspects thereof. The compositions and methods provided are exemplary and are not intended to limit the scope of the claimed aspects. All of the various aspects, aspects, and options disclosed herein can be combined in all variations. The scope of the compositions, formulations, methods, and processes described herein include all actual or potential combinations of aspects, aspects, options, examples, and preferences herein.

Although the technology herein has been described with reference to particular aspects, it is to be understood that these aspects are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one aspect,” “certain aspects,” “one or more aspects” or “an aspect” means that a particular feature, structure, material, or characteristic described in connection with the aspect is included in at least one aspect of the technology. Thus, the appearances of phrases such as “in one or more aspects,” “in certain aspects,” “in one aspect” or “in an aspect” in various places throughout this specification are not necessarily referring to the same aspect of the technology. Furthermore, the particular features, structures, materials, or characteristics may be combined in any suitable manner in one or more aspects. Any ranges cited herein are inclusive.

Aspects of the present technology are more fully illustrated with reference to the following examples. Before describing several exemplary aspects of the technology, it is to be understood that the technology is not limited to the details of construction or process steps set forth in the following description. The technology is capable of other aspects and of being practiced or being carried out in various ways. The following examples are set forth to illustrate certain aspects of the present technology and are not to be construed as limiting thereof.

### EXAMPLES

The present invention may be further illustrated by the following non-limiting examples describing the methods.

### Example 1. Carbon Aerogel Microbeads Comprising 3% Graphene Oxide

Carbon aerogel beads comprising 3% by weight graphene oxide were prepared by imidization of an emulsified aqueous solution of a polyamic acid triethylammonium salt in the presence of graphene oxide followed by pyrolysis of the resulting polyimide gel beads.

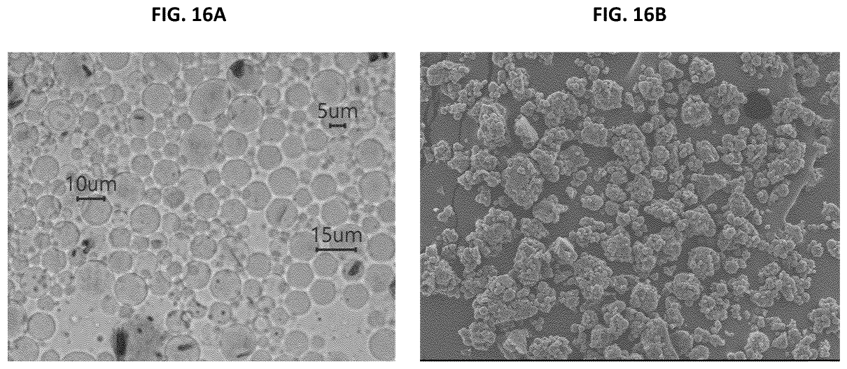

Polyimide gel beads comprising graphene oxide were prepared at a target density of about 0.073 g/cm³. A solution of 1,4-phenylenediamine in water was prepared by mixing PDA (3.51 g; 32.5 mmol) with water (73 g), followed by heating at 60° C. until complete dissolution occurred (approximately 8 minutes). The solution was cooled to room temperature and stirred while a dispersion of graphene oxide in water was added (33 ml of a 4 mg/ml dispersion). Triethylamine (10.9 ml; 2.4:1 mol/mol ratio to PMDA) was added, followed by stirring for 3 minutes. To this mixture was added pyromellitic dianhydride (PMDA; 7.09 g; 1:1 mol/mol ratio relative to PDA) followed by stirring for 3 hours at room temperature, forming a solution of polyamic acid triethylammonium salt. Then, 32.55 g of graphene oxide suspension with mass concentration of 0.4 wt % was added to the polyamic acid triethylammonium salt solution. Following addition of the graphene oxide suspension, acetic anhydride (13.2 ml; 4.3 mol/mol ratio relative to PMDA) was added, and the mixture was stirred for 50 seconds. At the end of that period, the sol was poured into an immiscible phase under high shear conditions using a Ross mixer. The immiscible phase was prepared by dissolving 9.75 g of surfactant Hypermer® B246SF (HLB of 6) in 650 mL of mineral spirits (mineral spirits to PI sol ratio of 5:1). The sol-immiscible phase mixture was emulsified by stirring at 4000 rpm with the Ross mixer for 2.5 minutes. After standing for 1 hour, the emulsified mixture was removed from the Ross mixer and the mineral spirits phase was decanted. The beads were washed with ethanol and collected by filtration. The beads were washed several times with ethanol to fully remove residual water and mineral spirits, and were then dried at 68° C. A photomicrograph of the dry polyimide beads is provided as FIG. 16A. With reference to FIG. 16A, the image of the beads closely resembles images of polyimide beads prepared in the absence of graphene oxide, and indicate very good dispersion of the graphene oxide. The dry polyimide beads were pyrolyzed at 1050° C. for 2 hours under nitrogen to provide the corresponding carbon aerogel beads. A photomicrograph of the carbonized beads is provided as FIG. 16B.

### Example 2. Carbon Aerogel Microbeads Comprising 20% Soft Carbon

Carbon aerogel beads comprising 20% by weight of soft carbon were prepared by imidization of an emulsified aqueous solution of a polyamic acid triethylammonium salt in the presence of perylene tetracarboxylic acid dianhydride (PTCDA) followed by pyrolysis of the resulting polyimide gel beads.

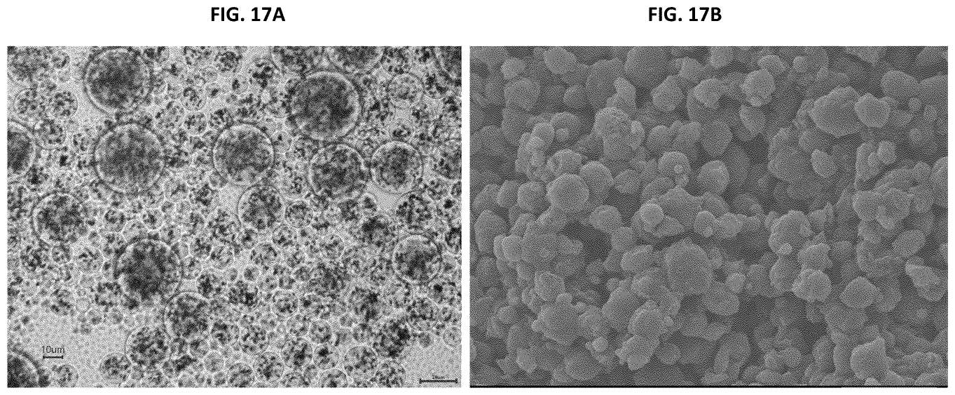

Polyimide gel beads comprising PTCDA were prepared at a target density of about 0.073 g/cm³. A solution of 1,4-phenylenediamine in water was prepared by mixing PDA (7.02 g; 65 mmol) with water (211 g), followed by heating at 60° C. until complete dissolution occurred (approximately 8 minutes). The solution was cooled to room temperature and stirred. Triethylamine (21.8 ml; 2.4:1 mol/mol ratio to PMDA) was added, followed by stirring for 3 minutes. To this mixture was added pyromellitic dianhydride (PMDA; 14.2 g; 1:1 mol/mol ratio relative to PDA) followed by stirring for 3 hours at room temperature. To the resulting triethylammonium salt solution of the polyamic acid, perylene tetracarboxylic acid dianhydride (PTCDA; 4.34 g; 11 mmol) was added and stirred for 10 min, and then acetic anhydride (26.4 ml; 4.3 mol/mol ratio relative to PMDA) was added and the mixture was stirred for 50 seconds. At the end of that period, the sol was poured into an immiscible phase under high shear using a Ross mixer at 4000 rpm. The immiscible phase was prepared by dissolving 9.75 g of surfactant Hypermer® B246SF (HLB of 6) in 650 mL of mineral spirits (mineral spirits to PI sol ratio of 5:1). The mixture was stirred at 4000 rpm with the Ross mixer for 3 minutes. After standing for 1 hour, the mixture was removed from the Ross mixer and the mineral spirits phase was decanted. The beads were washed with ethanol and collected by filtration. The beads were washed several times with ethanol to fully remove residual water and mineral spirits, and were then dried at 68° C. A photomicrograph of the dry polyimide beads is provided as FIG. 17A. The dry polyimide beads were pyrolyzed at 1050° C. for 2 hours under nitrogen to provide the corresponding carbon aerogel beads. A photomicrograph of the carbonized beads is provided as FIG. 17B.

### Example 3. Carbon Aerogel Microbeads Comprising 10% Soft Carbon

Carbon aerogel beads comprising 10% by weight of soft carbon were prepared according to the procedure of Example 2, but using half the quantity of PTCDA.

### Example 4. Carbon Aerogel Microbeads Comprising 10% Carbon Black

Carbon aerogel beads comprising 10% by weight of carbon black were prepared by imidization of an emulsified aqueous solution of a polyamic acid triethylammonium salt in the presence of carbon black followed by pyrolysis of the resulting polyimide gel beads.

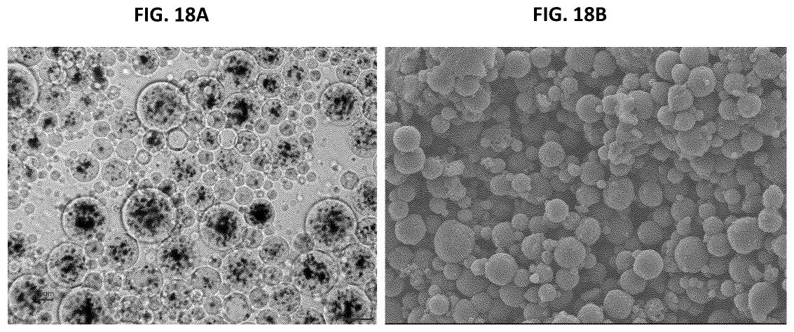

Polyimide gel beads comprising carbon black were prepared at a target density of about 0.073 g/cm³.A solution of 1,4-phenylenediamine in water was prepared by mixing PDA (7.02 g; 65 mmol) with water (211 g), followed by heating at 60° C. until complete dissolution occurred (approximately 8 minutes). The solution was cooled to room temperature and stirred. Triethylamine (21.8 ml; 2.4:1 mol/mol ratio to PMDA) was added, followed by stirring for 3 minutes. To this mixture was added pyromellitic dianhydride (PMDA; 14.2 g; 1:1 mol/mol ratio relative to PDA) followed by stirring for 3 hours at room temperature. To the resulting triethylammonium salt solution of the polyamic acid, carbon black (0.96 g) was added and stirred for 10 min, and then acetic anhydride (26.4 ml; 4.3 mol/mol ratio relative to PMDA) was added and the mixture was stirred for 50 seconds. At the end of that period, the sol was poured into an immiscible phase under high shear using a Ross mixer at 4000 rpm. The immiscible phase was prepared by dissolving 9.75 g of surfactant Hypermer® B246SF (HLB of 6) in 650 mL of mineral spirits (mineral spirits to PI sol ratio of 5:1). The mixture was stirred at 4000 rpm with the Ross mixer for 3 minutes. After standing for 1 hour, the mixture was removed from the Ross mixer and the mineral spirits phase was decanted. The beads were washed several times with ethanol to fully remove residual water and mineral spirits, and were then dried at 68° C. A photomicrograph of the dry polyimide beads is provided as FIG. 18A. The dry polyimide beads were pyrolyzed at 1050° C. for 2 hours under nitrogen to provide the corresponding carbon aerogel beads. A photomicrograph of the carbonized beads is provided as FIG. 18B.

### Example 5. Carbon Aerogel Microbeads Comprising Carbon Black and Silicon

Carbon aerogel beads comprising carbon black (˜10% by weight) and silicon (˜50% by weight) were prepared by imidization of an emulsified aqueous solution of a polyamic acid triethylammonium salt in the presence of carbon black and silicon followed by pyrolysis of the resulting polyimide gel beads.

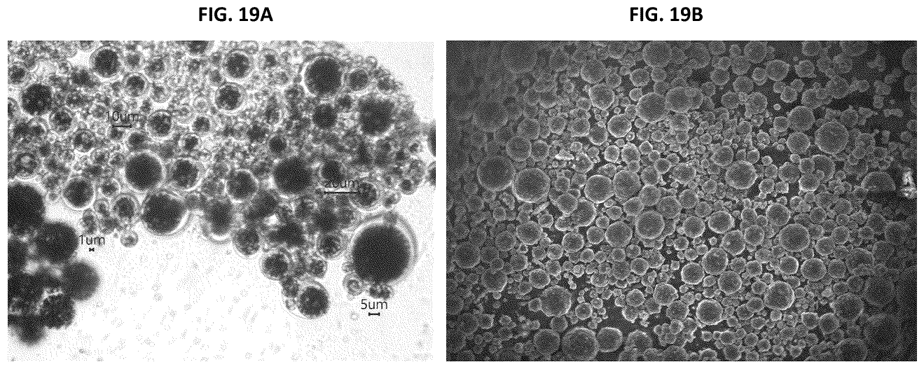

Polyimide gel beads comprising carbon black were prepared at a target density of about 0.085 g/cm³. A solution of 1,4-phenylenediamine in water was prepared by mixing PDA (12.7 g; 118 mmol) with water (313 g), followed by heating at 120° C. until complete dissolution occurred (approximately 8 minutes). The solution was cooled to near room temperature and stirred. Triethylamine (39.3 ml; 2.4:1 mol/mol ratio to PMDA) was added, followed by stirring for 4 minutes. To this mixture was added pyromellitic dianhydride (PMDA; 25.5 g; 1:1 mol/mol ratio relative to PDA) followed by stirring for 4 hours at room temperature. To the resulting triethylammonium salt solution of the polyamic acid, carbon black (1.7 g) and powdered silicon (15.1 g; Evonik AE-APTMS modified) were added and stirred for 10 min, then acetic anhydride (47.6 ml; 4.3 mol/mol ratio relative to PMDA) was added and the mixture was stirred for 50 seconds. At the end of that period, the sol was poured into an immiscible phase under high shear using a Ross mixer at 3880 rpm. The immiscible phase was prepared by dissolving 16.6 g of surfactant Hypermer® B246SF (HLB of 6) in 1200 mL of mineral spirits (mineral spirits to PI sol ratio of 3:1). The mixture was stirred with the Ross mixer for 3 minutes. After standing for 2 hours, the mixture was removed from the Ross mixer and about 300 ml of the mineral spirits phase was decanted, and the beads were allowed to remain overnight in the suspension. The following day, the mineral spirits layer was removed by decanting, and ethanol was added (600 ml) followed by stirring for 1 hour. The mixture was allowed to settle for 48 hours, then decanted. Ethanol was added (600 ml) followed by stirring for 2 hours. The suspension was filtered and the beads stirred with ethanol (400 ml) for 2 hours. The suspension was filtered again and the collected beads dried at 68° C. A photomicrograph of the polyimide beads with silicon and carbon black particles dispersed inside the beads is provided as FIG. 19A. With reference to FIG. 19A, the image shows good dispersion of these two different particles inside the beads After drying, the beads were ground with a mortar and pestle, then pyrolyzed at 1050° C. for 2 hours. FIG. 19B is an SEM image of the carbonized Si/C carbon beads illustrating the two types of carbon present (the carbon black added to the sol, and the carbon provided by carbonization of the polyimide, though the two carbon types cannot be differentiated in the image).

### Example 6. Carbon Aerogel Microbeads Comprising Soft Carbon and Silicon

Carbon aerogel beads comprising soft carbon (˜10% by weight) and silicon (˜50% by weight) were prepared by imidization of an emulsified aqueous solution of a polyamic acid triethylammonium salt in the presence of PTCDA and silicon, followed by pyrolysis of the resulting polyimide gel beads.

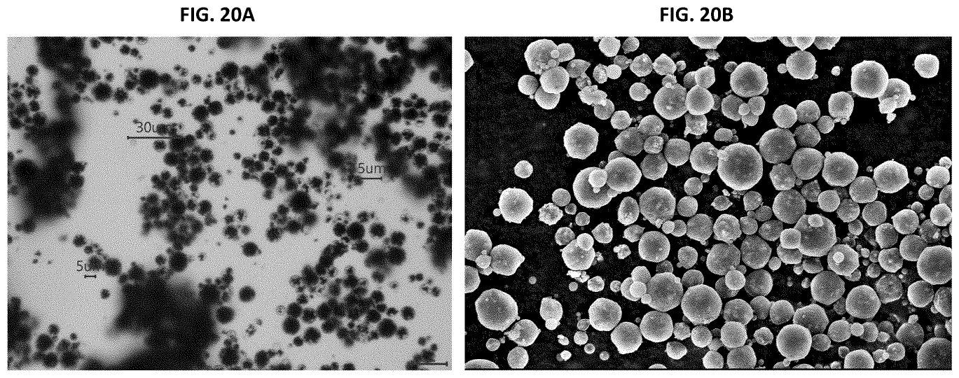

Polyimide beads comprising PTCDA and silicon were prepared by gelation of an emulsion of an aqueous triethylammonium salt solution of polyamic acid at a target density of about 0.085 g/cm³. A solution of 1,4-phenylenediamine in water was prepared by mixing PDA (12.7 g; 118 mmol) with water (313 g), followed by heating at 120° C. until complete dissolution occurred (approximately 8 minutes). The solution was cooled to room temperature and stirred. Triethylamine (39.2 ml; 2.4:1 mol/mol ratio to PMDA) was added, followed by stirring for 3 minutes. To this mixture was added pyromellitic dianhydride (PMDA; 25.5 g; 1:1 mol/mol ratio relative to PDA) followed by stirring for 4 hours at room temperature. To the resulting triethylammonium salt solution of the polyamic acid, perylene tetracarboxylic acid dianhydride (PTCDA; 3.4 g; 8.6 mmol) was added and stirred for 10 min, then acetic anhydride (47.6 ml; 4.3 mol/mol ratio relative to PMDA) was added, and the mixture was stirred for 50 seconds. At the end of that period, the sol was poured into an immiscible phase under high shear using a Ross mixer at 3880 rpm. The immiscible phase was prepared by dissolving 16.6 g of surfactant Hypermer® B246SF (HLB of 6) in 1200 mL of mineral spirits (mineral spirits to PI sol ratio of 3:1). The mixture was stirred with the Ross mixer for 3 minutes. After standing for 2 hours, the mixture was removed from the Ross mixer and about 300 ml of the mineral spirits phase was decanted, and the beads were allowed to remain overnight in the suspension. The following day, the mineral spirits layer was removed by decanting, and ethanol was added (600 ml) followed by stirring for 1 hour. The mixture was allowed to settle for 48 hours, then decanted. Ethanol was added (600 ml) followed by stirring for 2 hours. The suspension was filtered and the beads stirred with ethanol (400 ml) for 2 hours. The suspension was filtered again and the collected beads dried at 68° C. A photomicrograph of the polyimide beads with silicon and PTCDA particles dispersed inside the beads is provided as FIG. 20A. After drying, the beads were ground with a mortar and pestle, then pyrolyzed at 1050° C. for 2 hours. FIG. 20B is an SEM image of the carbonized Si/C beads.

### Example 7. Carbon Aerogel Microbeads (Reference)

Reference carbon aerogel beads were prepared by imidization of an emulsified aqueous solution of a polyamic acid triethylammonium salt followed by pyrolysis of the resulting polyimide gel beads.

Polyimide gel beads were prepared at a target density of about 0.073 g/cm³. A solution of 1,4-phenylenediamine in water was prepared by mixing PDA (7.02 g; 65 mmol) with water (211 g), followed by heating at 60° C. until complete dissolution occurred (approximately 8 minutes). The solution was cooled to room temperature and stirred. Triethylamine (21.8 ml; 2.4:1 mol/mol ratio to PMDA) was added, followed by stirring for 3 minutes. To this mixture was added pyromellitic dianhydride (PMDA; 14.2 g; 1:1 mol/mol ratio relative to PDA) followed by stirring for 3 hours at room temperature. To the resulting triethylammonium salt solution of the polyamic acid, acetic anhydride (26.4 ml; 4.3 mol/mol ratio relative to PMDA) was added, and the mixture was stirred for 50 seconds. At the end of that period, the sol was poured into an immiscible phase under high shear using a Ross mixer at 4000 rpm. The immiscible phase was prepared by dissolving 9.75 g of surfactant Hypermer® B246SF (HLB of 6) in 650 mL of mineral spirits (mineral spirits to PI sol ratio of 5:1). The mixture was stirred at 4000 rpm with the Ross mixer for 3 minutes. After standing for 1 hour, the mixture was removed from the Ross mixer and the mineral spirits phase was decanted. The beads were washed with ethanol and collected by filtration. The beads were washed several times with ethanol to fully remove residual water and mineral spirits, and were then dried at 68° C. The dry polyimide beads were pyrolyzed at 1050° C. for 2 hours under nitrogen.

### Example 8. Carbon Aerogel Microbeads with Carbon Black

Carbon aerogel beads comprising carbon black were prepared by imidization of an emulsified aqueous solution of a polyamic acid triethylammonium salt in the presence of carbon black followed by pyrolysis of the resulting polyimide gel beads.

A solution of 1,4-phenylenediamine (PDA) in water was prepared by stirring for 30 min a mixture of PDA (9.78 g) and water (182.93 g). To the solution was added triethylamine (22 g) followed by 10 minutes of stirring. After that, benzene-1,2,4,5-tetracarboxylic anhydride (19.726 g) was added followed by stirring for 4 h. Carbon black (1.167 g) was added to the solution followed by 10 minutes of stirring. Acetic anhydride (39.7 g) was then poured into the suspension and the mixture stirred for 50 s before pouring the combined mixture into 750 mL mineral spirits containing surfactant while mixing at 2800 rpm. The obtained emulsion was then aged overnight before collecting the polyimide beads by filtration. The collected beads were rinsed with ethanol several times and dried in an oven at 70° C. The dry polyimide beads were pyrolyzed at 1050° C. for 2 hours under nitrogen.

### Example 9. Carbon Aerogel Microbeads with Carbon Black and Silicon

Carbon aerogel beads comprising carbon black and silicon particles were prepared by imidization of an emulsified aqueous solution of a polyamic acid triethylammonium salt in the presence of carbon black and silicon particles followed by pyrolysis of the resulting polyimide gel beads. The beads were prepared as in Example 8, but further adding silicon particles (4.613 g) along with the carbon black.

### Example 10. Carbon Aerogel Microbeads with Carbon Nanotubes

Carbon aerogel beads comprising carbon nanotubes were prepared by imidization of an emulsified aqueous solution of a polyamic acid triethylammonium salt in the presence of carbon nanotubes followed by pyrolysis of the resulting polyimide gel beads. The beads were prepared as in Example 8, but substituting carbon nanotubes (0.106 g) in place of the carbon black.

### Example 11. Carbon Aerogel Microbeads with Graphene Ribbons

Carbon aerogel beads comprising graphene ribbons were prepared by imidization of an emulsified aqueous solution of a polyamic acid triethylammonium salt in the presence of graphene ribbons followed by pyrolysis of the resulting polyimide gel beads. The beads were prepared as in Example 8, but substituting graphene ribbons (0.053 g) in place of the carbon black.

### Example 12. Carbon Aerogel Microbeads with Soft Carbon

Carbon aerogel beads comprising soft carbon were prepared by imidization of an emulsified aqueous solution of a polyamic acid triethylammonium salt in the presence of PTCDA followed by pyrolysis of the resulting polyimide gel beads.

A solution of 1,4-phenylenediamine (PDA) in water was prepared by stirring for 30 min a mixture of PDA (9.78 g) and water (182.93 g). To the solution was added triethylamine (22 g) followed by 10 minutes of stirring. After that, benzene-1,2,4,5-tetracarboxylic anhydride (19.726 g) was added followed by stirring for 4 h. Perylenetetracarboxylic dianhydride (PTCDA, 2.917 g) was added to the solution followed by 10 minutes of stirring. Acetic anhydride (39.7 g) was then poured into the suspension and the mixture stirred for 50 s before pouring the combined mixture into 750 mL mineral spirits containing surfactant while mixing at 2800 rpm. The obtained emulsion was then aged overnight before collecting the polyimide beads by filtration. The collected beads were rinsed with ethanol several times and dried in an oven at 70° C. The dry polyimide beads were pyrolyzed at 1050° C. for 2 hours under nitrogen.

### Example 13. Evaluation of Specific Capacity

The prepared carbon bead materials with different carbon additives (e.g., soft and hard carbon, Examples 1, 2, and 4, and reference Example 7) were tested with lithium metal half-cell with 2032 stainless steel coin cell. The carbon samples were first blended with 2 wt % sodium carboxymethyl cellulose (CMC), 3 wt % styrene butadiene rubber (SBR) aqueous binder, and 10% carbon black to make a slurry, and the slurry was then coated on copper foil. The copper foil was dried at 100° C. under vacuum, and the dried foil was punched into small discs (diameter of 16 mm). The electrolyte used was 1.2 M LiPF₆ in 3/7 v/v ethylene carbonate:ethyl methyl carbonate (EC:EMC). The cell was tested with current of 150 μA in the potential range of 10 mV to 1.5 V.

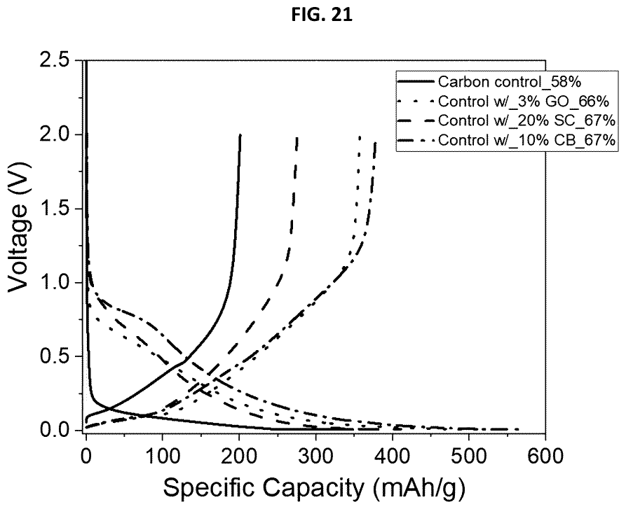

The results are provided in FIG. 21. With reference to FIG. 21, the carbon aerogel microbeads with graphene oxide, soft carbon, and carbon black (Examples 1, 2, and 4, respectively) show improved FCE and reversible capacity relative to the reference carbon aerogel microbead (Example 7). In addition, the lithiation potential of the modified carbon beads is higher than the carbon beads without carbon additives. All of these carbon bead examples have similar low surface area (<10 m²/g) and were tested under the same conditions. Therefore, the improved FCE and reversible capacities and their difference in the lithiation potential is believed to be due to changes of the intrinsic properties of the obtained carbon materials. Without wishing to be bound by theory, it is believed that this may be caused by both the introduced carbon additives themselves and also changes to the polyimide-derived carbon induced by the carbon additives.

### Example 14. Evaluation of Delithiation Capacity

The delithiation capacity of the prepared carbon bead materials with different carbon additives (e.g., soft and hard carbon, Examples 1, 2, and 4, and reference Example 7) was determined using the protocol of Example 8.

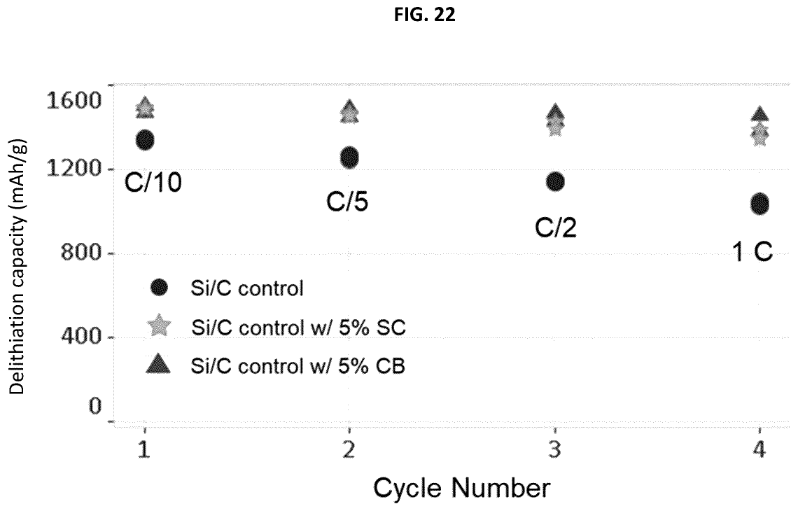

The results are provided in FIG. 22, which shows that the addition of the carbon additives to the Si/C composite materials improved the rate performance of the obtained materials. With continued reference to FIG. 22, the Si/C beads with different carbon additives (Examples 1, 2, and 4) showed improved capacities at higher current rates. These results demonstrate that adding carbon additives not only changes the carbon structure and improves the FCE of the carbon materials, but can also improve the high-rate performance, which is important for fast charging behavior. Without wishing to be bound by theory, it is believed that this improved high-rate performance is due to the improved electrical conductivity of the resulting carbon materials in the presence of the carbon additives.

### Example 15. Synthesis of Sacrificial Particles (PMMA Nanospheres) without Crosslinking

Water (80 grams) and monomer methyl methacrylate (20 grams) were added to beaker which was stirred on a hot plate at 500 RPM with solution temperature controlled at 80° C. for 15 minutes. 1.8 gram of ammonium persulfate was added to the solution as an initiator. The stirring speed was then lowered to 300 RPM after 60 minutes. When the color of the solution changes from transparent to milky, the stirring speed was raised to 500 RPM again. The solution was stirred for another 180 minutes before 2.1 gram of polymer modifier (Hydroxyethyl)methacrylate was added. The solution temperature was changed to 60° C. and the solution was stirred overnight. The synthesis of PMMA nanospheres in emulsion was done by the next morning.

### Example 16. Synthesis of Sacrificial Particles (PMMA Nanospheres) with Crosslinking

Water (80 grams) and monomer methyl methacrylate (20 grams) were added to a beaker which was stirred on a hot plate at 500 RPM with solution temperature controlled at 80° C. for 15 minutes. Ammonium persulfate (1.8 grams) was added to the solution as an initiator. The stirring speed was then lowered to 300 RPM after 60 minutes. When the color of the solution changed from transparent to milky, the stirring speed was raised to 500 RPM again. 1,3-Butanediol dimethacrylate (1.8 grams) was added to the solution as a crosslinking reagent immediately. The solution was stirred for another 180 minutes before polymer modifier ((Hydroxyethyl)methacrylate; 2.1 grams) was added. The solution temperature was changed to 60° C. and was stirred overnight. The synthesis of PMMA nanospheres in emulsion was completed by the next morning.

### Example 17. Synthesis of Si Particles Coated with a Sacrificial Layer

Commercially available silicon particles may or may not include oxidized (partially or completely) silicon particles. Therefore, depending on the surface functionalities of silicon particles provided by commercial providers, the oxidation step provided herein is optional.

Silicon particles (10-100 g; 100-3000 nm; Available from Evonik) were either heated in the temperature range of 400-800° C. under moisture for 1-5 h, or dispersed in 0.1-5 M of 10-1000 mL sulphochromic acid, or 1-10M of H₂O₂ (hydrogen peroxide; 10-1000 mL). For the Si dispersion, it was heated to 50-120° C. for 1-10 hour under constant stirring in order to obtain hydroxyl functional groups (or silanol groups) on the surface of silicon particles. In principle, other oxidizing agents can also be used for this purpose. After 1-10 hours of stirring the solution, the solution was cooled to room temperature and centrifuged to obtain oxidized silicon particles. The obtained silicon particles were washed with 100-3000 mL volume of water for 3-5 times to remove any residual acid and dried under ambient conditions for 3-10 hours. The surface oxidation was confirmed by IR spectrum as evidenced by the reduced intensity of band at 2105 and 1993 cm⁻¹ and the increase of band intensity at 1052 cm⁻¹. The oxidation by heating dry powder can also be confirmed by the mass increase after the treatment.

The oxidized silicon particles (10 grams) were dispersed in 50 mL of ethanol. The dispersion was sonicated for 30 minutes to prevent agglomeration of the silicon particles. Then, 1 gram of AEAPTMS was added to the dispersion and stirred for 240 minutes on a hot plate with dispersion temperature controlled at 70° C. After the dispersion cooled down to room temperature, initiator (4,4′-azobis(4-cyanovaleric acid; 0.5 gram) was added to the dispersion which was stirred for another 240 minutes. The dispersion was then left still overnight to let silicon particles precipitate, after which the top clear solvent was poured out and left silicon slurry was dispersed in 67 mL of water by stirring at 600 RPM for 5 minutes. Monomer methyl methacrylate (25.3 grams) was added to the dispersion and was stirred on a hot plate at 500 RPM with dispersion temperature controlled at 80° C. for 60 minutes. The stirring speed was then lowered to 300 RPM for 60 minutes before it was raised to 500 RPM. The dispersion was stirred for another 180 minutes before polymer modifier ((Hydroxyethyl)methacrylate; 2.6 grams) was added to the dispersion. The dispersion temperature was changed to 70° C. and stirred overnight. The synthesis of silicon particles with sacrificial polymer coating was done by the next morning. The PPMA coated silicon particles were analyzed by IR and the characteristic peaks of Si—H bond between 1950 and 2200 cm⁻¹ were found missing, indicating a good coverage of silicon surface by the PMMA layer.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1. A method of forming a carbon aerogel comprising a carbon additive, the method comprising:
providing a solution comprising an organogel precursor and a solvent;
adding a carbon additive or precursor thereof to the organogel precursor solution;
initiating gelation of the organogel precursor to provide an organogel comprising the carbon additive or precursor thereof;
drying the organogel to form an organic aerogel comprising the carbon additive or precursor thereof; and
isomorphically converting the organic aerogel to the carbon aerogel comprising the carbon additive, the converting comprising pyrolyzing the organic aerogel under an inert atmosphere at a temperature of at least about 650° C.

2. The method of claim 1, wherein the carbon additive is graphene, graphene nanoribbons, graphene nanoplatelets, graphene oxide, carbon black, single wall carbon nanotubes, multiple wall carbon nanotubes, carbon nanofibers, or a combination thereof, the method comprising adding the carbon additive to the organogel precursor solution.

3. The method of claim 1, wherein the carbon additive is soft carbon, the method comprising adding a soft carbon precursor to the organogel precursor solution, wherein the soft carbon precursor comprises or is perylene tetracarboxylic dianhydride (PTCDA).

4. The method of claim 1, wherein the carbon additive is soft carbon, the method comprising adding a soft carbon precursor to the organogel precursor solution, wherein the soft carbon precursor comprises or is or pitch.

5. The method of claim 1, wherein the carbon aerogel further comprises silicon or sacrificial polymer (PMMA) coated silicon particles, the method further comprising adding silicon or sacrificial polymer (PMMA) coated silicon particles to the organogel precursor solution.

6. The method of claim 5, wherein the method further comprises adding poly(methyl methacrylate) particles to the organogel precursor solution.

7. The method of claim 1, wherein drying the organogel comprises:
optionally, washing or solvent exchanging the organogel; and
subjecting the organogel to elevated temperature conditions, lyophilizing the organogel, or contacting the organogel with supercritical fluid carbon dioxide.

8. The method of claim 1, wherein the organogel comprises a resorcinol-formaldehyde (RF) polymer, a phloroglucinol-furfuraldehyde (PF) polymer, polyacrylonitrile (PAN), a polyurethane (PU), a polyurea (PUA), a polyamine (PA), polybutadiene, polydicyclopentadiene, or a combination thereof.

9. The method of claim 1, wherein the organogel comprises a polyimide, polyamic acid, or a combination thereof.

10. The method of claim 1, wherein the organogel is a polyimide, wherein the organogel precursor is a polyamic acid salt, and wherein initiating gelation comprises imidizing the polyamic acid salt.

11. The method of claim 10, wherein imidizing comprises adding acetic anhydride to the solution of the polyamic acid salt.

12. The method of claim 1, wherein the solvent is water.

13. The method of claim 1, wherein the solvent is N,N-dimethylacetamide, N,N-dimethylformamide, N-methylpyrrolidone, or a combination thereof.

14. A carbon aerogel comprising a carbon additive, the carbon aerogel prepared according to the method of claim 1.

15. The carbon aerogel of claim 14, comprising from about 0.1 to about 20% by weight of carbon black.

16. The carbon aerogel of claim 14, comprising from about 0.01 to about 5% by weight of graphene or graphene oxide.

17. The carbon aerogel of claim 14, comprising from about 0.1 to about 20% by weight of soft carbon.

18. The carbon aerogel of claim 14, comprising from about 0.01 to about 10% by weight of single wall carbon nanotubes, multiple wall carbon nanotubes, carbon nanofibers, or a combination thereof.

19. The carbon aerogel of claim 14, in the form of a monolith.

20. The carbon aerogel of claim 18, further comprising:
silicon;
void spaces; or
both silicon and void spaces, wherein at least a portion of the silicon is present within the void spaces.
